(19) United States
(12) Patent Application Publication
(10) Pub. No.: US 2023/0176669 A1
(43) Pub. Date: Jun. 8, 2023

(54) DEVICE ENSEMBLES AND COEXISTENCE MANAGEMENT OF DEVICES

(71) Applicant: View, Inc., Milpitas, CA (US)

(72) Inventors: Anurag Gupta, San Jose, CA (US); Nitesh Trikha, Pleasanton, CA (US); Rao P. Mulpuri, Saratoga, CA (US); Jue Wang, San Jose, CA (US); Christopher Lance Dong, Milpitas, CA (US); Ahmed Mustafa, Fremont, CA (US); Luis Javier Arreola-Maravilla, Morgan Hill, CA (US); Robert Michael Martinson, Palo Alto, CA (US); Nayana Vasant Ghantiwala, San Jose, CA (US)

(21) Appl. No.: 17/922,219

(22) PCT Filed: May 5, 2021
(86) PCT No.: PCT/US2021/030798

§ 371 Date: Oct. 28, 2022

Related U.S. Application Data
(63) Continuation-in-part of application No. PCT/US2021/027418, filed on Apr. 15, 2021.
Application No. PCT/US2021/030798 is a continuation-in-part of application No. 16/447,169, filed on Jun. 20, 2019.
Application No. PCT/US2021/030798 is a continuation-in-part of application No. PCT/US2021/015378, filed on Jan. 28, 2021.
Application No. PCT/US2021/030798 is a continuation-in-part of application No. 16/950,774, filed on Nov. 17, 2020.
Application No. 16/950,774 is a continuation of application No. 16/608,157, filed on Oct. 24, 2019.
Application No. PCT/US2021/030798 is a continuation-in-part of application No. 17/083,128, filed on Oct. 28, 2020.
Application No. 17/083,128 is a continuation of application No. 16/664,089, filed on Oct. 25, 2019, now Pat. No. 11,294,254.
Application No. 16/664,089 is a continuation of application No. PCT/US2019/030467, filed on May 2, 2019.
Application No. 17/083,128 is a continuation-in-part of application No. PCT/US2018/029460, filed on Apr. 25, 2018.
Application No. PCT/US2021/030798 is a continuation-in-part of application No. 17/081,809, filed on Oct. 27, 2020, now Pat. No. 11,460,749.
Application No. 17/081,809 is a continuation of application No. 16/608,159, filed on Oct. 24, 2019, now Pat. No. 11,300,849.
(60) Provisional application No. 63/079,851, filed on Sep. 17, 2020.
(60) Provisional application No. 63/034,792, filed on Jun. 4, 2020.
(60) Provisional application No. 63/020,819, filed on May 6, 2020.
(60) Provisional application No. 63/080,899, filed on Sep. 21, 2020.
(60) Provisional application No. 63/052,639, filed on Jul. 16, 2020.
(60) Provisional application No. 63/010,977, filed on Apr. 16, 2020.
(60) Provisional application No. 62/688,957, filed on Jun. 22, 2018.
(60) Provisional application No. 62/858,100, filed on Jun. 6, 2019.
(60) Provisional application No. 62/803,324, filed on Feb. 8, 2019.
(60) Provisional application No. 62/768,775, filed on Nov. 16, 2018.
(60) Provisional application No. 62/967,204, filed on Jan. 29, 2020.
(60) Provisional application No. 62/607,618, filed on Dec. 19, 2017.
(60) Provisional application No. 62/523,606, filed on Jun. 22, 2017.
(60) Provisional application No. 62/507,704, filed on May 17, 2017.
(60) Provisional application No. 62/506,514, filed on May 15, 2017.
(60) Provisional application No. 62/490,457, filed on Apr. 26, 2017.
(60) Provisional application No. 62/666,033, filed on May 2, 2018.
(60) Provisional application No. 62/607,618, filed on Dec. 19, 2017.
(60) Provisional application No. 62/523,606, filed on Jun. 22, 2017.
(60) Provisional application No. 62/507,704, filed on May 17, 2017.
(60) Provisional application No. 62/506,514, filed on May 15, 2017.
(60) Provisional application No. 62/490,457, filed on Apr. 26, 2017.
(60) Provisional application No. 62/607,618, filed on Dec. 19, 2017.
(60) Provisional application No. 62/523,606, filed on Jun. 22, 2017.
(60) Provisional application No. 62/507,704, filed on May 17, 2017.
(60) Provisional application No. 62/506,514, filed on May 15, 2017.
(60) Provisional application No. 62/490,457, filed on Apr. 26, 2017.

(51) Int. Cl. G06F 3/041; G06F 3/044

(52) U.S. Cl. CPC G06F 3/0412; G06F 3/04164; G06F 3/04166; G06F 3/041662; G06F 3/0443; G06F 3/0445; G06F 3/0446; G06F 3/0416; G06F 3/044; G06F 2203/04104

(57) ABSTRACT

Various devices (e.g., sensors and/or emitters) are disposed in a casing to form an ensemble are utilized to affect and/or control an environment of an enclosure (e.g., facility). A plurality of such ensembles may be disposed in the facility. Inter and/or intra coexistence issues may arise among the devices. Such coexistence is utilized and/or managed by a control and/or processing system. An ensemble may be integrated as a digital architectural element packaged as a capsule having a main body shell and a lid.

### RELATED APPLICATIONS

This application claims priority (a) from U.S. Provisional Patent Application Ser. No. 63/079,851, filed Sep. 17, 2020, titled “DEVICE ENSEMBLES AND COEXISTENCE MANAGEMENT OF DEVICES,” (b) from U.S. Provisional Patent Application Ser. No. 63/034,792, filed Jun. 4, 2020, titled “DEVICE ENSEMBLES AND COEXISTENCE MANAGEMENT OF DEVICES,” and (c) from U.S. Provisional Patent Application Ser. No. 63/020,819, filed May 6, 2020, titled “DEVICE ENSEMBLES AND COEXISTENCE MANAGEMENT OF DEVICES.” This application is also a continuation in part of U.S. patent application Ser. No. 17/249,442 filed Mar. 2, 2021, titled “ONBOARD CONTROLLER FOR MULTISTATE WINDOWS,” which is a Continuation of U.S. patent application Ser. No. 16/508,099, filed Jul. 10, 2019, now U.S. Pat. No. 10,989,977, issued Apr. 27, 2021, titled “ONBOARD CONTROLLER FOR MULTISTATE WINDOWS,” which is a Continuation of U.S. patent application Ser. No. 16/298,776, filed Mar. 11, 2019, now U.S. Pat. No. 10,747,082, issued Aug. 18, 2020, titled “ONBOARD CONTROLLER FOR MULTISTATE WINDOWS,” which is a Continuation of U.S. patent application Ser. No. 15/978,029, filed May 11, 2018, now U.S. Pat. No. 10,268,098, issued Apr. 23, 2019, titled “ONBOARD CONTROLLER FOR MULTISTATE WINDOWS,” which is a Continuation of U.S. patent application Ser. No. 14/887,178, filed Oct. 19, 2015, now U.S. Pat. No. 10,001,691, issued Jun. 19, 2018, titled “ONBOARD CONTROLLER FOR MULTISTATE WINDOWS,” which is a Continuation of U.S. patent application Ser. No. 13/479,137, filed May 23, 2012, now U.S. Pat. No. 9,128,346, issued Sep. 8, 2015, titled “ONBOARD CONTROLLER FOR MULTISTATE WINDOWS,” and which is a Continuation of U.S. patent application Ser. No. 13/049,750, filed Mar. 16, 2011, now U.S. Pat. No. 8,213,074, issued Jul. 3, 2012, titled “ONBOARD CONTROLLER FOR MULTISTATE WINDOWS.” This application also claims priority from International Patent Application Ser. No. PCT/US21/27418, filed Apr. 15, 2021, titled “INTERACTION BETWEEN AN ENCLOSURE AND ONE OR MORE OCCUPANTS,” that claims priority from U.S. Provisional Patent Application Ser. No. 63/080,899, filed Sep. 21, 2020, titled “INTERACTION BETWEEN AN ENCLOSURE AND ONE OR MORE OCCUPANTS,” from U.S. Provisional Application Ser. No. 63/052,639, filed Jul. 16, 2020, titled “INDIRECT INTERACTIVE INTERACTION WITH A TARGET IN AN ENCLOSURE,” and from U.S. Provisional Application Ser. No. 63/010,977, filed Apr. 16, 2020, titled “INDIRECT INTERACTION WITH A TARGET IN AN ENCLOSURE.” This application is also a Continuation-in-Part of U.S. patent application Ser. No. 17/249,148, filed Feb. 22, 2021, titled CONTROLLING OPTICALLY-SWITCHABLE DEVICES,” which is a Continuation of U.S. patent application Ser. No. 16/096,557, filed Oct. 25, 2018, titled “CONTROLLING OPTICALLY-SWITCHABLE DEVICES,” that is (A) a National Stage Entry of International Patent Application Ser. No. PCT/US17/29476, filed Apr. 25, 2017, titled “CONTROLLING OPTICALLY-SWITCHABLE DEVICES,” that claims priority from U.S. Provisional Patent Application Ser. No. 62/327,880, filed Apr. 26, 2016, titled “CONTROLLING OPTICALLY-SWITCHABLE DEVICES,” and that is (B) a Continuation-In-Part of U.S. patent application Ser. No. 14/391,122, filed Oct. 7, 2014, titled “APPLICATIONS FOR CONTROLLING OPTICALLY SWITCHABLE DEVICES,” that is a National Stage Entry of International Patent Application Ser. No. PCT/US13/36456, filed Apr. 12, 2013, titled “APPLICATIONS FOR CONTROLLING OPTICALLY SWITCHABLE DEVICES,” that claims priority from U.S. Provisional Patent Application Ser. No. 61/624,175, filed Apr. 13, 2012, titled “APPLICATIONS FOR CONTROLLING OPTICALLY SWITCHABLE DEVICES.” This application also claims priority from U.S. patent application Ser. No. 16/488,137 filed Aug. 22, 2019, titled “SEISMIC EVENT DETECTION SYSTEM,” that is a National Stage Entry of International Patent Application Ser. No. PCT/US18/19027, filed Feb. 21, 2018, titled “SEISMIC EVENT DETECTON SYSTEM,” that claims priority from U.S. Provisional Patent Application Ser. No. 62/462,152, filed Feb. 22, 2017, titled “SEISMIC EVENT DETECTION SYSTEM.” This application is also a Continuation-in-Part of U.S. patent application Ser. No. 16/447,169, filed Jun. 20, 2019, titled “SENSING AND COMMUNICATIONS UNIT FOR OPTICALLY SWITCHABLE WINDOW SYSTEMS,” which claims priority from (I) U.S. Provisional Patent Application Ser. No. 62/688,957, filed Jun. 22, 2018, titled “SENSING AND COMMUNICATIONS UNIT FOR OPTICALLY SWITCHABLE WINDOW SYSTEMS,” (II) U.S. Provisional Patent Application Ser. No. 62/858,100, filed Jun. 6, 2019, titled “SENSING AND COMMUNICATIONS UNIT FOR OPTICALLY SWITCHABLE WINDOW SYSTEMS,” (Ill) U.S. Provisional Patent Application Ser. No. 62/803,324, filed Feb. 8, 2019, titled “SENSING AND COMMUNICATIONS UNIT FOR OPTICALLY SWITCHABLE WINDOW SYSTEMS,” (IV) U.S. Provisional Patent Application Ser. No. 62/768,775, filed Nov. 16, 2018, titled “SENSING AND COMMUNICATIONS UNIT FOR OPTICALLY SWITCHABLE WINDOW SYSTEMS.” This application is also a Continuation-in-Part of International Patent Application Ser. No. PCT/US21/15378 filed Jan. 28, 2021, titled “Sensor Calibration and Operation,” that claims priority from U.S. Provisional Patent Application Ser. No. 62/967,204, filed Jan. 29, 2020, titled “SENSOR CALIBRATION AND OPERATION.” This application is also a Continuation-in-Part of U.S. patent application Ser. No. 16/950,774, filed Nov. 17, 2020, titled “Displays For Tintable Windows,” which is a Continuation-in-Part of U.S. patent application Ser. No. 16/608,157, filed October 24, 2019, titled “Displays For Tintable Windows,” which is a National Stage Entry of International Patent Application Ser. No. PCT/US18/29476, filed Apr. 25, 2018, titled “Displays For Tintable Windows,” which claims priority from (i) U.S. Provisional Patent Application Ser. No. 62/607,618, filed Dec. 19, 2017, titled “Electrochromic Windows With Transparent Display Technology Field,” (ii) U.S. Provisional Patent Application Serial No. 62/523,606, filed Jun. 22, 2017, titled “Electrochromic Windows With Transparent Display Technology,” (iii) U.S. Provisional Patent Application Ser. No. 62/507,704, filed May 17, 2017, titled “Electrochromic Windows With Transparent Display Technology,” (iv) U.S. Provisional Patent Application Ser. No. 62/506,514, filed May 15, 2017, titled “Electrochromic Windows With Transparent Display Technology,” and (v) U.S. Provisional Patent Application Ser. No. 62/490,457, filed Apr. 26, 2017, titled “Electrochromic Windows With Transparent Display Technology.” This application is also a Continuation-In-Part of U.S. patent application Ser. No. 17/083,128, filed Oct. 28, 2020, titled “Building Network,” which is a Continuation of U.S. patent application Ser. No. 16/664,089, filed October 25, 2019, titled “Building Network,” that is a National Stage Entry of International Patent Application Ser. No. PCT/US19/30467, filed May, 2, 2019, titled “Edge Network for Building Services,” which claims priority from U.S. Provisional Patent Application Ser. No. 62/666,033, filed May 2, 2018, U.S. patent application Ser. No. 17/083,128, is also a Continuation-In-Part of International Patent Application Ser. No. PCT/US18/29460, filed Apr. 25, 2018, that claims priority from U.S. Provisional Patent Application Ser. No. 62/607,618, from U.S. Provisional Patent Application Ser. No. 62/523,606, from U.S. Provisional Patent Application Ser. No. 62/507,704, from U.S. Provisional Patent Application Ser. No. 62/506,514, and from U.S. Provisional Patent Application Ser. No. 62/490,457. This application is also a Continuation-In-Part of U.S. patent application Ser. No. 17/081,809, filed Oct. 27, 2020, titled “Tintable Window System Computing Platform,” which is a Continuation of U.S. patent application Ser. No. 16/608,159, filed Oct. 24, 2019, titled “Tintable Window System Computing Platform,” that is a National Stage Entry of International Patent Application Ser. No. PCT/US18/29406, filed Apr. 25, 2018, titled “Tintable Window System Computing Platform,” which claims priority from U.S. Provisional Patent Application Ser. No. 62/607,618, U.S. Provisional Patent Application Ser. No. 62/523,606, from U.S. Provisional Patent Application Ser. No. 62/507,704, U.S. Provisional Patent Application Ser. No. 62/506,514, and from U.S. Provisional Patent Application Ser. No. 62/490,457. Each of the above recited patent applications is entirely incorporated herein by reference.

### BACKGROUND

At times, it may be beneficial to control (e.g., monitor and/or adjust) environmental characteristic of an enclosure (e.g., facility such as a building). The building may be a smart building. For example, it may be beneficial to monitor individuals and their effect on environmental characteristic(s) of an enclosure. For example, it may be beneficial to adjust the environmental characteristic(s) of an enclosure to accommodate request(s), e.g., by occupant(s). At times, communication (e.g., automatic communication) with occupant(s) in an enclosure may be requested. Sensor(s) and emitter(s) may facilitate such control and/or (e.g., automatic) reaction.

A community of components (e.g., sensors, emitters, timing circuits, actuators, transmitters, and/or receivers) may be placed at various locations in an enclosure (e.g., a building) to analyze, detect, and/or react to: data, temperature, humidity, sound, electromagnetic waves, position, distance, movement, speed, vibration, volatile compounds (VOCs), dust, light, glare, color, gases, and/or other aspects of the enclosure. Such components may be deployed in an ensemble having a common assembly (e.g., casing such as a box) containing a requested grouping of such components (e.g., modules). Operation of different types of components in such a (e.g., multiple-modality) assembly can at times skew the operation of at least one of the individual components. For example, proximal operation of sensors and emitters can cause signal interference and/or false readings. For example, operation of a sensor configured to sense an environmental characteristic having a signal type, next to an emitter emitting the same or similar signal type, can induce a false sensor reading.

Devices or collections of devices, such as modules (e.g., components such as sensors, emitters, and/or processing circuits), can be configured as a multiple component assembly (also referred to herein as “ensemble”). The packaging (e.g., physical integration) of an assembly and/or integration in a variety of fixtures of an enclosure (e.g., facility), pose challenges for the functionality of the component(s), size of the ensemble, layout in the facility, and/or costs. The cost may comprise installation, maintenance, removal, and/or replacement costs. Access to an installed assembly should be easy, e.g., when performing service, removal, and/or replacement. The assembly should preferably easily embed with a network. The ease of installation, maintenance, removal, replacement, and/or network coupling may refer to a shortened time, effort, and/or expense required to complete any of these tasks. Additionally, it may be beneficial to have substantial computing power in the facility that can support provision of services, e.g., data associated with the components, data associated with the facility, and/or data external to the facility that is communicatively coupled to the ensemble(s).

### SUMMARY

Various aspects disclosed herein alleviate at least part of the shortcomings related to potential interference between components deployed in close proximity.

Various aspects disclosed herein may utilize the interference between components deployed in close proximity.

Various aspects disclosed herein may relate to an ensemble (e.g., assembly, group, and/or network) of components such as sensors, actuators, emitters, transmitters, receivers, or other elements (also referred to herein as “modules”) deployed in close proximity, e.g., to provide information and/or control functions related to occupant(s) in an enclosure (e.g., a smart building). Integration of multiple components (e.g., sensor, emitter, actuator, transmitter, and/or receiver modules) in a single assembly (e.g., a package) allows all the elements to be installed at once. The communal packaging may shorten and/or simplify installation (e.g., deployment) time. Two or more components of the assembly can be controlled by one controller (e.g., microcontroller), which may simplify the control architecture and/or connectivity to these components. The potential for various undesired interactions between modules may increase, e.g., (i) in large spaces and/or (ii) in spaces that require more detailed monitoring and/or mapping of the environment. At times, it may become time-consuming, expensive, and/or difficult to package all such components in an assembly in a way that prevents mutual interference (e.g., coexistence errors).

Various aspects disclosed herein may relate to form factors for packaging ensembles as digital architectural elements. The ensemble configured as a digital architectural element (abbreviated herein as “DAE”) facilitates ease of installation, maintenance, removal, replacement, and/or packaging of the components. The ensemble can provide coexistence of components in the assembly with known and/or reduced interference. The ensemble may provide compact, attractive and/or simple design that is adaptable to different mounting locations in a facility. The ensemble may be configured for network integration, and/or facilitate high speed data streams. The ensemble may provide computing power and may be part of a collective of ensembles having (e.g., extensive) collective computing power, depending on the number of ensembles in the collective.

In some embodiments, a coexistence matrix is utilized in order to identify possible interference internally between modules of an assembly (also referred to herein as “intra assembly interference”) and/or between modules of different assemblies (also referred to herein as “inter assembly interference”), e.g., within close proximity. In some embodiments, positioning and/or operation times of modules (e.g., devices such as components) are controlled to have a potential to interfere with each other. In some embodiments, interference data is used as a tool to map a space in which the modules are disposed. Controller and/or “master” and “slave” assignments of modules can be established, e.g., in order to direct operation periods (e.g., time periods) for respective modules. In some embodiments, interaction and/or mutual learning (e.g., using Al) is employed (i) between modules within a single group and/or (ii) within different groups of modules to define roles, timing, and/or a control hierarchy.

In another aspect, a method for managing coexistence of modules (e.g., devices such as components), the method comprises:(A) generating a coexistence matrix indicative of any interference between (e.g., each of) a first plurality of devices disposed in an enclosure and (e.g., each of) a second plurality of devices disposed in the enclosure; (B) using the coexistence matrix to control operation of (a) at least one first device of the first plurality of devices and/or (b) at least one second device of the second plurality of devices; and(C) altering an environment of the enclosure using the at least one first device and/or the at least one second device.

In some embodiments, the first plurality of devices is disposed in a casing in which the second plurality of devices is disposed. In some embodiments, the casing has at least one cross section comprising an oblong cross section or a rectangular cross section. In some embodiments, the casing has a lid that can be snapped to an open body of the casing. In some embodiments, the casing comprises a mesh. In some embodiments, the casing comprises a polymer, resin, glass, ceramic, elemental metal, metal alloy, ceramic, or an allotrope of elemental carbon. In some embodiments, the casing comprises a transparent or a non-transparent portion. In some embodiments, the casing comprises a textured exterior portion and a non-textured exterior portion. In some embodiments, the textured portion comprises a pattern. In some embodiments, the pattern comprises space filling polygons. In some embodiments, the casing comprises at least one hole at least a portion of the textured exterior. In some embodiments, the casing interior comprises a heat sink or a partition. In some embodiments, the method further comprises using the coexistence matrix to alter an interior of the casing. In some embodiments, alteration of the interior of the casing comprises (i) adding a heat sink, (ii) adding a partition, or (iii) rearranging at least one first device of the first plurality of devices and/or at least one second device of the second plurality of devices. In some embodiments, the first plurality of devices is disposed in a circuit board in which the second plurality of devices is disposed. In some embodiments, at least one first device of the first plurality of devices and/or at least one second device of second plurality of devices, can be inserted reversibly into a circuit board in which the at least one first device and/or the at least one second device is disposed. In some embodiments, at least one first device of the first plurality of devices and/or at least one second device of second plurality of devices, can be extracted reversibly from a circuit board in which the at least one first device and/or the at least one first device is disposed. In some embodiments, the first plurality of devices is disposed in a first sub enclosure and wherein the second plurality of devices is disposed in a second sub enclosure. In some embodiments, the first sub enclosure is a first casing in which the first plurality of devices is disposed. In some embodiments, the second sub enclosure is a second casing in which the second plurality of devices is disposed. In some embodiments, the enclosure is a facility. In some embodiments, the first sub enclosure is a first room in the facility. In some embodiments, the second sub enclosure is a second room in the facility. In some embodiments, the first sub enclosure is a first floor in the facility. In some embodiments, the second sub enclosure is a second floor in the facility. In some embodiments, the first plurality of devices is a plurality of potential aggressor devices, and wherein the second plurality of devices is a plurality of potential victim devices. In some embodiments, the any interference between a first device of the first plurality of devices and a second device of the second plurality of devices is indicated in a cell of the coexistence matrix. In some embodiments, the any interference between a first device of the first plurality of devices and a second device of the second plurality of devices is indicated as an interference potential. In some embodiments, control of the environment of the enclosure is performed at least in part using at least one controller. In some embodiments, the at least one controller is part of a hierarchical control system. In some embodiments, the at least one controller is disposed in a circuit board in which the first plurality of devices and/or the second plurality of devices, is disposed. In some embodiments, the coexistence matrix is utilized in controlling the first plurality of devices and/or the second plurality of devices indicated in the coexistence matrix as having an interference potential above a threshold. In some embodiments, the threshold comprises a value, a time dependent function, or a spatially dependent function. In some embodiments, the coexistence matrix is utilized in controlling any device of the first plurality of devices and/or any device of the second plurality of devices indicated in the coexistence matrix as having an interference potential above a threshold. In some embodiments, controlling operation of the first plurality of devices and/or the second plurality of devices comprises controlling operation mode of (i) at least one first device of the first plurality of devices and/or (ii) at least one second device of the second plurality of devices. In some embodiments, the operation mode comprises timing of operation. In some embodiments, the operation mode comprises (i) an off mode or (ii) an on mode. In some embodiments, the operation mode comprises scheduling, locating, or calibrating the at least one first device of the first plurality of devices and/or the at least one second device of the second plurality of devices. In some embodiments, the method further comprises monitoring (i) at least one first device of the first plurality of devices and/or (ii) at least one second device of the second plurality of devices, for any malfunction. In some embodiments, the method further comprises using a control system communicatively coupled to the first plurality of devices and/or the second plurality of devices to alert of any malfunction (i) of at least one first device of the first plurality of devices and/or (ii) of at least one second device of second plurality of devices. In some embodiments, the control system (i) provides an alert of, and/or (ii) suggests a solution to: any detected malfunction of at least one first device of the first plurality of devices and/or at least one second device of second plurality of devices. In some embodiments, the first plurality of devices comprises a sensor and wherein the second plurality of devices comprises an emitter. In some embodiments, the first plurality of devices comprises a sensor sensing a property, and wherein the second plurality of devices comprises an emitter of the property. In some embodiments, the property comprises light, temperature, sound, pressure, gas type, gas concentration, or gas velocity.

In another aspect, a non-transitory computer program product for managing coexistence of modules (e.g., devices such as components), which non-transitory computer program product contains instructions inscribed thereon which, when executed by one or more processors, cause the one or more processors to execute operations, comprises: (A) generating, or direct generation of, a coexistence matrix indicative of any interference between (e.g., each of) a first plurality of devices disposed in an enclosure and (e.g., each of) a second plurality of devices disposed in the enclosure; (B) using, or direct usage of, the coexistence matrix to control operation of (a) at least one first device of the first plurality of devices and/or (b) at least one second device of the second plurality of devices; and (C) altering, or direct alteration of, an environment of the enclosure using the at least one first device and/or the at least one second device.

In some embodiments, the first plurality of devices is disposed in a casing in which the second plurality of devices is disposed. In some embodiments, the casing has at least one cross section comprising an oblong cross section or a rectangular cross section. In some embodiments, the casing has a lid that can be snapped to an open body of the casing. In some embodiments, the casing comprises a mesh. In some embodiments, the casing comprises a polymer, resin, glass, ceramic, elemental metal, metal alloy, ceramic, or an allotrope of elemental carbon. In some embodiments, the casing comprises a transparent or a non-transparent portion. In some embodiments, the casing comprises a textured exterior portion and a non-textured exterior portion. In some embodiments, the textured portion comprises a pattern. In some embodiments, the pattern comprises space filling polygons. In some embodiments, the casing comprises at least one hole at least a portion of the textured exterior. In some embodiments, the casing interior comprises a heat sink or a partition. In some embodiments, the non-transitory computer program product, further comprises using the coexistence matrix to alter an interior of the casing. In some embodiments, alteration of the interior of the casing comprises (i) adding a heat sink, (ii) adding a partition, or (iii) rearranging at least one first device of the first plurality of devices and/or at least one second device of the second plurality of devices. In some embodiments, the first plurality of devices is disposed in a circuit board in which the second plurality of devices is disposed. In some embodiments, at least one first device of the first plurality of devices and/or at least one second device of second plurality of devices, can be inserted reversibly into a circuit board in which the at least one first device and/or the at least one second device is disposed. In some embodiments, at least one first device of the first plurality of devices and/or at least one second device of second plurality of devices, can be extracted reversibly from a circuit board in which the at least one first device and/or the at least one first device is disposed. In some embodiments, the first plurality of devices is disposed in a first sub enclosure and wherein the second plurality of devices is disposed in a second sub enclosure. In some embodiments, the first sub enclosure is a first casing in which the first plurality of devices is disposed. In some embodiments, the second sub enclosure is a second casing in which the second plurality of devices is disposed. In some embodiments, the enclosure is a facility. In some embodiments, the first sub enclosure is a first room in the facility. In some embodiments, the second sub enclosure is a second room in the facility. In some embodiments, the first sub enclosure is a first floor in the facility. In some embodiments, the second sub enclosure is a second floor in the facility. In some embodiments, the first plurality of devices is a plurality of potential aggressor devices, and wherein the second plurality of devices is a plurality of potential victim devices. In some embodiments, the any interference between a first device of the first plurality of devices and a second device of the second plurality of devices is indicated in a cell of the coexistence matrix. In some embodiments, the any interference between a first device of the first plurality of devices and a second device of the second plurality of devices is indicated as an interference potential. In some embodiments, control of the environment of the enclosure is performed at least in part using at least one controller. In some embodiments, the at least one controller is part of a hierarchical control system. In some embodiments, the at least one controller is disposed in a circuit board in which the first plurality of devices and/or the second plurality of devices, is disposed. In some embodiments, the coexistence matrix is utilized in controlling the first plurality of devices and/or the second plurality of devices indicated in the coexistence matrix as having an interference potential above a threshold. In some embodiments, the threshold comprises a value, a time dependent function, or a spatially dependent function. In some embodiments, the coexistence matrix is utilized in controlling any device of the first plurality of devices and/or any device of the second plurality of devices indicated in the coexistence matrix as having an interference potential above a threshold. In some embodiments, controlling operation of the first plurality of devices and/or the second plurality of devices comprises controlling operation mode of (i) at least one first device of the first plurality of devices and/or (ii) at least one second device of the second plurality of devices. In some embodiments, the operation mode comprises timing of operation. In some embodiments, the operation mode comprises (i) an off mode or (ii) an on mode. In some embodiments, the operation mode comprises scheduling, locating, or calibrating the at least one first device of the first plurality of devices and/or the at least one second device of the second plurality of devices. In some embodiments, the non-transitory computer program product, further comprises monitoring (i) at least one first device of the first plurality of devices and/or (ii) at least one second device of the second plurality of devices, for any malfunction. In some embodiments, the non-transitory computer program product, further comprises using a control system communicatively coupled to the first plurality of devices and/or the second plurality of devices to alert of any malfunction (i) of at least one first device of the first plurality of devices and/or (ii) of at least one second device of second plurality of devices. In some embodiments, the control system (i) provides an alert of, and/or (ii) suggests a solution to: any detected malfunction of at least one first device of the first plurality of devices and/or at least one second device of second plurality of devices. In some embodiments, the first plurality of devices comprises a sensor, and wherein the second plurality of devices comprises an emitter. In some embodiments, the first plurality of devices comprises a sensor sensing a property and wherein the second plurality of devices comprises an emitter of the property. In some embodiments, the property comprises light, temperature, sound, pressure, gas type, gas concentration, or gas velocity.

In another aspect, an apparatus for managing coexistence of modules (e.g., devices such as components), the apparatus comprises one or more controllers (e.g., comprising circuitry), which one or more controllers are configured to: (A) generate, or direct generation of, a coexistence matrix indicative of any interference between (e.g., each of) a first plurality of devices disposed in an enclosure and (e.g., each of) a second plurality of devices disposed in the enclosure; (B) use, or direct usage of, the coexistence matrix to control operation of (a) at least one first device of the first plurality of devices and/or (b) at least one second device of the second plurality of devices; and (C) alter, or direct alteration of, an environment of the enclosure using the at least one first device and/or the at least one second device.

In some embodiments, the one or more controllers are coupled to the first plurality of devices and to the second plurality of devices, and wherein the one or more controllers are configured to isolate operation of the at least one first device from operation of the at least one second device based at least in part on any respective interference included in the coexistence matrix. In some embodiments, operation of the at least one first device and the operation of the at least one second device are isolated when an interference potential included in the coexistence matrix is above a threshold. In some embodiments, the coexistence matrix includes one or more cells characterizing an interference potential between the at least one first device and the at least one second device. In some embodiments, a cell of the coexistence matrix provides at least one designation representing a relative susceptibility to interference between a first device of the at least one first device and a second device of the at least one second device. In some embodiments, the at least one designation includes a high designation and a low designation according to the relative susceptibility being above a threshold or below the threshold, respectively. In some embodiments, the at least one designation includes a numerical value characterizing the interference. In some embodiments, the relative susceptibility is determined in response to performance specifications. In some embodiments, the relative susceptibility is determined in response to empirical evaluations. In some embodiments, isolation of the at least one first device from operation of the at least one second device is comprised of (i) a first time of operation of the at least one first device and (ii) a second time of operation of the at least one second device, wherein the first time is separated from the second time to prevent simultaneous operation of the at least one first device and the at least one second device. In some embodiments, the at least one first device and the at least one second device are of the same type, wherein the first plurality of devices are in a first assembly, wherein the second plurality of devices are in a second assembly, and wherein isolation of the at least one first device from operation of the at least one second device is comprised of a physical distance separation resulting from the one or more controllers activating the at least one first device while deactivating the at least one second device when the first assembly is above a distance threshold from the second assembly. In some embodiments, the apparatus further comprises a casing, wherein the first plurality of devices is disposed in the casing. In some embodiments, the casing has at least one cross section comprising an oblong cross section or a rectangular cross section. In some embodiments, the casing has a lid that can be snapped to an open body of the casing. In some embodiments, the casing comprises a mesh. In some embodiments, the casing comprises a polymer, resin, glass, ceramic, elemental metal, metal alloy, ceramic, or an allotrope of elemental carbon. In some embodiments, the casing comprises a transparent or a non-transparent portion. In some embodiments, the casing comprises a textured exterior portion and a non-textured exterior portion. In some embodiments, the textured portion comprises a pattern. In some embodiments, the pattern comprises space filling polygons. In some embodiments, the casing comprises at least one hole at least a portion of the textured exterior. In some embodiments, the casing interior comprises a heat sink or a partition. In some embodiments, the apparatus further comprises using the coexistence matrix to alter an interior of the casing. In some embodiments, alteration of the interior of the casing comprises (i) adding a heat sink, (ii) adding a partition, or (iii) rearranging at least one first device of the first plurality of devices and/or at least one second device of the second plurality of devices. In some embodiments, the first plurality of devices is disposed in a circuit board in which the second plurality of devices is disposed. In some embodiments, at least one first device of the first plurality of devices and/or at least one second device of second plurality of devices, can be inserted reversibly into a circuit board in which the at least one first device and/or the at least one second device is disposed. In some embodiments, at least one first device of the first plurality of devices and/or at least one second device of second plurality of devices, can be extracted reversibly from a circuit board in which the at least one first device and/or the at least one first device is disposed. In some embodiments, the first plurality of devices is disposed in a first sub enclosure and wherein the second plurality of devices is disposed in a second sub enclosure. In some embodiments, the first sub enclosure is a first casing in which the first plurality of devices is disposed. In some embodiments, the second sub enclosure is a second casing in which the second plurality of devices is disposed. In some embodiments, the enclosure is a facility. In some embodiments, the first sub enclosure is a first room in the facility. In some embodiments, the second sub enclosure is a second room in the facility. In some embodiments, the first sub enclosure is a first floor in the facility. In some embodiments, the second sub enclosure is a second floor in the facility. In some embodiments, the first plurality of devices is a plurality of potential aggressor devices, and wherein the second plurality of devices is a plurality of potential victim devices. In some embodiments, the any interference between a first device of the first plurality of devices and a second device of the second plurality of devices is indicated in a cell of the coexistence matrix. In some embodiments, the any interference between a first device of the first plurality of devices and a second device of the second plurality of devices is indicated as an interference potential. In some embodiments, control of the environment of the enclosure is performed at least in part using at least one controller. In some embodiments, the at least one controller is part of a hierarchical control system. In some embodiments, the at least one controller is disposed in a circuit board in which the first plurality of devices and/or the second plurality of devices, is disposed. In some embodiments, the coexistence matrix is utilized in controlling the first plurality of devices and/or the second plurality of devices indicated in the coexistence matrix as having an interference potential above a threshold. In some embodiments, the threshold comprises a value, a time dependent function, or a spatially dependent function. In some embodiments, the one or more controllers are configured to utilize the coexistence matrix in controlling any device of the first plurality of devices and/or any device of the second plurality of devices that is indicated in the coexistence matrix as having an interference potential above a threshold. In some embodiments, the one or more controllers are configured to control operation of the first plurality of devices and/or the second plurality of devices at least in part by controlling operation mode of (i) at least one first device of the first plurality of devices and/or (ii) at least one second device of the second plurality of devices. In some embodiments, the operation mode comprises timing of operation. In some embodiments, the operation mode comprises (i) an off mode or (ii) an on mode. In some embodiments, the operation mode comprises scheduling, locating, or calibrating the at least one first device of the first plurality of devices and/or the at least one second device of the second plurality of devices. In some embodiments, the one or more controllers are configured to monitor, or direct monitoring of, (i) at least one first device of the first plurality of devices and/or (ii) at least one second device of the second plurality of devices, for any malfunction. In some embodiments, the one or more controllers are configured to alert, or direct altering, of any malfunction (i) of at least one first device of the first plurality of devices and/or (ii) of at least one second device of second plurality of devices. In some embodiments, the one or more controllers are configured to (i) provide, or direct providing, an alert of, and/or (ii) suggest, or direct suggestion of, a solution to: any detected malfunction of at least one first device of the first plurality of devices and/or at least one second device of second plurality of devices. In some embodiments, the first plurality of devices comprises a sensor, and wherein the second plurality of devices comprises an emitter. In some embodiments, the first plurality of devices comprises a sensor sensing a property, and wherein the second plurality of devices comprises an emitter of the property. In some embodiments, the property comprises light, temperature, sound, pressure, gas type, gas concentration, or gas velocity. In some embodiments, the one or more controllers are configured to utilize a control scheme comprising a feedback, a feed forward, a closed loop, or an open loop control scheme. In some embodiments, the one or more controllers include a controller that is configured to control at least two of (A), (B), and (C). In some embodiments, the one or more controllers include a first controller and a second controller, and wherein the first controller is configured to control different operations of (A), (B), and (C) from the second controller.

In another aspect, an apparatus for altering an environment of an enclosure, the apparatus comprises: a plurality of devices comprising a sensor configured to sense an environmental property of the enclosure; a circuit board to which the plurality of devices is coupled, which circuit board is configured to operatively couple to at least one controller configured to alter the environment using at least one of the plurality of devices; and a casing having an open body and a lid configured to cover an opening of the open body, which casing is configured to enclose (a) the plurality of devices and (b) at least a portion of the circuit board, which lid optionally has a textured portion at an exterior of the lid, which textured portion optionally surrounds at least one hole in the lid, which at least one hole is optionally configure to facilitate sensing of the environmental property by the sensor when the casing is covered by the lid during operation.

In some embodiments, at least one device of the plurality of devices is configured to reversibly couple to the circuit board. In some embodiments, reversible coupling of the at least one device comprises reversible insertion of the at least one device to the circuit board, or reversible extraction of the at least one device from the circuit board. In some embodiments, the circuit board is configured to facilitate reversible couple of at least one device of the plurality of devices. In some embodiments, the casing interior comprises a heat sink or a partition. In some embodiments, the circuit board comprises a heat sink or a hole configured to facilitate sensing of the environmental property by the sensor when the casing is covered by the lid during operation. In some embodiments, the casing has at least one cross section comprising an oblong cross section or a rectangular cross section. In some embodiments, the lid is configured to be snapped to the open body of the casing to close the casing. In some embodiments, the textured portion comprises a mesh or a cloth. In some embodiments, the casing comprises a polymer, resin, glass, ceramic, elemental metal, metal alloy, ceramic, or an allotrope of elemental carbon. In some embodiments, the casing comprises a transparent or a non-transparent portion. In some embodiments, the lid comprises a non-textured exterior portion. In some embodiments, the textured portion comprises a pattern. In some embodiments, the pattern comprises space filling polygons. In some embodiments, the casing is configured to be assembled onto, or into, at least a portion of a fixture of the enclosure. In some embodiments, the casing is configured to attach to a support structure. In some embodiments, the support structure comprises a mast, a pole, or a framing. In some embodiments, the fixture comprises a wall, a ceiling, or a frame. In some embodiments, the frame is a window frame or a door frame.

In another aspect, an apparatus for altering an environment of an enclosure, the apparatus comprises at least one controller having a circuitry, which at least one controller is separately or collectively configured to: (A) communicatively coupled to a plurality of devices comprising a sensor configured to sense an environmental property of the enclosure, which plurality of device are coupled to a circuit board that is at least partially enclosed in a casing (a) that is configured to enclose the plurality of devices and (b) has an open body and a lid configured to cover an opening of the open body, which lid optionally has a textured portion at an exterior of the lid, which textured portion optionally surrounds at least one hole in the lid, which at least one hole is optionally configured to facilitate sensing of the environmental property by the sensor when the casing is covered by the lid during operation; and (B) alter, or direct alteration of, the environment (e.g., atmosphere and/or lighting of the environment) using at least one of the plurality of devices.

In some embodiments, at least one device of the plurality of devices is configured to reversibly couple to the circuit board. In some embodiments, reversible coupling of the at least one device comprises reversible insertion of the at least one device to the circuit board, or reversible extraction of the at least one device from the circuit board. In some embodiments, the circuit board is configured to facilitate reversible coupling of at least one device of the plurality of devices. In some embodiments, the casing interior comprises a heat sink or a partition. In some embodiments, the circuit board comprises a heat sink or a hole configured to facilitate sensing of the environmental property by the sensor when the casing is covered by the lid during operation. In some embodiments, the casing is configured to provide at least one cross section comprising an oblong cross section or a rectangular cross section. In some embodiments, the lid is configured to be snapped to the open body of the casing to close the casing. In some embodiments, the textured portion is configured as a mesh or a cloth. In some embodiments, the casing comprises a polymer, resin, glass, ceramic, elemental metal, metal alloy, ceramic, or an allotrope of elemental carbon. In some embodiments, the casing comprises a transparent or a non-transparent portion. In some embodiments, the lid is configured to provide a non-textured exterior portion. In some embodiments, the textured portion is configured to provide a pattern. In some embodiments, the pattern is configured to include space filling polygons. In some embodiments, the casing is configured to be assembled onto, or into, at least a portion of a fixture of the enclosure. In some embodiments, the casing is configured to attach to a support structure. In some embodiments, the support structure comprises a mast, a pole, or a framing. In some embodiments, the fixture comprises a wall, a ceiling, or a frame. In some embodiments, the frame is a window frame or a door frame. In some embodiments, the casing encloses (i) a processor, (ii) memory, and/or (iii) at least one network component configured to receive and/or transmit network communication. In some embodiments, the processor and/or at least one network component is configured to couple to the network to which the devices are coupled. In some embodiments, the circuit board is a first circuit board, and wherein the processor and/or at least one network component is disposed in a second circuit board. In some embodiments, the second circuit board is separate from the first circuit board. In some embodiments, separation of the first circuit board from the second circuit board facilitate cooling of heat dissipated from the first circuit board and/or second circuit board. In some embodiments, separation of the first circuit board from the second circuit board facilitate active and/or passive gas flow. In some embodiments, the second circuit board is separate from the first circuit board by a shield, heat absorber, cooler, and/or gas. In some embodiments, the heat absorber and/or cooler is active. In some embodiments, the heat absorber and/or cooler is passive. In some embodiments, the apparatus further comprises at least one controller configured to utilize the processor and/or at least one network component to process information related to the plurality of devices. In some embodiments, the apparatus further comprises at least one controller configured to utilize the processor and/or at least one network component to process information unrelated to the plurality of devices. In some embodiments, the apparatus further comprises at least one controller configured to manage power allocated to at least one of the plurality of devices. In some embodiments, the apparatus further comprises at least one controller configured to distribute power allocated to at least two of the plurality of devices sequentially or in parallel. In some embodiments, the apparatus further comprises at least one controller configured to distribute power allocated to at least two of the plurality of devices evenly or unevenly.

In another aspect, a method for altering an environment of an enclosure, the method comprises: (A) providing a casing having an open body and a lid configured to cover an opening of the open body; (B) enclosing a plurality of devices in the casing, the plurality of devices comprising a sensor configured to sense an environmental property of the enclosure; (C) enclosing at least a portion of a circuit board in the casing, the plurality of devices being coupled to the circuit board, which circuit board is configured to operatively couple to at least one controller that alters the environment of the enclosure using at least one of the plurality of devices; (D) optionally providing a textured portion at an exterior of the lid, which textured portion optionally surrounds at least one hole in the lid, which at least one hole is optionally configured to facilitate sensing of the environmental property by the sensor when the casing is covered by the lid during operation; and (E) altering the environment (e.g., atmosphere and/or lighting of the environment) using at least one of the plurality of devices.

In some embodiments, the method further comprises reversibly coupling at least one device of the plurality of devices to the circuit board. In some embodiments, reversibly coupling of the at least one device comprises reversibly inserting the at least one device to the circuit board, or reversibly extracting the at least one device from the circuit board. In some embodiments, the method further comprises configuring the circuit board to facilitate reversible coupling of at least one device of the plurality of devices. In some embodiments, the casing interior comprises a heat sink or a partition. In some embodiments, the circuit board comprises a heat sink or a hole configured to facilitate sensing of the environmental property by the sensor when the casing is covered by the lid during operation. In some embodiments, the casing comprises at least one cross section comprising an oblong cross section or a rectangular cross section. In some embodiments, snapping the lid to close body of the casing. In some embodiments, the textured portion comprises a mesh or a cloth. In some embodiments, the casing comprises a polymer, resin, glass, ceramic, elemental metal, metal alloy, ceramic, or an allotrope of elemental carbon. In some embodiments, the casing comprises a transparent or a non-transparent portion. In some embodiments, the lid to provide a non-textured exterior portion. In some embodiments, the textured portion comprises a pattern. In some embodiments, the pattern comprises space filling polygons. In some embodiments, the method further comprises assembling the onto, or into, at least a portion of a fixture of the enclosure. In some embodiments, the method further comprises attaching the casing to a support structure. In some embodiments, the support structure comprises a mast, a pole, or a framing. In some embodiments, the fixture comprises a wall, a ceiling, or a frame. In some embodiments, the frame is a window frame or a door frame. In some embodiments, the casing encloses (i) a processor, (ii) memory, and/or (iii) at least one network component configured to receive and/or transmit network communication. In some embodiments, the method further comprises using the processor and/or at least one network component to process information related to the plurality of devices. In some embodiments, the method further comprises using the processor and/or at least one network component to process information unrelated to the plurality of devices. In some embodiments, the method further comprises managing power allocated to at least one of the plurality of devices. In some embodiments, the method further comprises distributing power allocated to at least two of the plurality of devices sequentially or in parallel. In some embodiments, the method further comprises distributing power allocated to at least two of the plurality of devices evenly or unevenly. In some embodiments, the circuit board is a first circuit board, and wherein the processor and/or at least one network component is disposed in a second circuit board. In some embodiments, the second circuit board is separate from the first circuit board. In some embodiments, the method further comprises cooling heat dissipated from the first circuit board and/or second circuit board. In some embodiments, the cooling is by using active and/or passive gas flow. In some embodiments, the cooling is by using a shield, heat absorber, cooler, and/or gas. In some embodiments, the heat absorber and/or cooler is active. In some embodiments, the heat absorber and/or cooler is passive.

In another aspect, a non-transitory computer program product for altering an environment of an enclosure, which non-transitory computer program product contains instructions inscribed thereon which, when executed by one or more processors, cause the one or more processors to execute operations, comprises: (A) sensing, or direct sensing of, an environmental property of the enclosure with a sensor that is included in a plurality of devices operatively coupled to a circuit board, the plurality of devices and at least a portion of the circuit board being enclosed in a casing having an open body and a lid configured to cover an opening of the open body, which lid optionally has a textured portion at an exterior of the lid, which textured portion optionally surrounds at least one hole in the lid, which at least one hole is optionally configure to facilitate sensing of the environmental property by the sensor when the casing is covered by the lid during operation; and (B) altering, or direct alteration of, the environment (e.g., atmosphere and/or lighting of the environment) using at least one of the plurality of devices.

In some embodiments, at least one device of the plurality of devices is configured to reversibly couple to the circuit board. In some embodiments, reversible coupling of the at least one device comprises reversible insertion of the at least one device to the circuit board, or reversible extraction of the at least one device from the circuit board. In some embodiments, the circuit board is configured to facilitate reversible coupling of at least one device of the plurality of devices. In some embodiments, the casing interior comprises a heat sink or a partition. In some embodiments, the circuit board comprises a heat sink or a hole configured to facilitate sensing of the environmental property by the sensor when the casing is covered by the lid during operation. In some embodiments, the casing is configured to provide at least one cross section comprising an oblong cross section or a rectangular cross section. In some embodiments, the lid is configured to be snapped to the open body of the casing to close the casing. In some embodiments, the textured portion is configured as a mesh or a cloth. In some embodiments, the casing comprises a polymer, resin, glass, ceramic, elemental metal, metal alloy, ceramic, or an allotrope of elemental carbon. In some embodiments, the casing comprises a transparent or a non-transparent portion. In some embodiments, the lid is configured to provide a non-textured exterior portion. In some embodiments, the textured portion is configured to provide a pattern. In some embodiments, the pattern is configured to include space filling polygons. In some embodiments, the casing is configured to be assembled onto, or into, at least a portion of a fixture of the enclosure. In some embodiments, the casing is configured to attach to a support structure. In some embodiments, the support structure comprises a mast, a pole, or a framing. In some embodiments, the fixture comprises a wall, a ceiling, or a frame. In some embodiments, the frame is a window frame or a door frame. In some embodiments, the casing encloses (i) a processor, (ii) memory, and/or (iii) at least one network component configured to receive and/or transmit network communication. In some embodiments, the processor and/or at least one network component is configured to couple to the network to which the devices are coupled. In some embodiments, the circuit board is a first circuit board, and wherein the processor and/or at least one network component is disposed in a second circuit board. In some embodiments, the second circuit board is separate from the first circuit board. In some embodiments, separation of the first circuit board from the second circuit board facilitate cooling of heat dissipated from the first circuit board and/or second circuit board. In some embodiments, separation of the first circuit board from the second circuit board facilitate active and/or passive gas flow. In some embodiments, the second circuit board is separate from the first circuit board by a shield, heat absorber, cooler, and/or gas. In some embodiments, the heat absorber and/or cooler is active. In some embodiments, the heat absorber and/or cooler is passive. In some embodiments, the operations further comprise using the processor and/or at least one network component to process information related to the plurality of devices. In some embodiments, the operations further comprise using the processor and/or at least one network component to process information unrelated to the plurality of devices. In some embodiments, the operations further comprise managing power allocated to at least one of the plurality of devices. In some embodiments, the operations further comprise distributing power allocated to at least two of the plurality of devices sequentially or in parallel. In some embodiments, the operations further comprise distributing power allocated to at least two of the plurality of devices evenly or unevenly.

In another aspect of the invention, a method manages coexistence of ensembles of modules (e.g., ensemble of devices, which devices are components of the ensemble) contained in assembly units interconnected as nodes in a processing system. A coexistence matrix is formed relating modules in the ensembles to each other, wherein the coexistence matrix includes respective cells characterizing an interference potential between each module as an Aggressor paired with a different module as a Victim. A coexistence controller is operated having a master role over at least some of the assembly units in the processing system. The coexistence matrix controls at least one module within a pair of modules in the coexistence matrix having an interference potential above a threshold to isolate operation of the pair of modules. In some embodiments, the isolation is comprised of a time separation resulting from scheduling of operation of the modules to prevent simultaneous operation of the pair of modules. In some embodiments, the isolation is comprised of a distance separation resulting from the coexistence controller activating a type of module in an ensemble in one assembly unit while deactivating the same type of module in an ensemble in another assembly unit within a predetermined distance of the one assembly unit. In another aspect, the pair of modules can be in a same assembly unit or can be in different assembly units.

In another aspect, a method of the invention a) assigns a node in the processing system the role of the coexistence controller, b) assigns other nodes in the processing system the role of slave to the coexistence controller, and c) then the coexistence controller enumerating the modules within the ensembles. In some embodiments, activity of the coexistence controller is monitored. If the coexistence controller is inactive for a predetermined time, then assigning another node in the processing system with the role of the coexistence controller.

In another aspect, the isolation is comprised of a distance separation resulting from the coexistence controller activating a type of module in an ensemble in one assembly unit while deactivating the same type of module in an ensemble in another assembly unit, and the one assembly unit transmits a result obtained by activating the module in the one assembly unit to the other assembly unit. In some embodiments, the assembly units comprise a respective housing retaining the respective ensemble of modules and adapted for mounting to a structure in an enclosure. In some embodiments, a module in an ensemble within an assembly unit is comprised of a sensor. In some embodiments, a module in an ensemble within an assembly unit is comprised of an emitter. In some embodiments, a module in an ensemble within an assembly unit is comprised of an actuator. In some embodiments, a module in an ensemble within an assembly unit is comprised of a transmitter. In some embodiments, a module in an ensemble within an assembly unit is comprised of a receiver. In some embodiments, modules in an ensemble within an assembly unit are comprised of a plurality of sensors and a plurality of emitters.

In some embodiments, the network is a local network. In some embodiments, the network comprises a cable configured to transmit power and communication in a single cable. The communication can be one or more types of communication. The communication can comprise cellular communication abiding by at least a second generation (2G), third generation (3G), fourth generation (4G) or fifth generation (5G) cellular communication protocol. In some embodiments, the communication comprises media communication facilitating stills, music, or moving picture streams (e.g., movies or videos). In some embodiments, the communication comprises data communication (e.g., sensor data). In some embodiments, the communication comprises control communication, e.g., to control the one or more nodes operatively coupled to the networks. In some embodiments, the network comprises a first (e.g., cabling) network installed in the facility. In some embodiments, the network comprises a (e.g., cabling) network installed in an envelope of the facility (e.g., in an envelope of a building included in the facility).

In another aspect, the present disclosure provides systems, apparatuses (e.g., controllers), and/or non-transitory computer-readable medium or media (e.g., software) that implement any of the methods disclosed herein.

In another aspect, the present disclosure provides methods that use any of the systems, computer readable media, and/or apparatuses disclosed herein, e.g., for their intended purpose.

In another aspect, an apparatus comprises at least one controller that is programmed to direct a mechanism used to implement (e.g., effectuate) any of the method disclosed herein, which at least one controller is configured to operatively couple to the mechanism. In some embodiments, at least two operations (e.g., of the method) are directed/executed by the same controller. In some embodiments, at less at two operations are directed/executed by different controllers.

In another aspect, an apparatus comprises at least one controller that is configured (e.g., programmed) to implement (e.g., effectuate) any of the methods disclosed herein. The at least one controller may implement any of the methods disclosed herein. In some embodiments, at least two operations (e.g., of the method) are directed/executed by the same controller. In some embodiments, at less at two operations are directed/executed by different controllers.

In some embodiments, one controller of the at least one controller is configured to perform two or more operations. In some embodiments, two different controllers of the at least one controller are configured to each perform a different operation.

In another aspect, a system comprises at least one controller that is programmed to direct operation of at least one another apparatus (or component thereof), and the apparatus (or component thereof), wherein the at least one controller is operatively coupled to the apparatus (or to the component thereof). The apparatus (or component thereof) may include any apparatus (or component thereof) disclosed herein. The at least one controller may be configured to direct any apparatus (or component thereof) disclosed herein. The at least one controller may be configured to operatively couple to any apparatus (or component thereof) disclosed herein. In some embodiments, at least two operations (e.g., of the apparatus) are directed by the same controller. In some embodiments, at less at two operations are directed by different controllers.

In another aspect, a computer software product (e.g., inscribed on one or more non-transitory medium) in which program instructions are stored, which instructions, when read by at least one processor (e.g., computer), cause the at least one processor to direct a mechanism disclosed herein to implement (e.g., effectuate) any of the method disclosed herein, wherein the at least one processor is configured to operatively couple to the mechanism. The mechanism can comprise any apparatus (or any component thereof) disclosed herein. In some embodiments, at least two operations (e.g., of the apparatus) are directed/executed by the same processor. In some embodiments, at less at two operations are directed/executed by different processors.

In another aspect, the present disclosure provides a non-transitory computer-readable program instructions (e.g., included in a program product comprising one or more non-transitory medium) comprising machine-executable code that, upon execution by one or more processors, implements any of the methods disclosed herein. In some embodiments, at least two operations (e.g., of the method) are directed/executed by the same processor. In some embodiments, at less at two operations are directed/executed by different processors.

In another aspect, the present disclosure provides a non-transitory computer-readable medium or media comprising machine-executable code that, upon execution by one or more processors, effectuates directions of the controller(s) (e.g., as disclosed herein). In some embodiments, at least two operations (e.g., of the controller) are directed/executed by the same processor. In some embodiments, at less at two operations are directed/executed by different processors.

In another aspect, the present disclosure provides a computer system comprising one or more computer processors and a non-transitory computer-readable medium or media coupled thereto. The non-transitory computer-readable medium comprises machine-executable code that, upon execution by the one or more processors, implements any of the methods disclosed herein and/or effectuates directions of the controller(s) disclosed herein.

In another aspect, the present disclosure provides a non-transitory computer readable program instructions that, when read by one or more processors, causes the one or more processors to execute any operation of the methods disclosed herein, any operation performed (or configured to be performed) by the apparatuses disclosed herein, and/or any operation directed (or configured to be directed) by the apparatuses disclosed herein.

In some embodiments, the program instructions are inscribed in a non-transitory computer readable medium or media. In some embodiments, at least two of the operations are executed by one of the one or more processors. In some embodiments, at least two of the operations are each executed by different processors of the one or more processors.

The content of this summary section is provided as a simplified introduction to the disclosure and is not intended to be used to limit the scope of any invention disclosed herein or the scope of the appended claims.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

These and other features and embodiments will be described in more detail with reference to the drawings.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” and “FIGS.” herein), of which:

FIG. 1 shows a perspective view of an enclosure having an associated control system;

FIG. 2 schematically shows a control system architecture;

FIG. 3 schematically depicts network nodes (e.g., devices) disposed in various enclosures, such as floors of a building;

FIG. 4 shows a schematic example of sensor arrangement and sensor data;

FIG. 5 shows temperature-related changes to a sensor ensemble during operation;

FIG. 6 schematically shows an apparatus, its components, and connectivity options;

FIG. 7 schematically depicts a controller;

FIG. 8 schematically shows a digital architectural element and associated components;

FIG. 9 schematically shows various views and configurations of assembly housings;

FIGS. 10A and 10B schematically shows various plan views showing a device ensemble with a plurality of modules (e.g., devices) on printed circuit board sections;

FIGS. 11A, 11B, and 11C schematically show various views of a capsule;

FIGS. 12A and 12B schematically show various views of a capsule (e.g., ensemble housing);

FIGS. 13A and 13B schematically show front views of capsule portions;

FIGS. 14A and 14B schematically show a light pipe and its inclusion in a capsule portion;

FIG. 15A schematically shows an exploded, perspective view of a framing portion mount for a capsule, and FIG. 15B schematically shows a top, cross section showing the framing portion mount attached to a spline;

FIGS. 16A and 16B schematically show various views of a farming portion (e.g., mullion or transom) cap;

FIG. 17 schematically show various perspective views of capsules and mounting arrangements;

FIG. 18 schematically depicts front view of various capsules;

FIGS. 19A, 19B, 19C, and 19D depict various circuitry board portions;

FIG. 20 schematically depicts integration of electronic components and circuitry;

FIG. 21 schematically shows an assembly architecture;

FIG. 22 schematically shows a representation of a coexistence matrix;

FIG. 23 schematically depicts a controller architecture for managing coexistence of modules;

FIG. 24 schematically depicts a coexistence controller managing a plurality of ensembles (e.g., capsules);

FIG. 25 shows a flowchart of a method for managing coexistence of modules (e.g., devices);

FIG. 26 shows a flowchart of a method for assigning a scheduling role among interconnected ensemble(s) and/or controller(s);

FIG. 27 schematically depicts a processing system;

FIG. 28 schematically shows an electrochromic device;

FIG. 29 schematically shows a cross section of an Integrated Glass Unit (IGU);

FIGS. 30A and 30B schematically shows various views of device ensemble housing and components;

FIG. 31 schematically shows front view of device ensemble housing and example functionalities;

FIG. 32 shows an example of a devise ensemble connected to a fixture via a mast;

FIG. 33 schematically shows various views and configurations of assembly housings;

FIG. 34 schematically shows various plan views showing a device ensemble with a plurality of modules (e.g., devices) on printed circuit board sections;

FIG. 35 schematically shows exploded view and configurations of assembly housings;

FIGS. 36A, 36B, 36C and 36D schematically show various views and configurations of assembly housings; and

FIGS. 37A and 37B show various views of portions of framing systems.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

Terms such as “a,” “an,” and “the” are not intended to refer to only a singular entity but include the general class of which a specific example may be used for illustration. The terminology herein is used to describe specific embodiments of the invention(s), but their usage does not delimit the invention(s).

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.”

As used herein, including in the claims, the conjunction “and/or” in a phrase such as “including X, Y, and/or Z”, refers to in inclusion of any combination or plurality of X, Y, and Z. For example, such phrase is meant to include X. For example, such phrase is meant to include Y. For example, such phrase is meant to include Z. For example, such phrase is meant to include X and Y. For example, such phrase is meant to include X and Z. For example, such phrase is meant to include Y and Z. For example, such phrase is meant to include a plurality of Xs. For example, such phrase is meant to include a plurality of Ys. For example, such phrase is meant to include a plurality of Zs. For example, such phrase is meant to include a plurality of Xs and a plurality of Ys. For example, such phrase is meant to include a plurality of Xs and a plurality of Zs. For example, such phrase is meant to include a plurality of Ys and a plurality of Zs. For example, such phrase is meant to include a plurality of Xs and Y. For example, such phrase is meant to include a plurality of Xs and Z. For example, such phrase is meant to include a plurality of Ys and Z. For example, such phrase is meant to include X and a plurality of Ys. For example, such phrase is meant to include X and a plurality of Zs. For example, such phrase is meant to include Y and a plurality of Zs. The conjunction “and/or” is meant to have the same effect as the phrase “X, Y, Z, or any combination or plurality thereof.” The conjunction “and/or” is meant to have the same effect as the phrase “one or more X, Y, Z, or any combination thereof.”

The term “operatively coupled” or “operatively connected” refers to a first element (e.g., mechanism) that is coupled (e.g., connected) to a second element, to allow the intended operation of the second and/or first element. The coupling may comprise physical or non-physical coupling. The non-physical coupling may comprise signal-induced coupling (e.g., wireless coupling). Coupled can include physical coupling (e.g., physically connected), or non-physical coupling (e.g., via wireless communication). Operatively coupled may comprise communicatively coupled.

An element (e.g., mechanism, device, or electrical component) that is “configured to” perform a function includes a structural feature that causes the element to perform this function. A structural feature may include an electrical feature, such as a circuitry or a circuit element. A structural feature may include a circuitry (e.g., comprising electrical or optical circuitry). Electrical circuitry may comprise one or more wires. Optical circuitry may comprise at least one optical element (e.g., beam splitter, mirror, lens and/or optical fiber). A structural feature may include a mechanical feature. A mechanical feature may comprise a latch, a spring, a closure, a hinge, a chassis, a support, a fastener, or a cantilever, and so forth. Performing the function may comprise utilizing a logical feature. A logical feature may include programming instructions. Programming instructions may be executable by at least one processor. Programming instructions may be stored or encoded on a medium accessible by one or more processors. Additionally, in the following description, the phrases “operable to,” “adapted to,” “configured to,” “designed to,” “programmed to,” or “capable of” may be used interchangeably where appropriate.

In some embodiments, an enclosure comprises an area defined by at least one structure. The at least one structure may comprise at least one wall. An enclosure may comprise and/or enclose one or more sub-enclosure. The at least one wall may comprise metal (e.g., steel), clay, stone, plastic, glass, plaster (e.g., gypsum), polymer (e.g., polyurethane, styrene, or vinyl), asbestos, fiber-glass, concrete (e.g., reinforced concrete), wood, paper, or a ceramic. The at least one wall may comprise wire, bricks, blocks (e.g., cinder blocks), tile, drywall, or frame (e.g., steel frame).

In some embodiments, the enclosure comprises one or more openings. The one or more openings may be reversibly closable. The one or more openings may be permanently open. A fundamental length scale of the one or more openings may be smaller relative to the fundamental length scale of the wall(s) that define the enclosure. A fundamental length scale may comprise a diameter of a bounding circle, a length, a width, or a height. A surface of the one or more openings may be smaller relative to the surface the wall(s) that define the enclosure. The opening surface may be a percentage of the total surface of the wall(s). For example, the opening surface can measure about 30%, 20%, 10%, 5%, or 1% of the walls(s). The wall(s) may comprise a floor, a ceiling or a side wall. The closable opening may be closed by at least one window or door. The enclosure may be at least a portion of a facility. The enclosure may comprise at least a portion of a building. The building may be a private building and/or a commercial building. The building may comprise one or more floors. The building (e.g., floor thereof) may include at least one of: a room, hall, foyer, attic, basement, balcony (e.g., inner or outer balcony), stairwell, corridor, elevator shaft, facade, mezzanine, penthouse, garage, porch (e.g., enclosed porch), terrace (e.g., enclosed terrace), cafeteria, and/or Duct. In some embodiments, an enclosure may be stationary and/or movable (e.g., a train, a plane, a ship, a vehicle, or a rocket).

In some embodiments, the enclosure encloses an atmosphere. The atmosphere may comprise one or more gases. The gases may include inert gases (e.g., argon or nitrogen) and/or non-inert gases (e.g., oxygen or carbon dioxide). The enclosure atmosphere may resemble an atmosphere external to the enclosure (e.g., ambient atmosphere) in at least one external atmosphere characteristic that includes: temperature, relative gas content, gas type (e.g., humidity, and/or oxygen level), debris (e.g., dust and/or pollen), and/or gas velocity. The enclosure atmosphere may be different from the atmosphere external to the enclosure in at least one external atmosphere characteristic that includes: temperature, relative gas content, gas type (e.g., humidity, and/or oxygen level), debris (e.g., dust and/or pollen), and/or gas velocity. For example, the enclosure atmosphere may be less humid (e.g., drier) than the external (e.g., ambient) atmosphere. For example, the enclosure atmosphere may contain the same (e.g., or a substantially similar) oxygen-to-nitrogen ratio as the atmosphere external to the enclosure. The velocity of the gas in the enclosure may be (e.g., substantially) similar throughout the enclosure. The velocity of the gas in the enclosure may be different in different portions of the enclosure (e.g., by flowing gas through to a vent that is coupled with the enclosure).

Certain disclosed embodiments provide a network infrastructure in the enclosure (e.g., a facility such as a building). The network infrastructure is available for various purposes such as for providing communication and/or power services. The communication services may comprise high bandwidth (e.g., wireless and/or wired) communications services. The communication services can be to occupants of a facility and/or users outside the facility (e.g., building). The network infrastructure may work in concert with, or as a partial replacement of, the infrastructure of one or more cellular carriers. The network infrastructure can be provided in a facility that includes electrically switchable windows. Examples of components of the network infrastructure include a high speed backhaul. The network infrastructure may include at least one cable, switch, physical antenna, transceivers, sensor, transmitter, receiver, radio, processor and/or controller (that may comprise a processor). The network infrastructure may be operatively coupled to, and/or include, a wireless network. The network infrastructure may comprise wiring. One or more sensors can be deployed (e.g., installed) in an environment as part of installing the network and/or after installing the network.

In various embodiments, a network infrastructure supports a control system for one or more windows such as electrochromic (e.g., tintable) windows. The control system may comprise one or more controllers operatively coupled (e.g., directly or indirectly) to one or more windows. While the disclosed embodiments describe electrochromic windows (also referred to herein as “optically switchable windows,” “tintable windows”, or “smart windows”), the concepts disclosed herein may apply to other types of switchable optical devices comprising a liquid crystal device, an electrochromic device, suspended particle device (SPD), NanoChromics display (NCD), Organic electroluminescent display (OELD), suspended particle device (SPD), NanoChromics display (NCD), or an Organic electroluminescent display (OELD). The display element may be attached to a part of a transparent body (such as the windows). The tintable window may be disposed in a (non-transitory) facility such as a building, and/or in a transitory vehicle such as a car, RV, buss, train, airplane, helicopter, ship, or boat.

In some embodiments, a building management system (BMS) is a computer-based control system installed in a building that controls (e.g., monitors) the building's mechanical and electrical equipment such as one or more ventilation, lighting, power system, elevator, fire system, and/or security system. Controllers (e.g., nodes and/or processors) described herein may be suited for integration with a BMS. A BMS may consist of hardware, including interconnections by communication channels to computer(s) and/or associated software for maintaining conditions in the building, e.g., according to preferences set by at least one user. The user can be an occupant, an owner, a lessor, and/or a building manager. For example, a BMS may be implemented using a local area network, such as Ethernet. The software can be based at least in part on, for example, internet protocols and/or open standards. One example is software from Tridium, Inc. (of Richmond, Va.). One communication protocol commonly used with a BMS is BACnet (building automation and control networks).

In some embodiments, a BMS is disposed in an enclosure such as a facility. The facility can comprise a building such as a multistory building. The BMS may functions at least to control the environment in the building. The control system and/or BMS may control at least one environmental characteristic of the enclosure. The at least one environmental characteristic may comprise temperature, humidity, fine spray (e.g., aerosol), sound, electromagnetic waves (e.g., light glare, color), gas makeup, gas concentration, gas speed, vibration, volatile compounds (VOCs), debris (e.g., dust), or biological matter (e.g., gas borne bacteria and/or virus). The gas(es) may comprise oxygen, nitrogen, carbon dioxide, carbon monoxide, hydrogen sulfide, Nitric oxide (NO) and nitrogen dioxide (NO₂), inert gas, Nobel gas (e.g., radon), cholorophore, ozone, formaldehyde, methane, or ethane. For example, a BMS may control temperature, carbon dioxide levels, and/or humidity within an enclosure. Mechanical devices that can be controlled by a BMS and/or control system may comprise lighting, a heater, air conditioner, blower, or vent. To control the enclosure (e.g., building) environment, a BMS and/or control system may turn on and off one or more of the devices it controls, e.g., under defined conditions. A (e.g., core) function of a modern BMS and/or control system may be to maintain a comfortable environment for the occupants of the enclosure, e.g., while minimizing energy consumption (e.g., while minimizing heating and cooling costs/demand). A modern BMS and/or control system can be used to control (e.g., monitor), and/or to optimize the synergy between various systems, for example, to conserve energy and/or lower enclosure (e.g., facility) operation costs.

In some embodiments, the control system controls at least one environmental characteristic of an enclosure (e.g., atmosphere of the enclosure). The environmental characteristic can be any environmental characteristic disclosed herein. In some embodiments, the control system provides an alert regarding at least one environmental characteristic of an enclosure (e.g., atmosphere of the enclosure), e.g., when the at least one environmental characteristic deviate from a threshold. The threshold can be a threshold value, a threshold function, or a threshold range (e.g., threshold window). The alert may be in a way of an optical, written, or audio message (e.g., a lit or flashing light, a sound, or a written message).

In some embodiments, the control system is operatively (e.g., communicatively) coupled to an ensemble of devices (e.g., sensors and/or emitters). In some embodiments, the ensemble facilitates the control of the environment and/or the alert. The control may utilize a control scheme such as feedback control, or any other control scheme delineated herein. The ensemble may comprise at least one sensor configured to sense electromagnetic radiation. The electromagnetic radiation may be (humanly) visible, infrared (IR), or ultraviolet (UV) radiation. The at least one sensor may comprise an array of sensors. For example, the ensemble may comprise an IR sensor array (e.g., a far infrared thermal array such as the one by Melexis). The IR sensor array may have a resolution of at least 32x24 pixels. The IR sensor may be coupled to a digital interface. The ensemble may comprise an IR camera. The ensemble may comprise a sound detector. The ensemble may comprise a microphone. The ensemble may comprise any sensor and/or emitter disclosed herein. The ensemble may include CO₂, VOC, temperature, humidity, electromagnetic light, pressure, and/or noise sensors. The sensor may comprise a gesture sensor (e.g., RGB gesture sensor), an acetometer, or a sound sensor. The sounds sensor may comprise an audio decibel level detector. The sensor may comprise a meter driver. The ensemble may include a microphone and/or a processor. The ensemble may comprise a camera (e.g., a 4K pixel camera), a UWB sensor and/or emitter, a Bluetooth (BLE) sensor and/or emitter, a processor. The camera may have any camera resolution disclosed herein. One or more of the devices (e.g., sensors) can be integrated on a chip. The device (e.g., sensor) ensemble may be utilized to determine presence of occupants in an enclosure, their number and/or identity (e.g., using the camera). The device ensemble may be utilized to control (e.g., monitor and/or adjust) one or more environmental characteristics in the enclosure environment.

The sensors coupled to the network may be configured to sense properties comprising temperature, Relative Humidity (RH), Illuminance (e.g., in Lux), temperature (in degrees Celsius), correlated color temperature (CCT, e.g., in degrees Kelvin), carbon dioxide (e.g., in parts per million (ppm)), volatile organic compounds (VOC, e.g., as an index value), pressure (e.g., as sound pressure in Decibels), pulverous material, infrared, ultraviolet, or visible light. The sensor may have an accuracy. The sensor may have a random variability. The random variability (e.g., statistical measures of long-term random variability). The random variability of the temperature sensor may be at most about 0.5 degrees Celsius (° C.), 0.3° C., 0.2° C. or 0.1° C. The random variability of the RH sensor may be at most about 3%, 2%, 1.5%, or 1%. The random variability of the Illuminance sensor may be at most about 20LUX, 15LUX, 10LUX, or 5LUX. The random variability of the CCT sensor may be at most about 250Kelvin (K), 220K, 210K, 200K, 190K, or 150K. The random variability of the carbon dioxide sensor may be at most about 25 ppm, 23 ppm, 20 ppm, 19 ppm, or 15 ppm. The random variability of the VOC sensor may be at most about 15 index value (IV), 12IV, 11lV, 10IV, or 5IV. The random variability of the sound pressure sensor may be at most about 10 Decibels (dB), 8 dB, 5 dB, 4 dB, or 2 dB. At times, a sensor ensemble may comprise measuring the temperature in the device ensemble (e.g., internal device ensemble temperature) and/or out of the device ensemble (e.g., external device ensemble temperature such as temperature in a room in which the device ensemble is disposed). In some embodiments, data from the sensor(s) undergoes processing and/or analysis. The data processing may comprise removing gaps, removing anomalies (e.g., out of range data), performing spatial extrapolation, or calibration. The data processing may be different for data obtained by different types of sensors. For example, data from a temperature sensor may undergo different processing and/or analysis than data from a VOC sensor. The data processing may comprise data imputation. The data processing may comprise data filtering. The data filtering may be different for data obtained by different types of sensors. The data filtering may comprise median, mean, standard deviation, or select minima, as filtering mechanism(s). The data filtering may comprise finding the absolute deviation (e.g., mean absolute deviation, and/or median absolute deviation). At times, a median based approach may be favored over mean based approach. The media may comprise median of an absolute deviation. At times, the data processing and/or analysis may comprise finding a standard deviation of minima, e.g., to derive a long term variation (e.g., in a specific location of the sensor). The median absolute deviation may comprise a median absolute distance from the median. The mean absolute deviation may comprise a mean absolute distance from the mean. The filtering may comprise removing environmental noise (e.g., fluctuations). The spatial extrapolation may be of the property measured by the sensor(s) to the space in which the sensor is disposed, e.g., to provide a sensor property mapping of the space. For example, the sensor data may be of temperature, the spatial mapping may be temperature mapping of a room in which the temperature sensor is disposed. The calibration engine may consider long term drifts on a device basis. Examples for sensor calibration can be found in International Patent Application Ser. No. PCT/US21/15378, filed Jan. 28, 2021, titled “SENSOR CALIBRATION AND OPERATION, which is incorporated herein by reference in its entirety. The data processing and/or analysis may be refreshed, e.g., periodically. For example, sensor sampling may be performed at most every 10 seconds (s), 20s, 30s, 45s, 60s, 2 minutes (min), 5 min, or 10 min. The sensor sampling may be performed between any of the aforementioned values (e.g., from every 10s to every 10 min.) For example, spatial mapping of the sensed property(ies) may be performed at most every 1 minute (min), 2.5 min, 5 min, or 10 min. The spatial mapping may be performed between any of the aforementioned values (e.g., from every 1 min to every 10 min.). The sensor sampling and/or spatial mapping may be performed during periods of high and/or low occupancy of the facility. The sensor sampling and/or spatial mapping may be performed during periods of high and/or low activity in the facility (e.g., of personnel and/or machinery). The sensor sampling and/or spatial mapping may be performed randomly and/or at a whim.

In some embodiments, the ensemble (or a group of ensembles) may be utilized to detect characteristics of enclosure occupant(s). For example, the ensemble may be utilized to detect abnormal bodily characteristic of enclosure occupant(s). The abnormal bodily characteristic may comprise bodily temperature, coughing, sneezing, perspiration (e.g., humidity and/or VOCs expulsion), CO₂ level. The ensemble(s) may be utilized to locate an absolute and/or relative positioning of enclosure occupant(s). For example, the ensemble(s) may be utilized to measure relative distances between occupants in the enclosure, and/or between occupant(s) and hard and/or dense objects in the enclosure. The hard and/or dense objects may comprise fixtures (e.g., wall, ceiling, floor, window, door, shelf, ceiling light, or wall light) or mobile furniture (e.g., chair, desk, or lamp).

In some embodiments, a local (e.g., window) controller can be integrated with a BMS and/or control system. The local controller can be configured to control one or more devices comprising tintable windows (e.g., comprising an electrochromic window), sensors, emitters, or antennas. In one embodiment, the electrochromic windows include at least one all solid state and inorganic electrochromic device. The electrochromic window may include more than one electrochromic device, e.g., where at least two lites (e.g., each lite) are tintable. In one embodiment, the electrochromic windows include (e.g., only) all solid state and inorganic electrochromic devices. In one embodiment, the one or more electrochromic windows include organic electrochromic devices. In one embodiment, the electrochromic windows are multistate electrochromic windows. Examples of tintable windows and their control can be found in U.S. patent application Ser. No. 12/851,514, filed on Aug. 5, 2010, and titled “MULTI-PANE ELECTROCHROMIC WINDOWS” that is incorporated herein by reference in its entirety.

In some embodiments, a plurality of devices may be operatively (e.g., communicatively) coupled to the control system and/or to the BMS. The control system may comprise the hierarchy of controllers. The devices may comprise an emitter, a sensor, or a window (e.g., an insulated glass unit, or IGU). The device may be any device disclosed herein. At least two of the plurality of devices may be of the same type. For example, two or more IGUs may be coupled to the control system. At least two of the plurality of devices may be of different types. For example, a sensor and an emitter may be coupled to the control system. At times, the plurality of devices may comprise at least about 20, 50, 100, 500, 1000, 2500, 5000, 7500, 10000, 50000, 100000, or 500000 devices. The plurality of devices may be of any number between the aforementioned numbers (e.g., from about 20 devices to about 500000 devices, from about 20 devices to about 50 devices, from about 50 devices to about 500 devices, from about 500 devices to about 2500 devices, from about 1000 devices to about 5000 devices, from about 5000 devices to about 10000 devices, from about 10000 devices to about 100000 devices, or from about 100000 devices to about 500000 devices). For example, the number of windows in a floor may be at least about 5, 10, 15, 20, 25, 30, 40, or 50. The number of windows in a floor can be any number between the aforementioned numbers (e.g., from about 5 to about 50, from about 5 to about 25, or from about 25 to about 50). At times, the devices may be in a multi-story building. At least a portion of the floors of the multi-story building may have device(s) controlled by the control system (e.g., at least a portion of the floors of the multi-story building may be controlled by the control system). For example, the multi-story building may have at least about 2, 8, 10, 25, 50, 80, 100, 120, 140, or 160 floors that are controlled by the control system. The number of floors (e.g., devices therein) controlled by the control system may be any number between the aforementioned numbers (e.g., from 2 to 50, from 25 to 100, or from 80 to 160). The floor may be of an area of at least about 150 m², 250 m², 500 m², 1000 m², 1500 m², or 2000 square meters (m²). The floor may have an area between any of the aforementioned floor area values (e.g., from about 150 m² to about 2000 m², from about 150 m² to about 500 m² from about 250 m² to about 1000 m², or from about 1000 m² to about 2000 m²). The building may comprise an area of at least about 1000 square feet (sqft), 2000 sqft, 5000 sqft, 10000 sqft, 100000 sqft, 150000 sqft, 200000 sqft, or 500000 sqft. The building may comprise an area between any of the above mentioned areas (e.g., from about 1000 sqft to about 5000 sqft, from about 5000 sqft to about 500000 sqft, or from about 1000 sqft to about 500000 sqft). The building may comprise an area of at least about 100 m², 200 m², 500 m², 1000 m², 5000 m², 10000 m², 25000 m², or 50000 m². The building may comprise an area between any of the above mentioned areas (e.g., from about 100 m²to about 1000 m², from about 500 m²to about 25000 m², from about 100 m²to about 50000 m²). The facility may comprise a commercial or a residential building. The commercial building may include tenant(s) and/or owner(s). The residential facility may comprise a multi or a single family building. The residential facility may comprise an apartment complex. The residential facility may comprise a single family home. The residential facility may comprise multifamily homes (e.g., apartments). The residential facility may comprise townhouses. The facility may comprise residential and commercial portions.

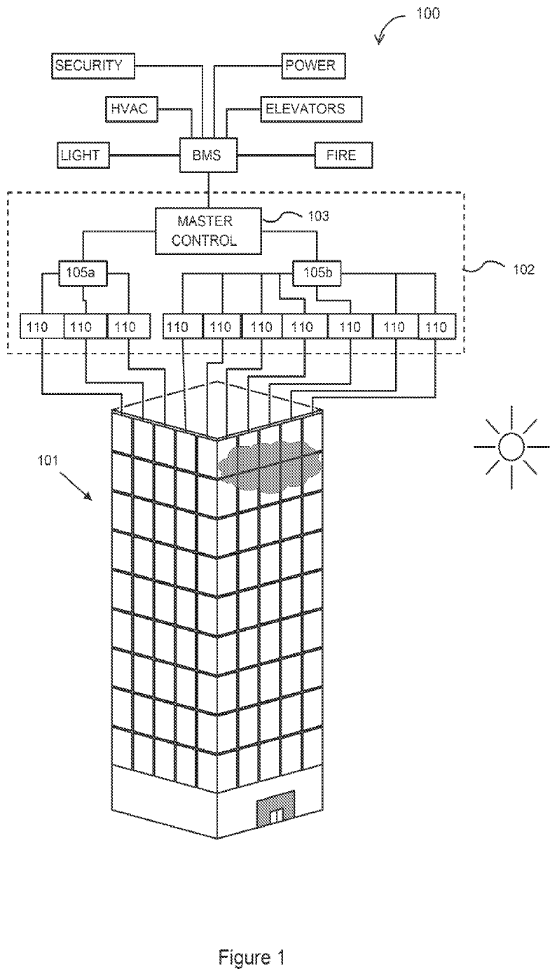

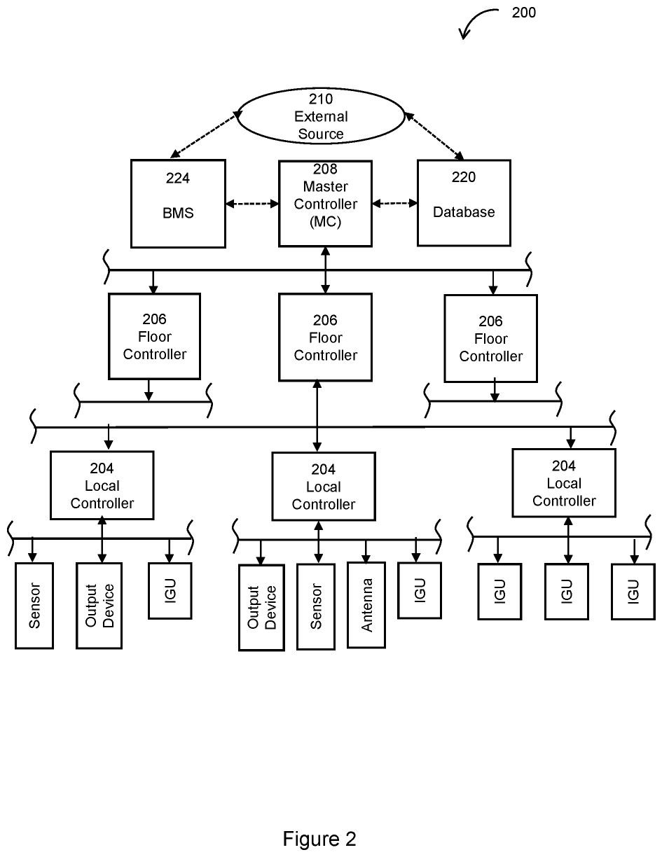

FIG. 1 depicts a schematic diagram example of an embodiment of a BMS and control system 100. In this example, the BMS manages a number of systems of a building 101, including security systems, heating ventilation and air conditioning system (abbreviated herein as “HVAC”), lighting, power systems, elevators, fire systems, and the like. Security systems may include magnetic card access, turnstile, solenoid driven door lock, (e.g., surveillance) camera, (e.g., burglar) alarm, and/or metal detector. The BMS and/or control system may control at least one fire system and/or fire suppression system. The fire system(s) may include fire alarm. The fire suppression system(s) may include a water plumbing control. The lighting system may include interior lighting, exterior lighting, emergency warning light, emergency exit sign, and/or emergency floor (e.g., egress or ingress) lighting. The power system may include the main power for the enclosure (e.g., facility), backup power generator, and/or uninterrupted power source (UPS) grid. The BMS can manage the control system. The BMS can be managed by the control system. The BMS can be included in the control system. In the example shown in FIG. 1, master controller 103 is depicted as a distributed network of local (e.g., window) controllers including a master controller 103, intermediate controllers 105a and 105b (that can be floor controllers and/or network controllers), and local controllers (e.g., end or leaf controllers such as window controllers) 110. Master controller 103 may or may not be in physical proximity to the BMS 100. At least one floor (e.g., each floor) of building 101 may have one or more intermediate controllers 105a and 105b. At least one device (e.g., window) may have its own local controller 110. A local controller may control at least 1, 2, 3, 4, 5, 6, 7, 8, 9, or 10 devices. The control system may or may not have intermediate controller(s). The control system may have 1, 2, 3, or more hierarchal control levels. In the example shown in FIG. 2, a local controller (e.g., 204) can control a plurality of devices. The devices may comprise a window, a sensor, an emitter, an antenna, a receiver, or a transceiver.

At least one (e.g., each) local controller can be disposed in a separate location from the device it controls or be integrated into the device. For simplicity, only ten electrochromic windows of building 101 are depicted as controlled by master controller 103. In a setting there may be a large number of devices in an enclosure controlled by master controller 103.

In some embodiment, the control system may comprise, or be operatively coupled to, a BMS. By incorporating feedback, a BMS and/or control system can provide enhanced: (1) environmental control, (2) energy savings, (3) security, (4) flexibility in control options, (5) improved reliability and usable life of other systems (e.g., coordination of systems may reduce overall operating time of individual systems, leading to less system maintenance), (6) information availability and diagnostics, (7) effective use of, and higher productivity from, staff, and any combination thereof (e.g., because the electrochromic windows can be automatically controlled). In some embodiments, a BMS may not be present, or a BMS may be present but may not communicate with a control system (e.g., with a master controller), or communicate at a high level with the control system (e.g., with a master controller). In certain embodiments, maintenance on the BMS would not interrupt control of the one or more devices (e.g., electrochromic windows) to which the BMS and/or control system is coupled to.

In some embodiments, a processing system has a hierarchical structure including a master controller at a highest level, local controller(s) at an intermediate level, and local controllers (e.g., window controllers) at a lowest level. FIG. 2 shows an example of a control system architecture 200 comprising a master controller 208 that controls floor controllers 206, that in turn control local controllers 204. In some embodiments, a local controller controls one or more ICUs, one or more sensors, one or more output devices (e.g., one or more emitters), one or more antennas, or any combination thereof. FIG. 2 shows an example of a configuration in which the master controller is operatively coupled (e.g., wirelessly and/or wired) to a building management system (BMS) 224 and to a database 220. Arrows in FIG. 2 represent communication pathways. A controller may be operatively coupled (e.g., directly/indirectly and/or wired and wirelessly) to an external source 210. The external source may comprise a network. The external source may comprise one or more sensor or output devices. The external source may comprise a cloud-based application and/or database. The communication may be wired and/or wireless. The external source may be disposed external to the facility. For example, the external source may comprise one or more sensors and/or antennas disposed, e.g., on a wall or on a ceiling of the facility. The communication may be mono-directional or bidirectional. In the example shown in FIG. 2, all communication arrows are meant to be bidirectional.

In some embodiments, the sensors and/or other modules are operatively coupled to at least one controller and/or processor in one or more separate assemblies. Sensor readings may be obtained by one or more processors and/or controllers. A controller may comprise a processing unit (e.g., CPU or GPU). A controller may receive an input (e.g., from at least one sensor). The controller may comprise circuitry, electrical wiring, optical wiring, socket, and/or outlet. A controller may deliver an output. A controller may comprise multiple (e.g., sub-) controllers. The controller may be a part of a control system. A control system may comprise a master controller, a floor (e.g., comprising network controller) controller, or a local controller. The local controller may be a window controller (e.g., controlling an optically switchable window), enclosure controller, or component controller. For example, a controller may be a part of a hierarchal control system (e.g., comprising a main controller that directs one or more controllers, e.g., floor controllers, local controllers (e.g., window controllers), enclosure controllers, and/or component controllers). A physical location of the controller type in the hierarchal control system may be changing. For example: at a first time: a first processor may assume a role of a main controller, a second processor may assume a role of a floor controller, and a third processor may assume the role of a local controller. At a second time: the second processor may assume a role of a main controller, the first processor may assume a role of a floor controller, and the third processor may remain with the role of a local controller. At a third time: the third processor may assume a role of a main controller, the second processor may assume a role of a floor controller, and the first processor may assume the role of a local controller. A controller may control one or more devices (e.g., be directly coupled to the devices). A controller may be disposed proximal to the one or more devices it is controlling. For example, a controller may control an optically switchable device (e.g., IGU), an antenna, a sensor, and/or an output device (e.g., a light source, sounds source, smell source, gas source, HVAC outlet, or heater). In one embodiment, a floor controller may direct one or more window controllers, one or more enclosure controllers, one or more component controllers, or any combination thereof. The floor controller may comprise a network controller. For example, the floor (e.g., comprising network) controller may control a plurality of local (e.g., comprising window) controllers. A plurality of local controllers may be disposed in a portion of a facility (e.g., in a portion of a building). The portion of the facility may be a floor of a facility. For example, a floor controller may be assigned to a floor. In some embodiments, a floor may comprise a plurality of floor controllers, e.g., depending on the floor size and/or the number of local controllers coupled to the floor controller. For example, a floor controller may be assigned to a portion of a floor. For example, a floor controller may be assigned to a portion of the local controllers disposed in the facility. For example, a floor controller may be assigned to a portion of the floors of a facility. A master controller may be coupled to one or more floor controllers. The floor controller may be disposed in the facility. The master controller may be disposed in the facility, or external to the facility. The master controller may be disposed in the cloud. A controller may be a part of, or be operatively coupled to, a building management system. A controller may receive one or more inputs. A controller may generate one or more outputs. The controller may be a single input single output controller (SISO) or a multiple input multiple output controller (MIMO). A controller may interpret an input signal received. A controller may acquire data from the one or more components (e.g., sensors). Acquire may comprise receive or extract. The data may comprise measurement, estimation, determination, generation, or any combination thereof. A controller may comprise feedback control. A controller may comprise feed-forward control. Control may comprise on-off control, proportional control, proportional-integral (P1) control, or proportional-integral-derivative (PID) control. Control may comprise open loop control, or closed loop control. A controller may comprise closed loop control. A controller may comprise open loop control. A controller may comprise a user interface. A user interface may comprise (or be operatively coupled to) a keyboard, keypad, mouse, touch screen, microphone, speech recognition package, camera, imaging system, or any combination thereof. Outputs may include a display (e.g., screen), speaker, or printer.

In some embodiments, a floor controller (e.g., a network controller) can have a structure as shown for a network controller described in U.S. Pat. No. 10,495,939, issued Dec. 3, 2019, entitled “CONTROLLERS FOR OPTICALLY-SWITCHABLE DEVICES,” that is incorporated herein by reference in its entirety. In some embodiments, a floor controller can take over some of the functions, processes or operations of a master controller. The floor controller can include additional functionalities and/or capabilities not described with reference to the master controller.

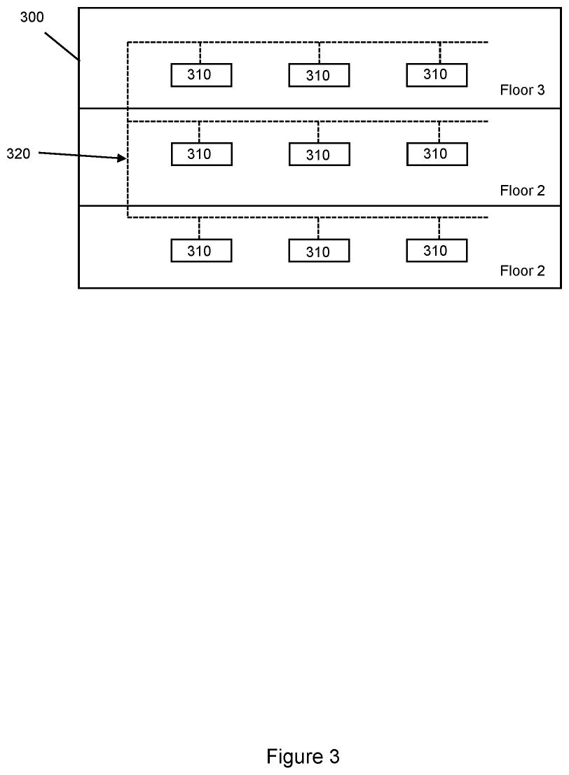

In some embodiments, a plurality of assemblies (e.g., ensembles) are deployed as interconnected nodes within a processing system throughout a particular enclosure (e.g., a building), portions thereof (e.g., rooms or floors), or spanning a plurality of such enclosures. FIG. 3 shows a schematic example of a processing system (e.g., controller network) within an enclosure. In the example of FIG. 3, the enclosure 300 is a building having floor 1, floor 2, and floor 3. The enclosure 300 includes a network 320 (e.g., a wired network) that is provided to communicatively couple a community of components (e.g., nodes) 310. In the example shown in FIG. 3, the three floors are sub enclosures within the enclosure 300. At least two of the devices 310 can be of a different type from each other. At least two of the devices 310 can be of the same type.

In some embodiments, an enclosure includes one or more sensors. The sensor may facilitate controlling the environment of the enclosure, e.g., such that inhabitants of the enclosure may have an environment that is more comfortable, delightful, beautiful, healthy, productive (e.g., in terms of inhabitant performance), easer to live (e.g., work) in, or any combination thereof. The sensor(s) may be configured as low or high resolution sensors. Sensor may provide on/off indications of the occurrence and/or presence of an environmental event (e.g., one pixel sensors). In some embodiments, the accuracy and/or resolution of a sensor may be improved via artificial intelligence (abbreviated herein as “Al”) analysis of its measurements. Examples of artificial intelligence techniques that may be used include: reactive, limited memory, theory of mind, and/or self-aware techniques). In some embodiments, the sensor data analysis comprises linear regression, least squares fit, Gaussian process regression, kernel regression, nonparametric multiplicative regression (NPMR), regression trees, local regression, semiparametric regression, isotonic regression, multivariate adaptive regression splines (MARS), logistic regression, robust regression, polynomial regression, stepwise regression, ridge regression, lasso regression, elasticnet regression, principal component analysis (PCA), singular value decomposition, fuzzy measure theory, Borel measure, Han measure, risk-neutral measure, Lebesgue measure, group method of data handling (GMDH), Naive Bayes classifiers, k-nearest neighbors algorithm (k-NN), support vector machines (SVMs), neural networks, support vector machines, classification and regression trees (CART), random forest, gradient boosting, or generalized linear model (GLM) technique. Sensors may be configured to process, measure, analyze, detect and/or react to: data, temperature, humidity, sound, force, pressure, concentration, electromagnetic waves, position, distance, movement, flow, acceleration, speed, vibration, dust, light, glare, color, gas(es) type, and/or other aspects (e.g., characteristics) of an environment (e.g., of an enclosure). The gases may include volatile organic compounds (VOCs). The gases may include carbon monoxide, carbon dioxide, water vapor (e.g., humidity), oxygen, radon, and/or hydrogen sulfide. The one or more sensors may be calibrated in a factory setting and/or in the facility. A sensor may be optimized to performing accurate measurements of one or more environmental characteristics present in the factory setting and/or in the facility in which it is deployed.

In some embodiments, a plurality of sensors of the same type may be distributed in a plurality of nodes in an enclosure. At least one of the plurality of sensors of the same type, may be part of an ensemble. For example, at least two of the plurality of sensors of the same type, may be part of at least two different ensembles. The sensor ensembles may be distributed in an enclosure. An enclosure may comprise a conference room or a cafeteria. For example, a plurality of sensors of the same type may measure an environmental parameter in the conference room. Responsive to measurement of the environmental parameter of an enclosure, a parameter topology of the enclosure may be generated. A parameter topology may be generated utilizing output signals from any type of sensor or sensor ensemble, e.g., as disclosed herein. Parameter topologies may be generated for any enclosure of a facility such as conference rooms, hallways, bathrooms, cafeterias, garages, auditoriums, utility rooms, storage facilities, equipment rooms, and/or elevators.

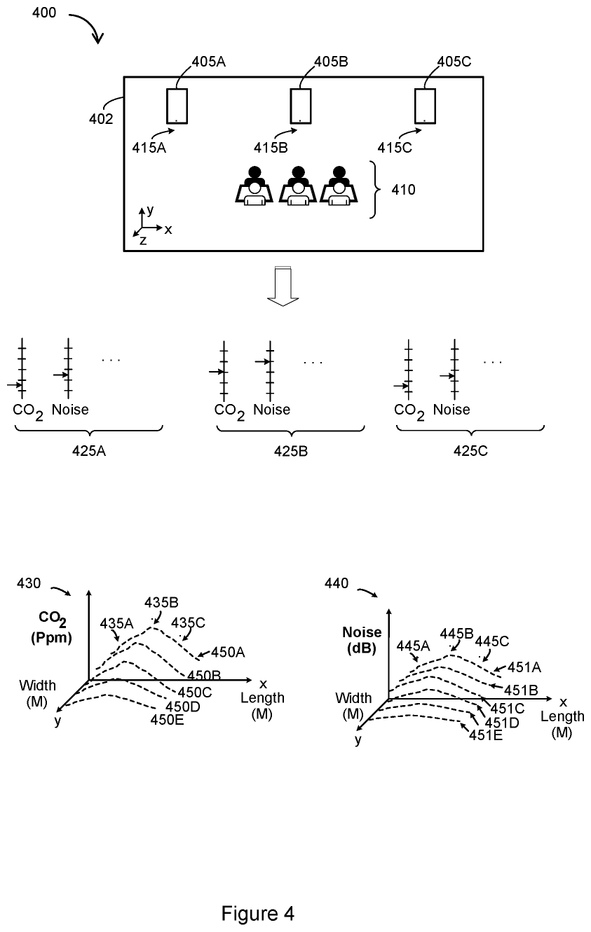

FIG. 4 shows an example of a diagram 400 of an arrangement of sensor ensembles distributed within an enclosure. In some embodiments, the ensembles include emitter(s), (e.g., local) controller(s), antenna(s), radar(s), or other modules. In the example shown in FIG. 4, a group 410 of individuals are seated in conference room 402. The conference room includes an “X” dimension to indicate length, a “Y” dimension to indicate height, and a “Z” dimension to indicate depth. XYZ being directions a Cartesian coordination system. At least two sensor ensembles (e.g., 405A, 405B, and 405C) may be integrated into a respective consolidated assembly. Sensor ensembles 405A, 405B, and 405C can include a carbon dioxide (CO₂) sensor, an ambient noise sensor, or any other sensor disclosed herein. In the example shown in FIG. 4, a first sensor ensemble 405A is disposed (e.g., installed) near point 415A, which may correspond to a location in a ceiling, wall, or other location to a side of a table at which the group 410 of individuals are seated. In the example shown in FIG. 4, a second sensor ensemble 405B is disposed (e.g., installed) near point 415B, which may correspond to a location in a ceiling, wall, or other location above (e.g., directly above) a table at which the group 410 of individuals are seated. In the example shown in FIG. 4, a third sensor ensemble 405C may be disposed (e.g., installed) at or near point 415C, which may correspond to a location in a ceiling, wall, or other location to a side of the table at which the relatively small group 410 of individuals are seated. Any number of additional sensors and/or sensor modules may be positioned at other locations of conference room 402. The sensor ensembles may be disposed anywhere in the enclosure. The location of an ensemble of sensors in an enclosure may have coordinates (e.g., in a Cartesian coordinate system). At least one coordinate (e.g., of x, y, and z) may differ between two or more sensor ensembles, e.g., that are disposed in the enclosure. At least two coordinates (e.g., of x, y, and z) may differ between two or more sensor ensembles, e.g., that are disposed in the enclosure. All the coordinates (e.g., of x, y, and z) may differ between two or more sensor ensembles, e.g., that are disposed in the enclosure. For example, two sensor ensembles may have the same x coordinate, and different y and z coordinates. For example, two sensor ensembles may have the same x and y coordinates, and a different z coordinate. For example, two sensor ensembles may have different x, y, and z coordinates.

In particular embodiments, one or more sensors of the sensor ensemble provide readings. In some embodiments, the sensor is configured to sense a parameter. The parameter may comprise temperature, particulate matter, volatile organic compounds, electromagnetic energy, pressure, concentration, acceleration, time, radar, lidar, glass breakage, movement, or gas type. The gas type may comprise a Nobel gas. The gas may be a gas harmful to an average human. The gas may be a gas present in the ambient atmosphere (e.g., oxygen, carbon dioxide, ozone, chlorinated carbon compounds, or nitrogen). The gas may comprise radon, carbon monoxide, hydrogen sulfide, phosgene, formaldehyde (or other volatile aldehyde), hydrogen, oxygen, water (e.g., humidity). The electromagnetic sensor may comprise an infrared, visible light, ultraviolet sensor. The infrared radiation may be passive infrared radiation (e.g., black body radiation). The electromagnetic sensor may sense geo-location related signals. The electromagnetic sensor may sense UWB, GPS, and/or BLE signals. The electromagnetic sensor may sense radio waves. The radio waves may comprise wide band, or ultra-wideband (UWB) radio signals. The radio waves may comprise pulse radio waves. The radio waves may comprise radio waves utilized in communication. The gas sensor may sense a gas type, flow (e.g., velocity and/or acceleration), pressure (absolute or relative such as partial gas pressure), and/or concentration (absolute or relative). The readings may have an amplitude range. The readings may have a parameter range. For example, the parameter may be electromagnetic wavelength. For example, the range may be a range of detected wavelengths.

In some embodiments, a device (e.g., transceiver) and/or a (local) network to which the device is operatively coupled to, is configured for radio communication. In some embodiments, a transceiver and/or the local network may be configured transmit and receive one or more signals using a personal area network (PAN) standard, for example such as IEEE 802.15.4. In some embodiments, signals may comprise Bluetooth, Wi-Fi, or EnOcean signals (e.g., wide bandwidth). The one or more signals may comprise ultra-wide bandwidth (UWB) signals (e.g., having a frequency in the range from about 2.4 to about 10.6 Giga Hertz (GHz), or from about 7.5 GHz to about 10.6 GHz). An Ultra-wideband signal can be one having a fractional bandwidth greater than about 20 %. An ultra-wideband signal can have a bandwidth greater than about 500 Mega Hertz (MHz). The one or more signals may use a low energy level (e.g., low power) for short-range. Signals (e.g., having radio frequency) may employ a spectrum capable of penetrating solid structures (e.g., wall, door, and/or window). Low power may be of at most 25 milli Watts (mW), 50 mW, 75 mW, or 100 mW. Low power may be any value between the aforementioned values (e.g., from 25 mW to 100 mW, from 25 mW to 50 mW, or from 75 mW to 100 mW). In some embodiments the local network (e.g., comprising one or more stationary sensors and/or stationary transceivers) is configured to (I) located a transitory transceiver in real time, (II) locate the transitory transceiver to an accuracy of about 20, 10, or 5 centimeters or to a higher accuracy, (Ill) transmit and sense ultrawide radio waves, and/or (IV) operatively couple to a control system configured to control a facility in which the local network of one or more stationary sensors and/or stationary transceivers are disposed.

In some embodiments, the (local) network incorporates and/or facilitates geo-location technology (e.g., global positioning system (GPS), Bluetooth (BLE), ultrawide band (UWB) and/or dead-reckoning), e.g., using a micro-location chip. The geo-location technology may facilitate determination of a position of signal source (e.g., location of a transitory tag comprising a transceiver facilitating the geo-location technology) to an accuracy of at least 100 centimeters (cm), 75 cm, 50 cm, 25 cm, 20 cm, 10 cm, or 5 cm. In some embodiments, the electromagnetic radiation of the signal comprises ultra-wideband (UWB) radio waves, ultra-high frequency (UHF) radio waves, or radio waves utilized in global positioning system (GPS). In some embodiments, the electromagnetic radiation comprises electromagnetic waves of a frequency of at least about 300 MHz, 500 MHz, or 1200 MHz. In some embodiments, the signal comprises location and/or time data. Localization may be of a transitory circuitry (e.g., identification tag). Localization may utilize one or more stationary device (e.g., comprising a sensor, emitter, and/or transceiver). In some embodiments, the transitory circuitry to be located utilizes Bluetooth, UWB, UHF, and/or global positioning system (GPS) technology. In some embodiments, the signal has a spatial capacity of at least about 1013 bits per second per meter squared (bit/s/m²).

In some embodiments, pulse-based ultra-wideband (UWB) technology (e.g., ECMA-368, or ECMA-369) is a wireless technology for transmitting large amounts of data at low power (e.g., less than about 1 millivolt (mW), 0.75 mW, 0.5 mW, or 0.25 mW) over short distances (e.g., of at most about 300 feet 0, 250′, 230′, 200′, or 150′). A UWB signal can occupy at least about 750 MHz, 500 MHz, or 250 MHz of bandwidth spectrum, and/or at least about 30%, 20%, or 10% of its center frequency. The UWB signal can be transmitted by one or more pulses. A component broadcasts digital signal pulses may be timed (e.g., precisely) on a carrier signal across a number of frequency channels at the same time. Information may be transmitted, e.g., by modulating the timing and/or positioning of the signal (e.g., the pulses). Signal information may be transmitted by encoding the polarity of the signal (e.g., pulse), its amplitude and/or by using orthogonal signals (e.g., pulses). The UWB signal may be a low power information transfer protocol. The UWB technology may be utilized for (e.g., indoor) location applications. The broad range of the UWB spectrum comprises low frequencies having long wavelengths, which allows UWB signals to penetrate a variety of materials, including various building fixtures (e.g., walls). The wide range of frequencies, e.g., including the low penetrating frequencies, may decrease the chance of multipath propagation errors (without wishing to be bound to theory, as some wavelengths may have a line-of-sight trajectory). UWB communication signals (e.g., pulses) may be short (e.g., of at most about 70 cm, 60 cm, or 50 cm for a pulse that is about 600 MHz, 500 MHz, or 400 MHz wide; or of at most about 20 cm, 23 cm, 25 cm, or 30 cm for a pulse that is has a bandwidth of about 1 GHz, 1.2 GHz, 1.3 GHz, or 1.5 GHz). The short communication signals (e.g., pulses) may reduce the chance that reflecting signals (e.g., pulses) will overlap with the original signal (e.g., pulse).

In some embodiments, a transitory circuitry (e.g., tag) is locatable in the enclosure (e.g., facility such as a building). The user can be located using one or more sensors and/or transceivers. A user and/or asset may carry the tag. The tag may include radio frequency identification (e.g., RFID) technology (e.g., transceiver), Bluetooth technology, and/or Global Positional System (GPS) technology. The radio frequency may comprise ultrawide band radio frequency. The tag may be sensed by one or more sensors disposed in the enclosure. The sensor may be part of a transceiver. The sensor(s) may be disposed in a device ensemble. The device ensemble may comprise a sensor or an emitter. The sensor(s) may be operatively (e.g., communicatively) coupled to the network. The network may have low latency communication, e.g., within the enclosure. The radio waves (e.g., emitted and/or sensed by the tag) may comprise wide band, or ultra-wideband radio signals. The radio waves may comprise pulse radio waves. The radio waves may comprise radio waves utilized in communication. The radio waves may be at a medium frequency of at least about 300 kilohertz (KHz), 500 KHz, 800 KHz, 1000 KHz, 1500 KHz, 2000 KHz, or 2500 KHz. The radio waves may be at a medium frequency of at most about 500 KHz, 800 KHz, 1000 KHz, 1500 KHz, 2000 KHz, 2500 KHz, or 3000 KHz. The radio waves may be at any frequency between the aforementioned frequency ranges (e.g., from about 300 KHz to about 3000 KHz). The radio waves may be at a high frequency of at least about 3 megahertz (MHz), 5 MHz, 8 MHz, 10 MHz, 15 MHz, 20 MHz, or 25 MHz. The radio waves may be at a high frequency of at most about 5 MHz, 8 MHz, 10 MHz, 15 MHz, 20 MHz, 25 MHz, or 30 MHz. The radio waves may be at any frequency between the aforementioned frequency ranges (e.g., from about 3 MHz to about 30 MHz). The radio waves may be at a very high frequency of at least about 30 Megahertz (MHz), 50 MHz, 80 MHz, 100 MHz, 150 MHz, 200 MHz, or 250 MHz. The radio waves may be at a very high frequency of at most about 50 MHz, 80 MHz, 100 MHz, 150 MHz, 200 MHz, 250 MHz, or 300 MHz. The radio waves may be at any frequency between the aforementioned frequency ranges (e.g., from about 30 MHz to about 300 MHz). The radio waves may be at an ultra-high frequency of at least about 300 kilohertz

(MHz), 500 MHz, 800 MHz, 1000 MHz, 1500 MHz, 2000 MHz, or 2500 MHz. The radio waves may be at an ultra-high frequency of at most about 500 MHz, 800 MHz, 1000 MHz, 1500 MHz, 2000 MHz, 2500 MHz, or 3000 MHz. The radio waves may be at any frequency between the aforementioned frequency ranges (e.g., from about 300 MHz to about 3000 MHz). The radio waves may be at a super high frequency of at least about 3 gigahertz (GHz), 5 GHz, 8 GHz, 10 GHz, 15 GHz, 20 GHz, or 25 GHz. The radio waves may be at a super high frequency of at most about 5 GHz, 8 GHz, 10 GHz, 15 GHz, 20 GHz, 25 GHz, or 30 GHz. The radio waves may be at any frequency between the aforementioned frequency ranges (e.g., from about 3 GHz to about 30 GHz).

In some embodiments, the identification tag of the occupant comprises a location device. The location device (also referred to herein as “locating device”) may compromise a radio emitter and/or receiver (e.g., a wide band, or ultra-wide band radio emitter and/or receiver). The locating device may include a Global Positioning System (GPS) device. The locating device may include a Bluetooth device. The locating device may include a radio wave transmitter and/or receiver. The radio waves may comprise wide band, or ultra-wideband radio signals. The radio waves may comprise pulse radio waves. The radio waves may comprise radio waves utilized in communication. The radio waves may be at a medium frequency of at least about 300 kilohertz (KHz), 500 KHz, 800 KHz, 1000 KHz, 1500 KHz, 2000 KHz, or 2500 KHz. The radio waves may be at a medium frequency of at most about 500 KHz, 800 KHz, 1000 KHz, 1500 KHz, 2000 KHz, 2500 KHz, or 3000 KHz. The radio waves may be at any frequency between the aforementioned frequency ranges (e.g., from about 300 KHz to about 3000 KHz). The radio waves may be at a high frequency of at least about 3 megahertz (MHz), 5 MHz, 8 MHz, 10 MHz, 15 MHz, 20 MHz, or 25 MHz. The radio waves may be at a high frequency of at most about 5 MHz, 8 MHz, 10 MHz, 15 MHz, 20 MHz, 25 MHz, or 30 MHz. The radio waves may be at any frequency between the aforementioned frequency ranges (e.g., from about 3 MHz to about 30 MHz). The radio waves may be at a very high frequency of at least about 30 Megahertz (MHz), 50 MHz, 80 MHz, 100 MHz, 150 MHz, 200 MHz, or 250 MHz. The radio waves may be at a very high frequency of at most about 50 MHz, 80 MHz, 100 MHz, 150 MHz, 200 MHz, 250 MHz, or 300 MHz. The radio waves may be at any frequency between the aforementioned frequency ranges (e.g., from about 30MHz to about 300 MHz). The radio waves may be at an ultra-high frequency of at least about 300 kilohertz (MHz), 500 MHz, 800 MHz, 1000 MHz, 1500 MHz, 2000 MHz, or 2500 MHz. The radio waves may be at an ultra-high frequency of at most about 500 MHz, 800 MHz, 1000 MHz, 1500 MHz, 2000 MHz, 2500 MHz, or 3000 MHz. The radio waves may be at any frequency between the aforementioned frequency ranges (e.g., from about 300 MHz to about 3000 MHz). The radio waves may be at a super high frequency of at least about 3 gigahertz (GHz), 5 GHz, 8 GHz, 10 GHz, 15 GHz, 20 GHz, or 25 GHz. The radio waves may be at a super high frequency of at most about 5 GHz, 8 GHz, 10 GHz, 15 GHz, 20 GHz, 25 GHz, or 30 GHz. The radio waves may be at any frequency between the aforementioned frequency ranges (e.g., from about 3 GHz to about 30 GHz).

In some embodiments, the locating device facilitates location within an error range. The error range of the locating device may be at most about 5 meters (m), 4 m, 3 m, 2 m, 1 m, 0.5 m, 0.4 m, 0.3 m, 0.2 m, 0.1 m, or 0.05 m. The error range of the locating device may be any value between the aforementioned values (e.g., from about 5 m to about 0.05 m, from about 5 m to about 1 m, from about 1 m to about 0.3 m, and from about 0.3 m to about 0.05 m). The error range may represent the accuracy of the locating device.

In certain embodiments, a (e.g., local such as a facility) network infrastructure has a vertical data plane (between building floors) and a horizontal data plane (within a single floor or multiple contiguous floors). The horizontal and vertical data planes may have at least one data carrying capability that is (e.g., substantially) similar. The horizontal and vertical data plane may have at least one type of network components that is (e.g., substantially) similar. In other cases, these two data planes have different data carrying capabilities. In some cases, the horizontal and vertical data planes have (e.g., substantially) the same (or similar) data carrying capabilities and/or type of network components. In other cases, the vertical and horizontal data planes have at least one (e.g., all) data carrying capability and/or network component that is different from each other. For example, the vertical data plane may contain network components for fast communication (e.g., data transmission) rates and/or bandwidths. The faster communication rates may be at least about 1 Gigabits per second (Gbit/s), 10 Gbit/s, 50 Gbit/s, 100 Gbit/s, 250 Gbit/s, 500 Gbit/s, 750 Gbit/s, 1 terabits per second (Tbit/s), or 1.125 Tbit/s. The faster communication rates can be any communication rate between the aforementioned rates (e.g., from about 1 Gbit/s to about 1.125 Tbit/s, from about 1 Gbit/s to about 500 Gbit/s, or from about 250 Gbit/s to about 1.125 Tbit/s). The vertical network component may comprise an optical fiber. The horizontal network component may comprise coaxial cabling or twisted cables. The horizontal network component may be devoid of one or more optical cables.

In some embodiments, the sensor data is responsive to the environment in the enclosure and/or to any inducer(s) of a change (e.g., any environmental disruptor) in this environment. The sensors data may be responsive to emitter(s) operatively coupled to (e.g., in) the enclosure (e.g., the emission source can be an occupant, appliance (e.g., heater, cooler, ventilation, and/or vacuum), and/or an enclosure opening). For example, the sensor data may be responsive to an air conditioning duct, or to an open window. The sensor data may be responsive to an activity taking place in the room. The activity may include human activity, and/or non-human activity. The activity may include electronic activity, gaseous activity, and/or chemical activity. The activity may include a sensual activity (e.g., visual, tactile, olfactory, auditory, and/or gustatory). The activity may include an electronic and/or magnetic activity. The activity may be sensed by a person. The activity may not be sensed by a person. The sensors data may be responsive to the occupants in the enclosure, substance (e.g., gas) flow, substance (e.g., gas) pressure, and/or temperature.

In one example, sensor ensembles (e.g., 405A, 405B, and 405C) can include carbon dioxide (CO₂) sensor, and an ambient noise sensor. A carbon dioxide sensor of sensor ensemble 405A may provide a reading as depicted in sensor output reading profile 425A shown in the example of FIG. 4. A noise sensor of sensor ensemble 405A may provide a reading also depicted in sensor output reading profile 425A. A carbon dioxide sensor of sensor ensemble 405B may provide a reading as depicted in sensor output reading profile 425B. A noise sensor of sensor ensemble 405B may provide a reading also as depicted in sensor output reading profile 425B. Sensor output reading profile 425B may indicate higher levels of carbon dioxide and nose relative to sensor output reading profile 425A. Sensor output reading profile 425C may indicate lower levels of carbon dioxide and noise relative to sensor output reading profile 425B. Sensor output reading profile 425C may indicate carbon dioxide and noise levels similar to those of sensor output reading profile 425A. Sensor output reading profiles 425A, 425B, and 425C may comprise indications representing other sensor readings, such as temperature, humidity, particulate matter, volatile organic compounds, ambient light, pressure, acceleration, time, radar, lidar, ultra-wideband radio signals, passive infrared, and/or glass breakage, movement detectors.

In some embodiments, data from a sensor in a sensor in the enclosure (e.g., and in the sensor ensemble) is collected and/or processed (e.g., analyzed). The data processing can be performed by a processor of the sensor, by a processor of the sensor ensemble, by another sensor, by another ensemble, in the cloud, by a processor of the controller, by a processor in the enclosure, by a processor outside of the enclosure, by a remote processor (e.g., in a different facility), by a manufacturer (e.g., of the sensor, of the window, and/or of the building network). The processing may be at least partially local (e.g., in the ensemble and/or enclosure in which the ensemble is disposed). The processing may be done at least in part remotely (e.g., outside of the ensemble, outside of the enclosure, and/or in the cloud). The processing can be done at least in part by the control system. The processing may be communicated via the network. The data of the sensor may have a time indicator (e.g., may be time stamped). The data of the sensor may have a sensor and/or location identification (e.g., be location stamped and/or sensor stamped—such as by the identification number of the sensor). The sensor may be identifiably coupled with one or more controllers.

In particular embodiments, sensor output reading profiles (e.g., 425A, 425B, and 425C) may be processed. For example, as part of the processing (e.g., analysis), the sensor output reading profiles may be plotted on a graph depicting a sensor reading as a function of a dimension (e.g., the “X” dimension) of an enclosure (e.g., conference room 402). In an example, a carbon dioxide level indicated in sensor output reading profile 425A may be indicated as point 435A of CO₂ graph 430 of the example shown in FIG. 4. In an example, a carbon dioxide level of sensor output reading profile 425B may be indicated as point 435B of CO₂ graph 430. In an example, a carbon dioxide level indicated in sensor output reading profile 425C may be indicated as point 435C of CO₂ graph 430. In an example, an ambient noise level indicated in sensor output reading profile 425A may be indicated as point 445A of noise graph 440. In an example, an ambient noise level indicated in sensor output reading profile 425B may be indicated as point 445B of noise graph 440. In an example, an ambient noise level indicated in sensor output reading profile 425C may be indicated as point 445C of noise graph 440.

In some embodiments, processing data derived from the sensor comprises applying one or more models. The models may comprise a mathematical model. The processing may comprise fitting of model(s) (e.g., curve fitting). The model may be multi-dimensional (e.g., two or three dimensional). The model may comprise a linear or non-linear equation. The model may comprise an exponential or logarithmic equation. The model may comprise one or more Boolean operations. The model may consider the enclosure. Considering the enclosure may include the structure and/or makeup of the enclosure. Makeup of the enclosure may comprise material makeup of any fixture and/or non-fixture the model in the enclosure. The model may consider a Building Information Modeling (BIM) (e.g., Revit file) of the enclosure before, during, and/or after its construction. The model may consider a two dimensional (e.g., floor plan) and/or three dimensional modeling (e.g., 3D model rendering) of the enclosure. The model may or may not comprise a finite element analysis. The model may comprise, or be utilized in, a simulation. The simulation may be of at least one environmental characteristics of the enclosure (e.g., depicting status in various positions in the enclosure). The model may be represented as a graph (e.g., 2 or 3 dimensional graph). For example, the model may be represented as a contour map. The modeling may comprise one or more matrices. The model may comprise a topological model. The model may relate to a topology of the sensed parameter in the enclosure. The model may relate to a time variation of the topology of the sensed parameter in the enclosure. The model may be environmental and/or enclosure specific. The model may consider one or more properties of the enclosure (e.g., dimensionalities, openings, and/or environmental disrupters (e.g., emitters)). Processing of the sensor data may utilize historical sensor data, and/or current (e.g., real time) sensor data. The data processing (e.g., utilizing the model) may be used to project an environmental change in the enclosure, and/or recommend actions to alleviate, adjust, or otherwise react to the change.

In particular embodiments, sensor ensembles (e.g., 405A, 405B, and/or 405C), may be capable of accessing at least one model to permit curve fitting of sensor readings as a function of one or more dimensions of an enclosure. In an example, a model may be accessed to generate sensor profile curves 450A, 450B, 450C, 450D, and 450E, utilizing points 435A, 435B, and 435C of CO₂ graph 430. In an example, a model may be accessed to generate sensor profile curves 451A, 451B, 451C, 451B, and 451E utilizing points 445A, 445B, and 445C of noise graph 440. Additional models may utilize additional readings from sensor ensembles (e.g., 405A, 405B, and/or 405C) to provide curves in addition to sensor profile curves 450 and 451 of FIG. 4. Sensor profile curves generated in response to use of a model may sensor output reading profiles indicate a value of a particular environmental parameter as a function of a dimension of an enclosure (e.g., an “X” dimension, a “Y” dimension, and/or a “Z” dimension).

In some embodiments, a parameter topology of an enclosure is modeled by creating one or more models representing profiles of a sensed parameter (e.g., environmental characteristic) such as sensed parameters within the enclosure. The profiles may be comprised of parameter values which vary according to spatial positions in the enclosure. The parameter values may be derived directly from an output of any sensor deployed in the enclosure and/or calculated from the outputs of any sensors and/or other data available to a processor of a sensor, a processor of a sensor ensemble, a processor in the cloud, a processor of a local controller, a processor in the enclosure, a processor outside of the enclosure, and/or a remote processor. The profiles may be multi-dimensional (e.g., resembling a topographical map or cross sections of a topographical map).

In certain embodiments, one or more models (e.g., such as the ones utilized to form curves 450A-450E and 451A-451E) may provide a parameter topology of an enclosure. In an example, a parameter topology (e.g., as represented by curves 450A-450E and 451A-451E) may be synthesized or generated from sensor output reading profiles. The parameter topology may be a topology of any sensed parameter disclosed herein. In an example, a parameter topology for a conference room (e.g., conference room 402) may comprise a carbon dioxide profile having relatively low values at locations away from a conference room table and relatively high values at locations above (e.g., directly above) a conference room table. In an example, a parameter topology for a conference room may comprise a multi-dimensional noise profile having relatively low values at locations away from a conference table and slightly higher values above (e.g., directly above) a conference room table.

In some embodiments, the at least one sensor is operatively coupled to a control system (e.g., computer control system). The sensor may comprise light sensor, acoustic sensor, vibration sensor, chemical sensor, electrical sensor, magnetic sensor, fluidity sensor, movement sensor, speed sensor, position sensor, pressure sensor, force sensor, density sensor, distance sensor, or proximity sensor. The sensor may include temperature sensor, weight sensor, material (e.g., powder) level sensor, metrology sensor, gas sensor, or humidity sensor. The metrology sensor may comprise measurement sensor (e.g., height, length, width, angle, and/or volume). The metrology sensor may comprise a magnetic, acceleration, orientation, or optical sensor. The sensor may transmit and/or receive sound (e.g., echo and/or ultrasound), magnetic, electronic, or electromagnetic signal. The electromagnetic signal may comprise a visible, infrared, ultraviolet, radio wave, or microwave signal. The gas sensor may sense any of the gas delineated herein. The distance sensor can be a type of metrology sensor. The distance sensor may comprise an optical sensor, or capacitance sensor. The temperature sensor can comprise Bolometer, Bimetallic strip, calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Infrared sensor, Silicon band gap temperature sensor, Special sensor microwave/imager, Temperature gauge, Thermistor, Thermocouple, Thermometer (e.g., resistance thermometer), or Pyrometer. The temperature sensor may comprise an optical sensor. The temperature sensor may comprise image processing. The temperature sensor may comprise a camera (e.g., IR camera, CCD camera). The pressure sensor may comprise Barograph, Barometer, Boost gauge, Bourdon gauge, Hot filament ionization gauge, Ionization gauge, McLeod gauge, Oscillating U-tube, Permanent Downhole Gauge, Piezometer, Pirani gauge, Pressure sensor, Pressure gauge, Tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode (e.g., light sensor), Light-addressable potentiometric sensor, Nichols radiometer, Fiber optic sensor, Optical position sensor, Photo detector, Photodiode, Photomultiplier tubes, Phototransistor, Photoelectric sensor, Photoionization detector, Photomultiplier, Photo resistor, Photo switch, Phototube, Scintillometer, Shack-Hartmann, Single-photon avalanche diode, Superconducting nanowire single-photon detector, Transition edge sensor, Visible light photon counter, or Wave front sensor. The one or more sensors may be connected to a control system (e.g., to a processor, to a computer).

Sensors and/or other devices or other modules (e.g., devices such as emitters) of an ensemble may be organized into an assembly module. In some embodiments, an ensemble may comprise a circuit board, such as a printed circuit board, in which a number of sensors are adhered or affixed to the circuit board. The assembly module may include a housing (e.g., a shell) with an internal chamber to retain at least a portion of the (e.g., the entire) circuit board and various sensors, emitters, transmitters, receivers, integrated circuit chips, processors, and/or connectors. The sensors may include temperature and/or other environmental sensors that could potentially be negatively impacted by heat generated in the assembly module. A layout of a printed circuit board and a housing may include an elongated shape to place temperature sensitive devices away from heat-generating devices.

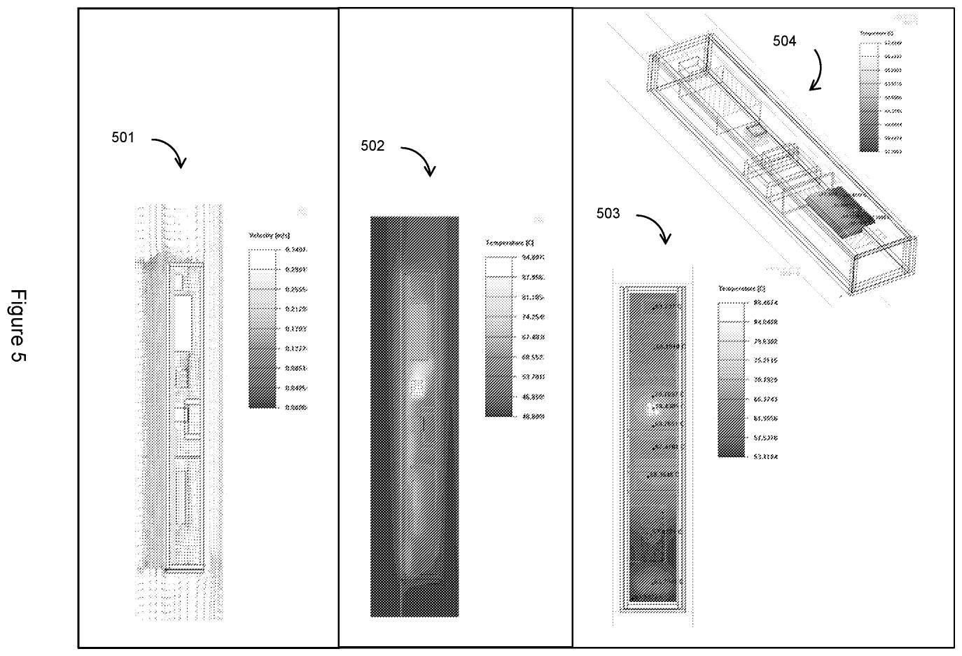

FIG. 5 shows heat-related performance for an example ensemble module 500 during its operation. A convection map 501 shows direction and velocity of air circulation around assembly module 500 when operating at a power level of about 2.5 Watts. A temperature map 502 shows a side view of temperature variations outside assembly module 500 during operation, and a temperature map 503 shows a top view of temperature variations outside assembly module 500 during its operation. A temperature map 504 depicts temperatures at an environmental sensor. Temperature changes generated by other power-consuming components may be sufficiently small to avoid (e.g., substantially) impacting operation of the environmental sensor to a detectable degree.

In some embodiments, the devices in an ensemble may be plugged into and out of the circuit board, e.g., using pressure. For example, sensors can be removable from a sensor assembly. For example, a device may be plugged and/or unplugged from the circuit board. The device(s) may be individually activated and/or deactivated (e.g., using a switch). The circuit board may comprise a polymer. The circuit board may comprise a transparent or non-transparent portion (e.g., may be transparent or non-transparent). The circuit board may comprise metal (e.g., elemental metal and/or metal alloy). The circuit board may comprise a conductor. The circuit board may comprise an insulator. The circuit board may comprise any geometric shape (e.g., rectangle or ellipse). The circuit board may be configured (e.g., may be of a shape) to allow the ensemble to be disposed in a fixture (e.g., a frame or a portion thereof). The frame portion may be a mullion (e.g., of a window). The circuit board may be configured (e.g., may be of a shape) to allow the ensemble to be disposed in a frame (e.g., door frame and/or window frame). The frame portion and/or cover of the ensemble may comprise one or more holes to allow the sensor(s) to obtain (e.g., accurate) readings. The circuit board may include an electrical connectivity port (e.g., socket). The circuit board may be connected to a power source (e.g., to electricity). The power source may comprise renewable and/or non-renewable power source.

An ensemble of devices organized into a device assembly may include at least 1, 2, 4, 5, 8, 10, 20, 50, or 500 devices. The device module may include a number of devices in a range between any of the aforementioned values (e.g., from about 1 to about 1000, from about 1 to about 500, or from about 500 to about 1000). Sensors of a device assembly may comprise devices configured or designed for sensing any environmental characteristic (e.g., as disclosed herein) comprising, temperature, humidity, carbon dioxide, particulate matter (e.g., between about 2.5 μm and about 10 μm), total volatile organic compounds (e.g., via a change in a voltage potential brought about by surface adsorption of volatile organic compound), ambient light, audio noise level, pressure (e.g. gas, and/or liquid), acceleration, time, radar, lidar, radio signals (e.g., ultra-wideband radio signals), passive infrared, glass breakage, or movement detectors. The sensor ensemble may comprise non-sensor devices, such as buzzers and light emitting diodes. Examples of sensor ensembles and their uses can be found in U.S. patent application Ser. No. 16/447169 filed Jun. 20, 2019, titled “SENSING AND COMMUNICATIONS UNIT FOR OPTICALLY SWITCHABLE WINDOW SYSTEMS,” that is incorporated herein by reference in its entirety.

In some embodiments, an increase in the number and/or types of sensors may be used to increase a probability that one or more measured property is accurate and/or that a particular event measured by one or more sensor has occurred. In some embodiments, sensors of sensor ensemble may cooperate with one another. In an example, a radar sensor of sensor ensemble may determine presence of a number of individuals in an enclosure. A processor may determine that detection of presence of a number of individuals in an enclosure is positively correlated with an increase in carbon dioxide concentration. In an example, the processor-accessible memory may determine that an increase in detected infrared energy is positively correlated with an increase in temperature as detected by a temperature sensor. In some embodiments, a network interface may communicate with other sensor ensembles similar to sensor ensemble. The network interface may additionally communicate with a controller.

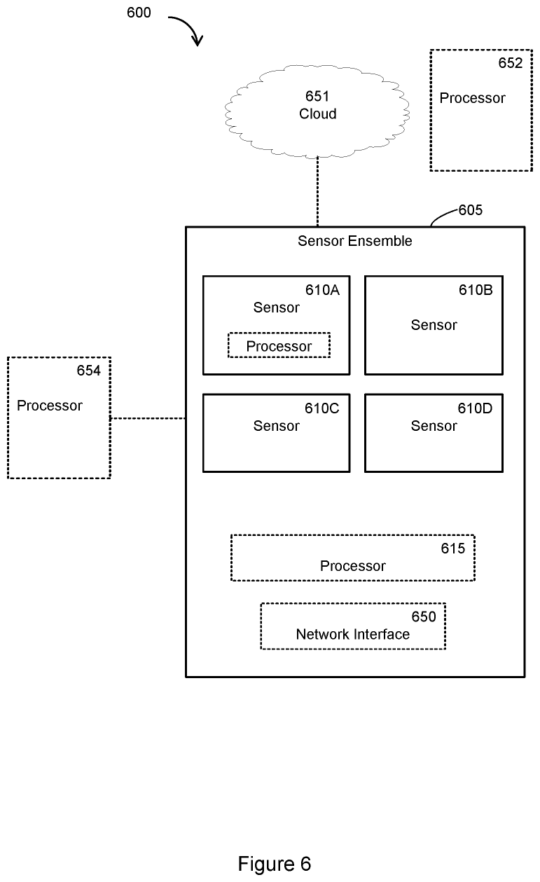

FIG. 6 shows an example of a diagram 600 of an ensemble of sensors organized into a sensor module. Sensors 610A, 610B, 610C, and 610D are shown as included in sensor ensemble 605. Individual sensors (e.g., sensor 610A, sensor 610D, etc.) of a device ensemble may comprise and/or utilize at least one dedicated processor. A device ensemble may utilize a remote processor (e.g., 654) utilizing a wireless and/or wired communications link. A sensor ensemble may utilize at least one processor (e.g., processor 652), which may represent a cloud-based processor coupled to a sensor ensemble via the cloud (e.g., 651). Any of the processors communicatively coupled to the ensemble (e.g., processors 652 and/or 654) may be located in the same enclosure, in a different enclosure, in an enclosure owned by the same or different entity, an enclosure owned by the manufacturer of the window/controller/sensor ensemble, or at any other location. In various embodiments, as indicated by the dotted lines of FIG. 6, sensor ensemble 605 is not required to comprise a separate processor and network interface. These entities may be separate entities and may be operatively coupled to ensemble 605. The dotted lines in FIG. 6 designate optional features. In some embodiments, onboard processing and/or memory of one or more ensemble of sensors may be used to support other functions (e.g., via allocation of ensembles(s) memory and/or processing power to the network infrastructure of a building).

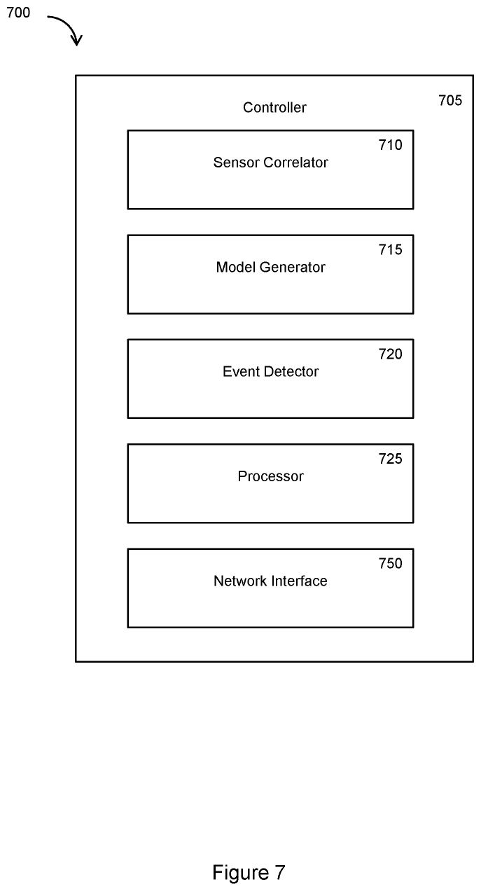

FIG. 7 shows an example of a controller 705 for controlling one or more sensors. Controller 705 comprises sensor correlator 710, model generator 715, event detector 720, processor 725, and the network interface 750. Sensor correlator 710 operates to detect correlations between or among various sensor types. For example, an infrared radiation sensor measuring an increase in infrared energy may be positively correlated with an increase in measure temperature. A sensor correlator may establish correlation coefficients, such as coefficients for negatively-correlated sensor readings (e.g., correlation coefficients between -1 and 0). For example, the sensor correlator may establish coefficients for positively-correlated sensor readings (e.g., correlation coefficients between 0 and +1).

In some embodiments, the enclosure includes at least one digital architectural element. A digital architectural element (DAE) may contain various sensors, emitters, devices, processors (e.g., a microcontroller and/or a non-volatile memory), network interfaces, and/or one or more peripheral interfaces. The term DAE can refer to any device, device ensemble, or interface, configured to be mounted to and/or retained in, or on, any structural component in an enclosure (e.g., framework, beam, joist, wall, ceiling, floor, window, fascia, transom, and/or casement of a building or of a room of a building). A DAE may include, for example, a window-mullion interface, a digital wall interface, and/or a ceiling-mounted interface. Examples of DAE sensors include light sensors, optionally including image capture sensors such as cameras, audio sensors such as voice coils or microphones, air quality sensors, and proximity sensors (e.g., certain IR and/or RF sensors). The network interface may be a high bandwidth interface such as a gigabit (or faster) Ethernet interface. Examples of DAE peripherals include video display monitors, add-on speakers, mobile devices, battery chargers, and the like. Examples of peripheral interfaces include standard Bluetooth modules, ports such as USB ports and network ports, etc. Ports may include any of various proprietary ports for third party devices.

In some embodiments, the DAE operates in conjunction with other hardware and/or software provided for an optically switchable window system to a display coupled to window, and/or to a display projected on the window. In some embodiments, the DAE includes a controller (e.g., any controller disclosed herein).

In some embodiments, a DAE includes one or more signal generating devices such as a speaker, a light source (e.g., an LED), a beacon, an antenna (e.g., a Wi-Fi or cellular communications antenna), and the like. The signal generating device can be an emitter. In some embodiments, a DAE includes an energy storage component and/or a power harvesting component. For example, a DAE may contain one or more batteries and/or capacitors, e.g., as energy storage devices. the DAE may include a photovoltaic cell. In one example, a DAE has one or more user interface components (e.g., a microphone or a speaker), one more sensors (e.g., a proximity sensor), and a network interface (e.g., for a high bandwidth communications).

In some embodiments, a DAE is designed, or configured to, attach to (or otherwise be collocated with) a structural element of an enclosure (e.g., a building). In some embodiments, a DAE has an appearance that blends in with the structural element with which it is associated. For example, a DAE may have a shape, size, and/or color that blends with the associated structural element. For example, a DAE may not be easily visible to occupants of a building; e.g., the element is fully or partially camouflaged in the surrounding in which it is disposed. However, such element may interface with other component(s) that do not blend in, such as one or more video display monitors, touch screens, projectors, and the like.

In some embodiments, the building structural elements to which DAE may be attached include any of various building structures. In some embodiments, building structures to which DAEs attach are installed and/or constructed during building construction, in some cases early in building construction when the building skeleton or envelope is constructed. In some embodiments, the building structural elements for DAEs are elements that serve a building structural function. Such elements may be permanent, e.g., not easily removable from a building. Examples include columns, piers (e.g., elevator, communication, or electrical piers), walls, partitions (e.g., office space partitions), doors, beams, stairs, facades, moldings, mullions and/or transoms. In various examples, the structural elements are located on a perimeter of the enclosure. In some embodiments, the DAE is provided as separate modular unit or as a housing (e.g., box) that attach to the building structural element. In some cases, DAEs are provided as facades for building structural elements. For example, a DAE may be provided as a cover for a portion of a mullion, transom, or door. In one example, a DAE is configured as a mullion or disposed in or on a mullion. If it is attached to a mullion, the DAE may be bolted on or otherwise attached to the rigid parts of the mullion. In some embodiments, a DAE can snap onto a structural element of the enclosure. In some embodiments, a DAE serves as a molding, e.g., a crown molding. In some embodiments, a DAE is modular; e.g., it serves as a module for part of a larger system such as a communications network, a power distribution network, and/or computational system. The computation system can employ an external video display and/or other user interface components.

In some embodiments, the DAE is a digital mullion designed to be deployed on one or more mullions in a room, floor, or building. In some embodiments, digital mullions are deployed in a regular or periodic fashion. For example, digital mullions may be deployed on every sixth successive mullion.

In some embodiments, in addition to the high bandwidth network connection (port, switch, and/or router) and a housing, the DAE includes one or more of the following digital and/or analog components: a camera, a proximity or movement sensor, an occupancy sensor, a color temperature sensor, an infrared sensor, an ultraviolet sensor, a visible light sensor, a biometric sensor, a speaker, a microphone, an air quality sensor, a hub for power and/or data connectivity, display video driver, a Wi-Fi access point, an antenna, a location service (e.g., Bluetooth, Global Positioning System, or ultra-wide band) via beacons or other mechanism, a power source, a light source, a processor, a memory, and/or ancillary processing device. One or more cameras may include a sensor and processing logic for imaging features in the visible, IR (see use of thermal imager below), or other wavelength region; various resolutions are possible including HD and greater. The DAE may include one or more devices disclosed herein.

One or more proximity or movement sensors may include an infrared sensor (abbreviated herein as an “IR” sensor). In some embodiments, a proximity sensor is a radar or radar-like device that detects distances from and between objects using a ranging function. Radar sensors can also be used to distinguish between closely spaced occupants via detection of their biometric functions, for example, detection of their different breathing movements. When radar or radar-like sensors are used, better operation may be facilitated when disposed unobstructed or behind a plastic case of a DAE. One or more occupancy sensors may include a multi-pixel thermal imager, which when configured with an appropriate computer implemented algorithm can be used to detect and/or count the number of occupants in a room. In some embodiments, data from a thermal imager or thermal camera is correlated with data from a radar sensor to provide a better level of confidence in a particular determination being made. In some embodiments, thermal imager measurements can be used to evaluate other thermal events in a particular location, for example, changes in air flow caused by open windows and doors, the presence of intruders, and/or fires. One or more color temperature sensors may be used to analyze the spectrum of illumination present in a particular location and to provide outputs that can be used to implement changes in the illumination as needed or desired, for example, to improve an occupant's health or mood. One or more biometric sensors (e.g., for fingerprint, retina, or facial recognition) may be provided as a stand-alone sensor or be integrated with another sensor such as a camera.

One or more speakers and associated power amplifiers may be included as part of a DAE or separate from it. In some embodiments, two or more speakers and an amplifier are configured as a sound bar; e.g., a bar-shaped device containing multiple speakers. The device may be designed (e.g., configured) to provide high fidelity sound. One or more microphones and/or logic for detecting and processing sounds may be provided as part of a DAE or separate from it. The microphones may be configured to detect internally and/or externally generated sounds. In some embodiments, processing and analysis of the sounds is performed by logic embodied as software, firmware, or hardware in one or more digital structural element and/or by logic in one or more other devices coupled to the network, for example, one or more controllers coupled to the network. In some embodiments, based at least in part on the analysis, the logic is configured to automatically adjust a sound output of one or more speaker to mask and/or cancel sounds, frequency variations, echoes, and other factors detected by one or more microphone, e.g., that negatively impact (or potentially could negatively impact) occupants present in a particular location within the enclosure (e.g., the building). In some embodiments, the sounds comprise sounds generated by, but not limited to: indoor machinery, indoor office equipment, outdoor construction, outdoor traffic, and/or airplanes.

One or more air quality sensors (optionally able to measure one or more of the following air components: volatile organic compounds (VOC), carbon dioxide temperature, humidity) may be used in conjunction with HVAC to improve air circulation control.

One or more hubs for power and/or data connectivity to sensor(s), speakers, microphone, and the like may be provided. The hub may comprise a USB hub, or a Bluetooth hub. The hub may include one or more ports such as USB ports, High Definition Multimedia Interface (HDMI) ports, or any other port, plug, or socket disclosed herein. For example, the DAE may include a connector dock for external sensors, light fixtures, peripherals (e.g., a camera, microphone, speaker(s)), network connectivity, power sources, etc.

One or more video drivers may be provided. The driver may be utilized for a display (e.g., a transparent OLED device) on or proximate to a window (such as an integrated glass unit (IGU)) associated with the DAE element. The driver may be physically wired or optically coupled to the DAE. For example, the optical signal may be launched into the window by optical transmission, such as a switchable Bragg grating that includes a display with a light engine and lens that focuses on glass waveguides that transmits through the glass and travels perpendicularly to line of sight.

One or more Wi-Fi access points and antenna(s), which may be part of the Wi-Fi access point or serve a different purpose. In some embodiments, the DAE or a faceplate that covers all or a portion of the DAE, may serve as an antenna. Various approaches may be employed to insulate the DAE and use it to transmit and/or receive directionally. A prefabricated antenna may be employed in the enclosure. A window antenna may be employed. Examples of antennas and their integration in a facility and deployment may be found in International Patent Application Ser. No. PCT/US17/31106, filed May 4, 2017, titled “WINDOW ANTENNAS,” which is incorporated herein by reference in its entirety.

One or more power sources such as an energy storage device (e.g., a rechargeable battery and/or a capacitor), and the like may be provided. The power source may be renewable or non-renewable. In some embodiments, a power harvesting device is included; e.g., a photovoltaic cell or panel of cells. This may allow the device to be self-contained or partially self-contained. The light harvesting device may be transparent or opaque, e.g., depending on where it is attached. For example, a photovoltaic cell may be attached to, e.g., and partially or fully cover, the exterior of a digital mullion. For example, a transparent photovoltaic cell may be cover a display and/or user interface (e.g., a dial, button, etc.), e.g., on the DAE.

One or more light sources (e.g., light emitting diodes) may be configured to interface with the processor in order to emit light under certain conditions, such as signaling when the device is active.

One or more processors may be configured to provide various embedded or non-embedded applications. The processor may comprise a microcontroller. In some embodiments, the processor is low-powered mobile computing unit (MCU) with memory and configured to run a lightweight secure operating system hosting applications and data. In some embodiments, the processor is an embedded system, system on chip, or an extension. One or more ancillary processing devices (such as a graphical processing unit, or an equalizer or other audio processing device) may be used to interpret audio signals.

In some embodiments, a DAE (or building structural element associated with a DAE) may include one or more antennas. The antenna(s) may be pre-constructed. The antenna(s) may be attached to, or embedded in, the DAE, e.g., either on the surface on or in the DAE interior. An antenna may be configured such that the structure of a DAE (or building structural element) may serve as an antenna component. For example, a conductive metal piece of a mullion may serve as an antenna element or ground plane. In some embodiments, a portion of a DAE or building structural element is removed (or added) so that the remaining portion serves as a tuned antenna element. For example, a part of a mullion may be punched out to provide a tuned antenna element. By attaching cable(s) (e.g., coaxial or other cables), an RF transmitter, and/or an RF receiver, the building structural element and/or an associated DAE may serve as an antenna element. The antenna components may be designed with an impedance (e.g., of at least about 50 ohms) that matches that of the RF transmitter.

Depending on construction, the antenna element may be a Wi-Fi antenna, a Bluetooth antenna, a cellular communication antenna, etc. The antenna may be configured for at least a third generation (3G), fourth generation (4G), or fifth generation (5G) communication protocol. In some embodiments, the antenna transmits and/or receives in the radio frequency portion of the electromagnetic spectrum. The antenna may be a patch antenna, a monopole antenna, a dipole antenna, etc. It may be configured to transmit or receive electromagnetic signals in any appropriate wavelength range. Examples of antenna, its components, and its integration in the enclosure (e.g., building) and its components (e.g., optically switchable window) can be found in U.S. patent application Ser. No. PCT/US17/31106, filed May 4, 2017, titled “WINDOW ANTENNAS,” which was previously incorporated herein by reference in its entirety.

In some embodiments, a camera of a DAE is configured to capture images, e.g., in the visible portion of the electromagnetic spectrum. For example, the camera may provide images in low resolution, e.g., low definition (e.g., 24×32 pixels). For example, the camera may provide images in high resolution, e.g., high definition (e.g., 4K camera). The camera may have a horizontal resolution of at least about 24 pixels, 32 pixels, 720 pixels, 1080 pixels, or 3840 pixels. The camera may have a horizontal display resolution of approximately 4,000 pixels. The camera resolution may provide images that have at least 24 pixels by at least 32 pixels, at least 1280 pixels by at least 720 pixels (e.g., at least about 921, 600 pixels), that have at least 1920 pixels by at least 1080-pixel (e.g., at least about 2.1 megapixels), at least about 3840 pixels by at least about 2160 pixels, or at least 4096 by at least about 2160 pixels. The number of pixels of the camera can be at least about 800 pixels, 0.5 megapixels (MP), 1 MP, 1.5 MP, 2 MP, 2.5 MP, 3 MP, 4 MP, 5 MP, 6 MP, 7 MP, 8 MP, 9 MP, 10 MP, or 15 MP. The camera resolution may be any camera resolution between the aforernentioned values (e.g., from about 0.5 MP to about 15 MP). In some embodiments, the camera captures images having information about the intensity of wavelengths outside the visible range. For example, a camera may be able capture infrared signals. For example, a camera may be able capture ultraviolet signals. In some embodiments, a DAE includes a near infrared device such as a forward looking infrared (FLIR) camera or near-infrared (NIR) camera. Examples of suitable infrared cameras include the Boson™ or Lepton™ from FLIR Systems, of Wilsonville, Oreg. Such infrared cameras may be employed to augment a visible camera in a DAE.

In some embodiments, the camera is configured to map the heat signature of an enclosure or portion thereof (e.g., a room) such that it may serve as a temperature sensor, e.g., with three-dimensional awareness. In some embodiments, such cameras in a DAE enable occupancy detection, augment visible cameras to facilitate detecting a human instead of a hot wall, and/or provide quantitative measurements of solar heating (e.g., image the floor or desks and see what the sun is actually illuminating).

In some embodiments, the speaker, microphone, and associated logic are configured to use acoustic information to characterize air quality and/or air conditions. As an example, an algorithm may issue ultrasonic pulses, and detect the transmitted and/or reflected pulses coming back to a microphone. The algorithm may be configured to analyze the detected acoustic signal, sometimes using a transmitted vs. received differential audio signal, to determine air density, particulate deflection, and the like to characterize air quality.

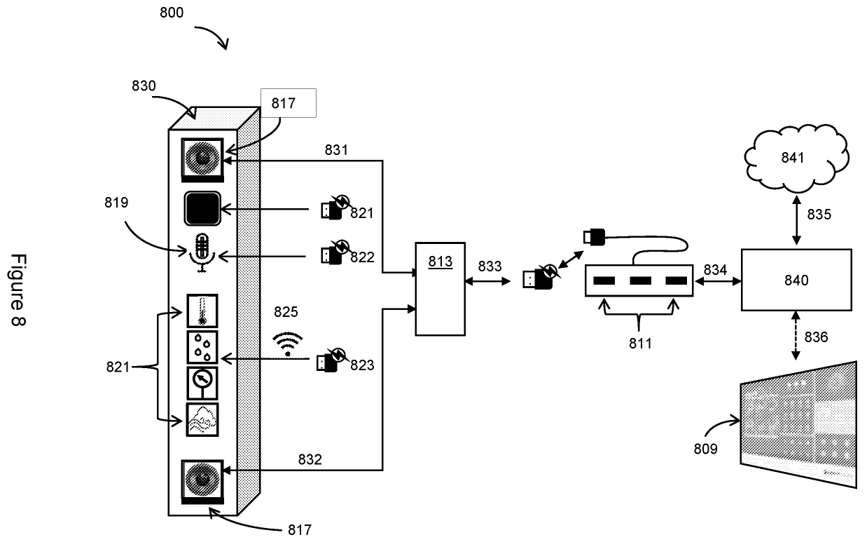

FIG. 8 schematically shows an example of components related to a digital architectural element (DAE). In the illustrated example, an arrangement 800 includes a DAE 830 and a processor (e.g., computer) 840. The processor 840 is connected (e.g., via ethernet connection) to an external network 841. The external network can include internet and/or a cloud-based content and/or service provider. The connection of the processor to the external network may include an appropriate modem, router, switch and/or a high bandwidth backbone such as the 10 Gigabyte backbone. The processor 840 may also be connected to a display 809 (e.g., video display) via, in this example, a High-Definition Multimedia Interface (HDMI) link. The processor 840 is connected to ports 811 (e.g., USB, Wi-Fi, Bluetooth, or any other port, and/or socket disclosed herein), e.g., to make available additional internal and/or external resources for the DAE 830. A DAE may include any device disclosed herein (e.g., various sensors and peripheral elements). In the example illustrated in FIG. 8, DAE 830 includes speakers 817, microphone 819, and various sensors 821 such as temperature, humidity, pressure, and gas flow sensors. Any one or more of these components may be coupled to the computer or processor 840 via the ports 811. Ay of the device may be reversibly plugged in and out of the electronic circuitry of the DAE, e.g., via connectors 821-823. Any of the devices may communicate via wired or wireless (e.g., 825) communication. The communication may be to the network, to the processor 811, or to any other processor configure to receive the communication. The communication can be monodirectional or bidirectional. In the example shown in FIG. 8, bidirectional communication is designated by bidirectional arrows, e.g., 831-836. The DAE is coupled an equalizer 813 configured to provide tone control to adjust for acoustics of the enclosure in which the DAE is disposed. The DAE may be also referred to herein as “device ensemble,” “ensemble of devices,” or a “device assembly.”

In some embodiments, the DAE is coupled to a signal (e.g., sound) equalizer. In some cases, the equalizer can facilitate adjustment of room acoustics using, e.g., real time, time delay reflectometry. The equalizer (and associated components) can compensate for unwanted audio artifacts, e.g., produced by interactions of the sound waves with items that are in the enclosure (e.g., a room) or otherwise in close proximity with an occupant. In some embodiments, a signal pulse is generated by a speaker associated with the DAE. One or more microphones can pick up the pulse (e.g., directly) and as reflected and/or attenuated by items in the room. Based at least in part (i) on the time delay between emitting and detecting the pulse, and/or (ii) on tonal quality of the detected pulse, the system can infer boundaries of the enclosure (e.g., room boundaries), etc. In some embodiments, a user's smart phone enables optimizing speaker outputs for the acoustical environment of various locations in a room. During a set up mode, the user, with phone enabled, may move around a room and use the phone to detect the acoustical response. Based at least in part on the location and the detected acoustic response, the DAE can determine how to optimize speaker output. After the acoustic profile of the room is mapped, the DAE can be programmed to tune its speaker output based on various factors such as where the user is located in a room. The element can, in some embodiments, detect the user location using any of a number of proximity techniques, such as those described in International Patent Application Ser. No. PCT/US17/31106, filed May 4, 2017, which is incorporated herein by reference in its entirety.

In some embodiments, a DAE is configured as a digital wall interface including a chassis or housing that is designed for mounting on a wall, ceiling, or door of a partially or fully constructed building. The wall interface may be constructed to provide a user interface that is easily visible to users. It may have a relatively small footprint (e.g., at most about 500 square inches of user facing surface area) and be geometrically (e.g., elliptically (e.g., circularly) or polygonally) shaped. In some embodiments, a digital wall interface is approximately tablet shaped and sized.

In some embodiments, a DAE is installed in an enclosure (e.g., a building), as the enclosure is being constructed. For example, a DAE configured as a mullion-mounted unit may be installed during enclosure construction, while a DAE configured as a digital wall interface may be installed in an enclosure after the construction is complete or nearly complete. In one approach to enclosure construction, a plurality of DAEs is installed during construction of the basic enclosure structures (e.g., walls, partitions, doors, mullions and transoms, etc.) using appropriate form factors for the DAE (e.g., mullion mounting). Later, one or more digital wall interfaces are installed shortly before or at the time of occupancy, e.g., by a tenant. Of course, once installed, all of the DAEs can work in conjunction, e.g., as part of a mesh network, by sharing sensed results, by sharing analysis and control logic, etc.

In some embodiments, multiple devices (e.g., sensors, emitters, actuators, transmitters, and/or receivers) are integrated into a common assembly (such as onto a common circuit board). The DAE ensemble may have a single casing (e.g., cover). One or more circuit boards may be disposed in the single casing to form one device ensemble. The circuit boards in the casing may or may not be physically coupled (e.g., using wiring). The boards in the casing may be communicatively coupled. Communicatively coupled may be directly or indirectly, e.g., wired or wireless communication, e.g., using the network. The common assembly may be referred to herein also as “ensemble.” Multiple assemblies (e.g., ensembles) containing such elements may be deployed in close proximity to one another. The close proximity of at least two devices in the same ensemble or different ensembles may lead to one or more shortcomings in their operation. These one or more shortcomings may be in the course of their normal (e.g., designed and/or intended) operation. The one or more shortcomings may be as a result of (i) mutual interference between the devices in the ensemble (e.g., intra assembly interference) and/or (ii) mutual interference between the devices of different ensembles (e.g., inter assembly interference). The ensemble(s) may include, or be operatively coupled to, at least one controller. The at least one controller may comprise a digital architectural system controller. At least one controller may be disposed in an assembly casing (also referred to herein as “housing” or “package”). The package may be adapted to mount to a window, wall, ceiling, or any other structure and/or fixture in an enclosure (e.g., a building, facility, or room) to perform various functions. The various functions may include tinting window control, environmental monitoring, building management, video communication, audio communications, lighting (e.g., light communication), and/or wireless networking. Interference can occur, for example, during simultaneous operation of elements. Interference may lead to reduced sensor precision, false readings, sensor saturation, loss of consistency, signal transmission failure, power imbalance, and any combination thereof. In some embodiments, the plurality of modules (e.g., devices) are consolidated as an ensemble in a common housing, e.g., to provide a useful suite of functions to be provided to a particular user. The functions may increase building efficiency (e.g., energetic and/or monetary), improve occupant health, improve occupant wellness, provide a platform for networking, and/or provide a platform for communications. Examples of various modules (e.g., devices) for inclusion in a consolidated assembly include a temperature sensor, humidity sensor, carbon dioxide sensor, particulate (e.g., dust) sensor, volatile organics sensor, ambient light sensor, glass-breakage sensor, microphone, speaker/buzzer, digital amplifier, camera, video display, LED indicator, Bluetooth transceiver, ultra-wideband transceiver, passive infrared motion sensor, radar sensor, accelerometer, and pressure sensor. The consolidated assembly may include power conditioning components, a processing unit, memory, and/or a network interface. In some embodiments, the assembly has a form factor adapted for mounting in various locations in an enclosure. For example, corresponding mounting adapters can be provided for installing an assembly to at least a portion of a fixture such as a window mullion, a building wall, or a ceiling.

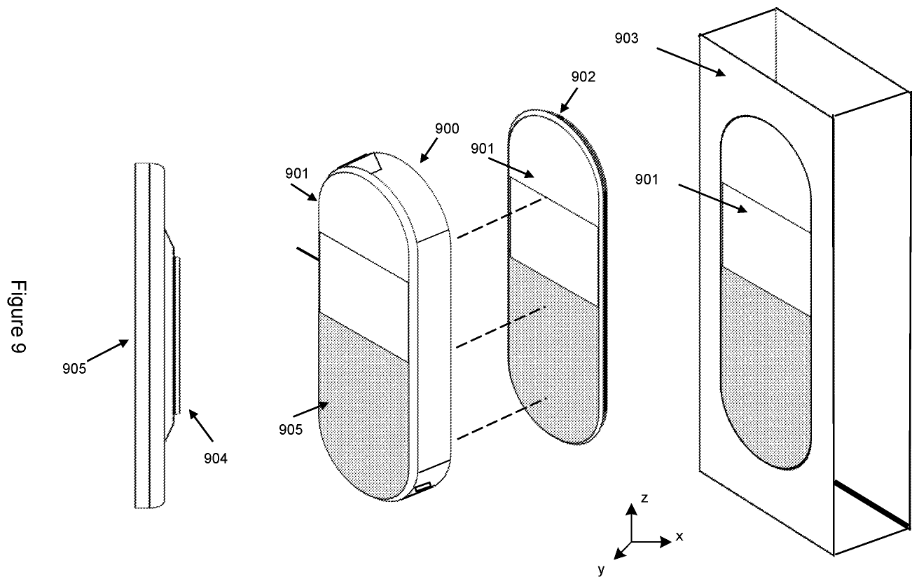

FIG. 9 shows an example of an assembly 900 having a protective housing 901. The housing may include mounting features that enable it to be captured in a wall-mount adapter such as 902, a window mullion section such as 903, or a ceiling-mount adapter such as 904 shown as a side view with 905 being the front of the housing exposed to the occupant, and 904 being the rear of the housing facing the ceiling. The housing may comprise one or more features desirable for optimal performance of modules in corresponding locations, such as one or more opening for admitting external environmental characteristic(s) into the housing to facilitate their sensing by the sensor(s). For example, the housing may comprise one or more openings (e.g., holes) that facilitate air to contact temperature, humidity, pressure, and dust sensors. The housing may comprise an open body and a lid. The lid may comprise the one or more openings (e.g., holes). The lid may snap into the open body to close the casing. Other examples of housing features include speaker or microphone grilles and an aperture for a camera lens, motion sensor, or an ambient light sensor. The one or more openings may be exposed in the front of the housing that faces an occupant of the enclosure. The housing may be masked by a textured area surrounding and/or engulfing the openings. The textured area may be patterned or irregular. The pattern may comprise any geometric shape such as space filling polygons (e.g., squares, rectangles, hexagons, or triangles). The pattern may be devoid of space filling polygons. The space filling polygons may be of a single type or of a plurality of types (e.g., at least 2 or 3 types). The textured pattern may comprise a curved line, or a straight line. The textured pattern may be devoid of a curved line or a straight line. The textured pattern may be a mesh. The textured pattern may be formed by the same, or by a different material than the rest of the housing. For example, the housing may be formed of plastic, and the textured area may be a mesh and/or cloth at least partially covering the openings portion of the housing. The textured pattern may comprise a shape that resembles the opening. The opening may resemble flower petals or leaves. The textured pattern may cover at least an eight, a fifth, a fourth, a third, or a half of a front portion of the housing, which front portion faces an occupant. The housing may be attached to a fixture such as wall and/or ceiling, directly, using a frame, and/or by a post or mast.

In some embodiments, the housing encloses at least one circuit board. The circuit board can be configured to accommodate (e.g., and accommodate) one or more devices. The devices can be reversibly integrated into the circuit board. For example, at least one device can be inserted or extracted from the circuit board (e.g., for maintenance, repair, exchange, or removal). The board may have one side on which the circuitry and/or devices are disposed. The one side may face the front of the housing. The front of the housing may face an occupant in the enclosure in which the housing is disposed. The one side may face the back of the housing. The back of the housing may face away from an occupant in the enclosure in which the housing is disposed. The board may have two sides onto which the circuitry and/or devices are disposed. The board may have one or more holes. The holes may facilitate passing of at least one environmental characteristic. The holes may facilitate passing of gas, sound, or electromagnetic radiation. For example, a sensor may be disposed at a back of the circuit board and sense an environmental quality that reaches the sensor from the enclosure, through the one or more holes. The board may have first device(s) disposed on a first side, and circuitry disposed on a second side. The board may have first device(s) disposed on a first side, and second device(s) disposed on a second side. The board may include one or more heat sinks. The heat sink(s) may be disposed at locations that are prone to heat generation and/or accumulation. The board may be operatively coupled and/or include partition(s). The partition(s) may be utilized to reduce unwanted consequences (e.g., interference) of device coexistence in the housing and/or on the board. The housing may comprise one or more circuit boards. The circuit boards may be communicatively coupled with each other (e.g., directly or indirectly). The circuit boards may be operatively (e.g., communicatively) coupled to each other by wiring and/or wireless. The circuit boards may be operatively (e.g., communicatively) coupled to the network by wiring and/or wirelessly.

In some embodiments, the device ensemble (e.g., digital architectural element DAE) comprises a processing unit. The processing unit may comprise circuitry, memory, and be configured for processing capabilities. The device ensemble may comprise a plurality of circuit boards. At least two of the plurality of circuit boards may be disposed (e.g., substantially) parallel to each other (e.g., in the DAE housing). At least two of the plurality of circuit boards may be disposed (e.g., substantially) in the same plane. At least two of the plurality of circuit boards may be disposed (e.g., substantially) in different planes. At least two of the plurality of circuit boards may be disposed (e.g., directly) adjacent to each other. Directly adjacent to each other excludes an intervening circuit board. At least two of the plurality of circuit boards may be disposed to allow shielding element, cooling element, and/or gas to flow therebetween.

In some embodiments, at least two of the plurality of circuit boards may be disposed in a manner that facilitates gas flow therebetween. The gas flow may be active or passive. The heat exchange may comprise conduction or convection. The gas flow may comprise heating of gas surrounding at least one of the circuit boards, followed by (e.g., passive) temperature equilibration. The gas flow may comprise hot gas flow to cooler area. The gas flow may comprise laminar and/or turbulent gas flow. The gas flow may be in an upwards direction (e.g., against the gravitational center). The gas flow may comprise movement of gas during its temperature equilibration. The gas flow may be active. The gas flow may be directed into the device ensemble by a gas tube and/or actuator (e.g., fan). At least one actuator (e.g., fan) may be disposed in the DAE housing, as part of the DAE housing, or outside of the DAE housing. At least one actuator may be configured to suck external gas (e.g., air) and direct it into the DAE interior (e.g., push gas into the DAE). At least one actuator may be configured to suck internal gas (e.g., air) and direct it out of the DAE interior (e.g., expel gas out of the DAE). The gas may be directed into the DAE by a tube. The DAE may comprise one or more opening through which the gas can ingress and egress out of the DAE (e.g., passively and/or actively). The opening(s) may comprise slits or holes. At least one opening may be the same as the opening in the lid of the housing (e.g., configured to allow functionality of the sensor(s) and/or emitters). At least one opening may be different from the opening in the lid of the housing (e.g., configured to allow functionality of the sensor(s) and/or emitters). At least one opening may be a gap between the DAE housing and its lid. At least one opening may be at or adjacent to connectors (e.g., sockets) of the DAE. The gas entering the DAE may be cooled. The gas may be cooled before or during its entry into the DAE. The gas cooler may be any (e.g., active) cooling device disclosed herein.

In some embodiments, at least two of the plurality of circuit boards may be disposed in a manner that facilitates shielding, heat exchange and/or cooling element disposed therebetween. At least one shielding element may be disposed between a first circuit board and a second circuit board that are located (e.g., directly) adjacent to each other. The shielding element may comprise electrical and/or electromagnetic (e.g., radio frequency) shielding. The shielding may or may not act as a heat exchanger and/or heat dissipating (e.g., cooling) element. The ensemble may comprise a heat exchanger and/or heat dissipating (e.g., cooling) element that is separate from the shielding. The heat exchanger and/or heat dissipating (e.g., cooling) element may comprise a heat pipe, or a metallic slab. Metallic may comprise elemental metal or metal alloy. The metal may be configured for (e.g., efficient and/or rapid) heat conduction. The metal may comprise copper, aluminum, brass, steel, or bronze. The heat dissipating (e.g., cooling) element may comprise a fluid, gaseous, or semisolid (e.g., gel) material. The heat dissipating (e.g., cooling) element may be active and/or passive. The heat dissipating (e.g., cooling) element may comprise a circulating substance. The heat dissipating (e.g., cooling) element may be operatively coupled to an active cooling device (e.g., thermostat, cooler, and/or refrigerator). The active cooling device may be disposed externally to the device ensemble housing. The heat dissipating (e.g., cooling) element may be disposed in a fixture (e.g., the floor, ceiling, or wall) of the enclosure (e.g., building or room) in which the device ensemble is disposed. The fixture may comprise a mullion or transom. The device ensemble may have a temperature range of from about −80° C., −40° C., or −20° C.; to about 50° C. 100° C., 150° C., or 200° C.

In some embodiments, the sensor and/or device ensemble housing may be devoid of thermal insulation. In some embodiments, the sensor and/or device ensemble housing may comprise thermal and/or vibrational insulation. The thermal and/or vibrational insulation may comprise fibrous material (e.g., felt), foamy material (e.g., polyurethane), thermoplast, rubber, or silicone. The vibrational insulation may comprise elastomer (e.g., incorporated in gromets, pads, and/or bumpers), or a mechanical spring.

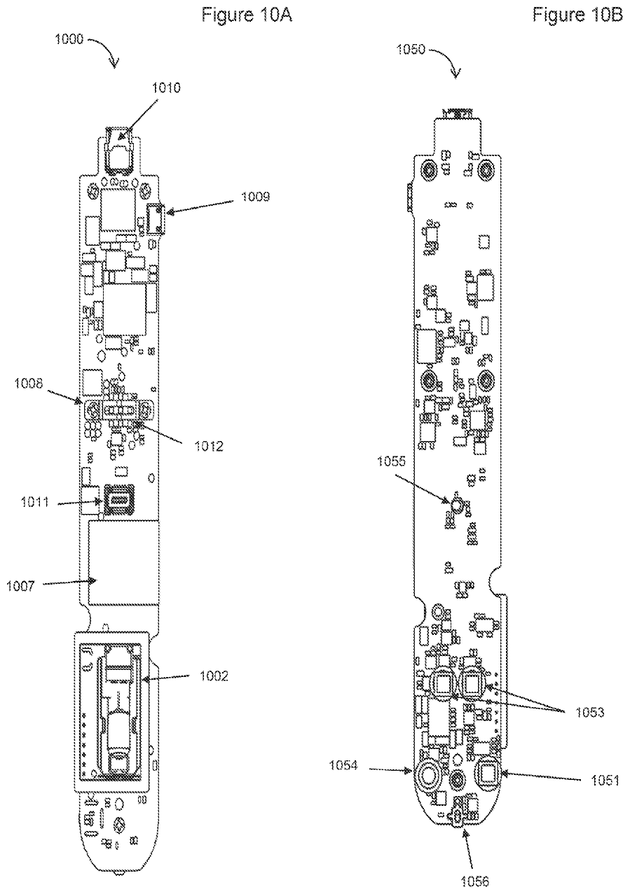

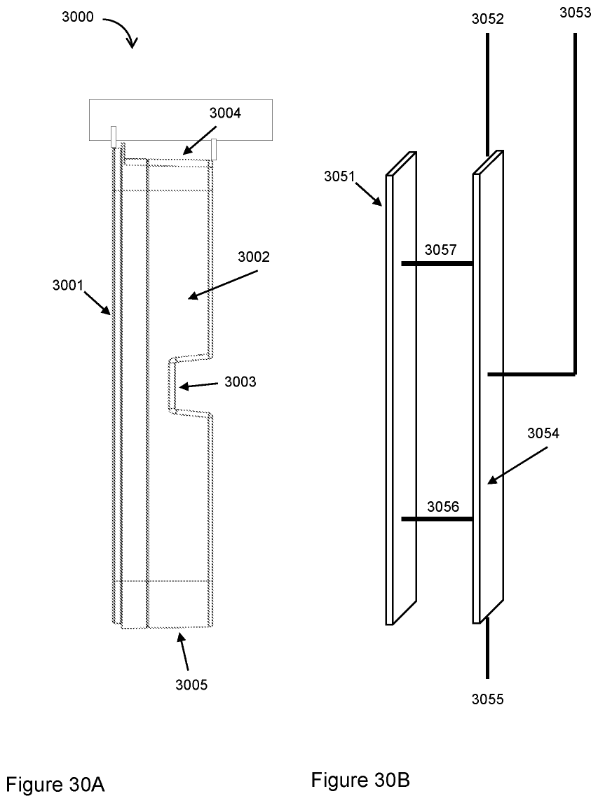

FIG. 30A shows an example of a side view of a device ensemble housing (DAE housing). 3002 shows a side view of a body of the DAE, and 3001 show a side view of a lid of the DAE. The DAE may comprise one or more openings and/or connectors, which may be disposed in various DAE portions, e.g., in 3004, 3003, and 3005. The connectors may be any of the ones disclosed herein (e.g., FIG. 10, 1009, 1010, or 1011). FIG. 30B shows a perspective view of two circuit boards 3051 and 3054. The circuit boards can be housed in the DAE. The two circuit boards 3051 and 3054 are disposed parallel to each other, and directly adjacent to each other. When housed in a DAE housing, circuit board 3051 can be a front facing circuity board that is closer to the lid 3001, and circuit board 3054 can be a back facing circuity board, that is more distant from the lid 3001 relative to circuit board 3051. The circuity boards can be electrically connected or disconnected. FIG. 30B show two section 3057 and 3056 between circuity board 3051 and 3054. At least one of the two sections 3057 and 3056 may comprise electrical connections (e.g., wires and/or cables) that electrically connect the circuitry of 3051 to 3054. At least one of the two sections 3057 and 3056 may comprise an electrical insulator that electrically separate the circuitry of 3051 to 3054. At least one of the circuity boards may be electrically connected to an external network via wiring (e.g., cabling). FIG. 30B shows an example in which circuit board 3054 is connected externally to a network via wiring (e.g., 3052, 3053, and 3055). The electrical wiring may be configured to transmit power and/or communication. In some examples, the cable transmitting the power is separate from the cable transiting the communication. In some examples, the cable transmitting the power also the cable transiting the communication (e.g., a coaxial cable). At least one of the wiring is configured to transit power over ethernet (PoE). At least one of the wiring can be an incoming communication port, and at least one of the wiring can be an outgoing communication port. For example, wiring 3052 and 3053 can be incoming PoE wiring, and wiring 3055 can be an outgoing PoE wiring.

In some embodiments, the DAE may have a plurality of circuit boards. Two of the plurality of circuit boards may differ by at least one functionality. Two of the plurality of circuit boards may have at least one functionality that is the same. For example, one circuit board (e.g., 3051) may comprise sensor(s) that are absent from the second circuit board (e.g., 3054). For example, one circuit board (e.g., 3051) may comprise emitter(s) (e.g., buzzer) that are absent from the second circuit board (e.g., 3054). For example, one circuit board (e.g., 3054) may comprise a processor (e.g., comprising a memory) that is absent from circuit board (e.g., 3051). The processor may be any processor disclosed herein. The processor may process information relating to functionalities of the DAE in which it is disposed (e.g., coexistence), relating to functionalities of another DAE (e.g., disposed in the same or in another enclosure), to information unrelated to (e.g., any) DAE, or to any combination thereof (e.g., at different times).

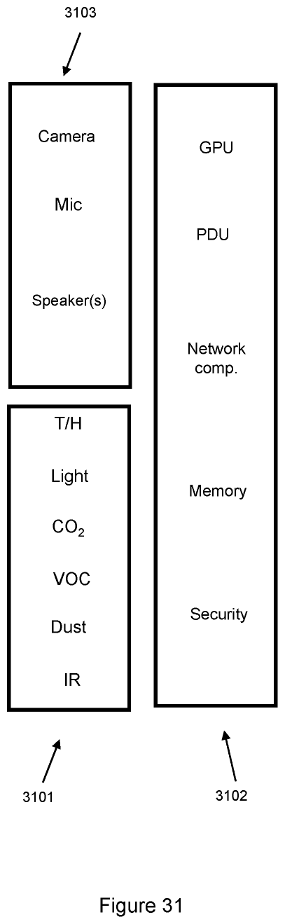

In some embodiments, the DAE may comprise a circuitry disposed in a circuit board (e.g., a printed circuit board (PCB)). The circuity board may comprise a central processing unit (CPU), graphical processing unit (GPU), memory (e.g., of the GPU and/or CPU), protocol data unit (PDU), network components (e.g., to enable wired and/or wireless communication), and security related components (e.g., encryption and/or decryption codes). The central processing unit may comprise a graphical processing unit. In some examples, the circuit boards may comprise a plurality of processing units. FIG. 31 shows a schematic example of a circuit board 3102 comprising a GPU, PDU, network components (abbreviated as “network comp.”), memory, and security related information (e.g., tokens).

In some examples, the device ensemble may comprise sensors. The sensors may be disposed in one circuit board. At least two sensors may be disposed in the same circuit board of the DAE. At least two sensors may be disposed in different circuit boards of the DAE. In some examples, the device ensemble may comprise emitters. The emitters may be disposed in one circuit board. At least two emitters may be disposed in the same circuit board of the DAE. At least two emitters may be disposed in different circuit boards of the DAE. A circuity board may comprise one type of functionality while another circuit board may comprise different functionality. For example, one circuit board may comprise processor and network related functionalities, while another circuit board may comprise sensing and/or emitting functionality. For example, one circuity board may be dedicated to devices related sensing, while the other circuit board may be dedicated to devices relating to collaboration between individuals. FIG. 31 shows an example of circuit board section 3101 to which various sensors are connected (e.g., volatile organic compounds (VOC), light, carbon dioxide (CO₂), dust, infrared (IR), temperature and humidity (abbreviated as “T/H”) sensors); and circuit board section 3103 to which collaboration related devices are connected (e.g., a camera, a microphone (Mic), and speaker(s). The microphone device can comprise a microphone array. each of the circuit board section 3101 and 3102 can be a different circuity board. The circuit board section 3101 and 3102 can be disposed in the same physical board and/or circuit board.

The DAE may comprise a plurality of functionalities. The functionalities may include collaboration, processing, memory, storage, power, network communication, sensing, emitting, and/or security. The power may comprise power supply and/or regulation. The sensors may include temperature, humidity, VOC, carbon dioxide, particulate matter 9e.g., dust), light (e.g., lux), and/or vibration. The sensors may be any sensor disclosed herein. The Network related module (e.g., network related component) may include protocol data unit (PDU), ethernet components (e.g., gigabit ethernet (GigE) components), ultrawideband (UVB) components, Bluetooth (BLE) components, and/or Wi-Fi components. The processing related module may comprise 1, 2, or more (e.g., quad-core ARM) CPUs, random access memory (e.g., 16 GB RAM), storage device. The storage device may comprise flash memory. The storage device may comprise a solid state storage device (SSD). The storage device may comprise at least about 2, 4, 6, or 8 terabits (TB). The storage device may operate using total productive maintenance (TPM). The memory module may comprise a temporary file storage that appears as a mounted file system (tmpfs), in which data is stored in volatile memory (e.g., instead of in a persistent storage device). The processor may comprise a graphic processing unit (GPU), e.g., a NVIDIA® Jetson Nano™ GPU. The processor may be configured to facilitate operating a plurality of neural networks (e.g., in parallel). The processing unit may be configured for applications like image classification, object detection, segmentation, and/or speech processing. The processing unit may require at most 3, 4, 5, 8, or 10 watts to operate. The DAE (e.g., processor, network, and/or collaboration module) may be configured for media display and/or touch screen capabilities. Examples of media display (e.g., display construct) and touch screen and their control can be found in U.S. Provisional Patent Application Ser. No. 62/975,706 filed on Feb. 12, 2020, titled “TANDEM VISION WINDOW AND MEDIA DISPLAY,” which is incorporated herein by reference in its entirety.

In some embodiments, the DAE comprises a plurality of circuit boards. At least one of the circuit boards of the DAE (e.g., at least two of the circuit boards and/or all of the circuit boards) can be a double sided circuit board (e.g., both sides of the circuit board comprise circuitry. At least one of the circuit boards of the DAE (e.g., at least two of the circuit boards and/or all of the circuit boards) can be a single sided circuit board (e.g., one side of the circuit board comprise circuitry. Devices can reside on one side of the circuit boards or on one side. In some embodiments, the sensor(s) and/or emitter(s) reside on the same board where the processor, storage and/or network functionalities reside. In some embodiments, the side of the circuit board comprising the sensor(s) and/or emitter(s) is where the processor, storage and/or network functionalities reside. In some embodiments, the side of the circuit board comprising the sensor(s) and/or emitter(s) is different from the side where the processor, storage and/or network functionalities reside. In some embodiments, the circuit boards are connected (e.g., back to back) to form a single unit. In some embodiments, the circuit boards are disconnected to form different units (e.g., that may be electrically connected via wiring, e.g., as in FIG. 30B).

In some embodiments, the DAE comprises shielding. The shielding may shield the devices and/or circuitry of the DAE, e.g., from interference of external signals (e.g., electronic and/or radio frequency signals). The shield may be in the form of a mesh. The shield may comprise elemental or metal alloy. The shield may be disposed (i) in at least a portion of the DAE housing, (ii) attached to at least a portion of the interior of the DAE housing, (iii) disposed in the DAE housing and disconnected from at least a portion of the DAE housing, (iv) at least partially disposed between the DAE housing and the circuit board(s), or (iv) any combination thereof. The shielding and the DAE housing may form a composite material (e.g., metallic mesh in a plastic ousting). The shielding may form the DAE housing (e.g., the DAE housing may be made of elemental metal (e.g., aluminum) and/or metal alloy).

In some embodiments, the circuitry (e.g., on the circuit board) comprises electrical connector (e.g., bus). The electrical connector may connect at least two devices and/or functionalities of the DAE (e.g., disposed on the circuit board). The electrical connector may include parallel and/or (e.g., bit) serial connections. The electrical connection may comprise a multidrop (electrical parallel), daisy chain topology, or connected by switched hubs. The electrical connector may be a universal serial bus (USB). The electrical connector may be a high speed electrical connector. The electrical connection can be an external bus or an internal bus. The electrical connector can be at least a second, third, or fourth generation bus. The electrical connector (e.g., bus) can operate at frequencies greater than that of the memory. The frequency can be of at least about 40 Mega Hertz (MHz), 50 MHz, 60 MHz, 66 MHz, 80 MHz, 100 MHz, 200 MHz, 400 MHz, 800 MHz, or 1000 MHz. The electrical connector can reside on the circuit board. The electrical connector can connect at least two devices (e.g., sensor and emitter) on the circuit board. The electrical connector can reside at least partially between circuit boards. The electrical connector can connect devices residing in different circuit boards.

In some embodiments, the DAE comprises a power conditioning component. The power conditioning component may mange the power allocated to various components of the DAE. The DAE may comprise a controller. The controller may receive power consumption specification of the devices in the DAE. The controller may control (e.g., in real time) demands for power in the DAE. The controller may generate (e.g., on demand and/or in real-time) a power distribution scheme according to which power is distributed amongst the DAE components. The controller may reside on the DAE. The controller may be operatively coupled to the network. The controller may be part of the control system (e.g., as disclosed herein). The controller may be external to the DAE and communicate the power distribution scheme for the DAE to the DAE components. Power (e.g., electrical power) may be distributed in parallel to at least two components in the DAE. Power may be distributed sequentially to at least two components of the DAE. The DAE may comprise a battery. The battery may be a rechargeable battery. The battery may operate as a generator and/or power reserve for the DAE. The controller may strive to ensure that the battery is nearing its maximum capacity. The controller may send an alert when the battery is below a threshold that does not allow one or more components of the DAE to operate according to its intended purpose.

In some embodiments, a printed circuit board mounts and interconnects sensor and/or emitter modules in a compact arrangement. A layout of particular modules on the circuit board(s) may sometimes provide sufficient separation between modules which tend to interact or interfere with one another. Efforts to devise an optimal layout may be time consuming and/or expensive. Furthermore, an optimal layout might still allow detectable (e.g., and undesirable) levels of interference, e.g., due to a desire to miniaturize an assembly. At times, the detectable interference between modules may be taken advantage of, e.g., for calibration and/or location purposes. One or more factors may be considered in selecting electronic circuit components and laying out circuit board(s). An acceptable overall design can be reached, which achieves most specified requirements, but which might still be subject to (e.g., some) interference issues. FIGS. 10A and 10B show example layouts of modules on a circuit board. FIG. 10A shows a rear side 1000 of a circuit board. FIG. 10B shows a front side (user-facing side) 1050 of the circuit board having a front side 1000. An environmental sensor 1051 on the front side 1050 of the circuit board 1000 integrates temperature, humidity, VOC, and pressure sensors. A CO₂ sensor 1002 is mounted on the rear side 1000 of the circuit board, which sensor 1002 receives air via intake ports 1053 passing through apertures in the circuit board. A microphone 1054 is mounted on the front side 1050 of the circuit board. In some embodiments, sounds picked up by microphone 1054 can be used to detect occupancy of a room and/or to detected spoken commands. An LED light source 1055 on the front side 1050 of the circuit board can be selectively illuminated to indicate various status signals, such as power status and/or malfunction. An ambient light sensor 1056 of the front side 1050 of the circuit board may detect light levels (e.g., for use in controlling window transparency and/or tint level). An ultra-wideband and/or BLE transceiver 1007 on the rear side 1000 of the circuit board may also comprise an acceleration sensor (e.g., accelerometer). Depending on desired functionality, many other examples of sensor and/or emitters modules and other electronic elements (e.g., a microcontroller) are mounted to respective locations on the circuit board of the ensemble. A microcontroller unit (MCU) 1008 in the example shown in FIG. 10A provides a CPU, RAM, and ROM. Power and communications can be provided via one or more of a micro-USB connector 1009 and Ethernet connectors 1010 and 1011. The circuit board may comprise a heat sink (e.g., 1012).

In some embodiments, a form factor for integrating and installing a DAE (e.g., a device ensemble, sensor, emitter, interface, window controller, network controller, etc.) employs a capsule (e.g., a housing, lid, circuit board, and/or component devices) configured to be mounted to structural elements of an enclosure using one or more covers, adapters, trim, brackets, fasteners, and the like. The DAE (e.g., ensemble) may provide compact, attractive, and/or simple design that is adaptable to different mounting locations in an enclosure. The DAE may be configured for network integration, and/or facilitate high speed data streams. The DAE may provide computing power and may be part of a collective of DAEs having (e.g., extensive) collective computing power, depending on the number of DAEs in the collective. Integration of sensors, emitters, and/or processing/controller chips into a DAE may support data collection, distribution, processing, and delivery of data services in an enclosure. The DAE in the form of a capsule (e.g., also referred to herein as “cartridge” or “enclosure housing”) may be deployable as part of a digital skin to provide infrastructure for occupant wellness (e.g., comfort, health, and/or safety). In some embodiments, the DAE is mountable on interior fixtures such as a wall, a ceiling, or a frame (e.g., window or door frame). For example, the DAE ensemble may be mountable within any window frame portion (e.g., mullion) and may include or be operatively (e.g., communicatively) coupled to a controller such as a window controller functionality for a tintable window.

In some embodiments, the DAE comprises a capsule configured to be integrated with a plurality of building structures via respective mechanical trim(s) (e.g., mullion, transom, cover, adapter, and/or bracket). The capsule may include a housing with an (e.g., elongated or wide) body/shell with an internal chamber for mounting circuitry (which may include at least one printed circuit board). A lid attachable to the elongated body may be (e.g., reversibly) removable or may be unremovable. Reversibly removable may refer to removal and attachment of the lid. Sensors, emitters, and/or other devices may be plugged in (physically inserted) and out of the circuitry (e.g., for changing the available functions or for replacing a malfunctioning component).

In some embodiments, an exposed front fascia (e.g., a bezel portion of a removable lid) of the capsule includes a fenestrated region and an uninterrupted region. The fenestrated region may be provided at one longitudinal end of the housing body coinciding with gas exchange, electromagnetic transmission (e.g., IR, visible light, and/or UV), environmental sensors and/or emitters operatively coupled to at least one circuit board. The sensors may sense at least one environmental characteristic. The environmental characteristic may comprise temperature, humidity, pressure, CO₂, CO, VOC, debris (e.g., smoke, particulates), radon, sound, sound emitter, temperature, or electromagnetic radiation (e.g., UV having wavelength range of from about 10 nanometers (nm) to about 400 nm, IR having wavelength range of from about 700 nm to about 1 mm, or visible light having wavelength range of from about 400 to about 700 nm). Fenestrations may include one or more open holes or slots (e.g., with various patterns or geometry of one or more holes of any shape. The shape may be any geometrical shape such as elliptical (e.g., circular), or polygonal (e.g., octagon, triangle, and/or rectangle) for exposure to atmosphere. Fenestrations may include optical windows (e.g., a translucent/transparent material comprising polymeric, glass, sapphire, or salt optical window) for allowing electromagnetic radiation to pass from the ambient environment through the window and into the ensemble housing (e.g., to reach the sensor). Radiation may be allowed to enter the housing body (e.g., to an ALS sensor for sensing ambient visible light, or to a passive infrared (PIR) sensor for detecting moving objects), and/or allowed to exit the housing (e.g., from a LED indicator light). The fenestrations may be configured to allow sounds (e.g., from a speaker) to exit the housing. The fenestrations may be configured to allow sounds to enter the housing (e.g., and be detected by a sound sensor). At least two of the fenestrations may be arranged in the lid in a symmetrical arrangement with respect to each other and/or at least one other fenestrations. The symmetry may comprise point symmetry, mirror symmetry, or rotational symmetry. The rotational symmetry may comprise rotation of about 180 degree)(°), 90°, 45°, 60°, 30°, 20°, 15°, 10° or any multiplication thereof. At least two of the fenestrations may be arranged in the lid in a non-symmetrical arrangement with respect to each other and/or at least one other fenestrations.

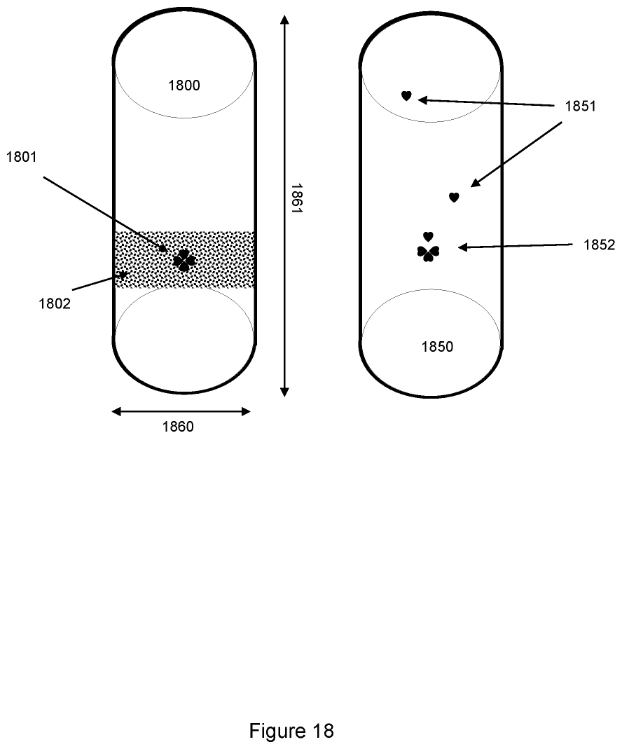

FIG. 18 shows an example of lid 1800 of a device ensemble housing, having heart shaped fenestrations 1801 that are symmetrically arranged via point symmetry, which fenestrations are disposed in a patterned portion 1802 of the lid 1800. FIG. 18 shows an example of lid 1850 of a device ensemble housing that has a group of shaped fenestrations 1852 that are arranged via mirror symmetry, and fenestrations 1851 that are non-symmetrically arranged with respect to each other and with respect to the other fenestrations 1852. FIG. 18 shows an example of a device ensemble width 1860 and device ensemble housing length 1861.

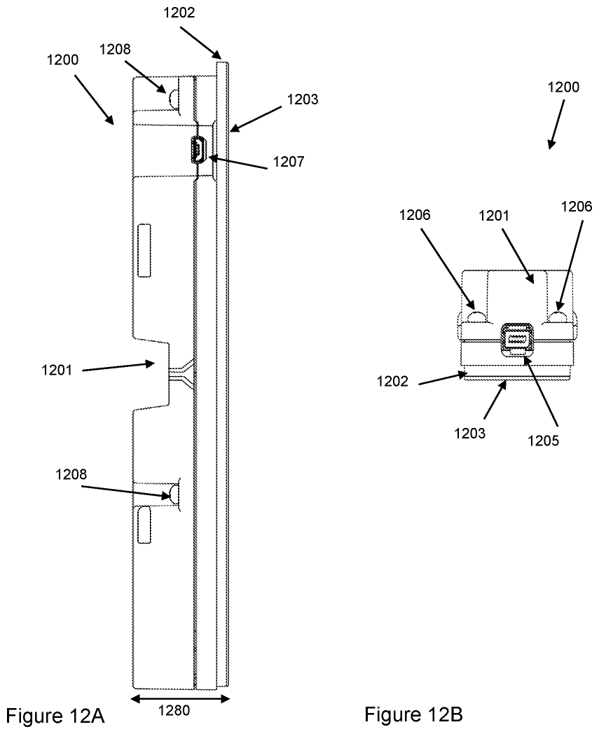

In some embodiments, the device ensemble housing (e.g., and lid thereof) has an elongated shape. The device ensemble can have a width (e.g., FIG. 18, 1860), length (e.g., FIG. 18, 1861), and depth (e.g., FIG. 12, 1280). The elongated shape can have an aspect ratio of length to width that is greater than 1. For example, the length of the device ensemble housing can be at least about 1.25 times (*), 1.5*, 1.75*, 2.0*, 2.5*, 3.0*, 3.5*, 4.0*, 4.5*, 5.0*, 5.5*, 6.0*, 6.5*, 7.0*, 7.5*, 8.0*, 8.5*, 9.0*, 9.5*, or 10.0* longer than the width of the device ensemble housing. The length of the device ensemble housing can be longer than the width by any multiplication of the width, which multiplication has the aforementioned values (e.g., from about 1.25* to about 10.0*, from about 1.25* to about 3.5*, from about 3.0* to about 6.5*, or from about 6.0* to about 10.0*). The sign “*” designates the mathematical operation of multiplication. The depth of the device ensemble housing may be configured to fit into a framing portion, e.g., such that the lid of the device ensemble housing is flush (or approximately flush) with the framing portion (e.g., mullion or transom). The depth of the device ensemble housing may be configured to fit into a cavity in a fixture (e.g., a wall, ceiling, or floor), e.g., such that the lid of the device ensemble housing is flush (or approximately flush) with an exposed surface of the fixture (e.g., fixture surface facing an occupant in a facility in which the fixture is disposed).

In some embodiments, at least one uninterrupted region (e.g., at an opposite longitudinal end of housing body from a fenestrated region) coincides with the mounting locations of heat-generating devices (e.g., processors, transmitters, Bluetooth, and/or UWB devices) disposed within the housing body. There may be at least one thermal wall (heat shield) and/or thermal absorber (heat sink) in the chamber. The thermal wall may segregate the gas exchange/environmental sensors. A heat sink may be included in strategic regions (e.g., per simulations such as shown in FIG. 5). A printed circuit board (PCB) or other support structure in the housing shell may include temperature sensor(s) (e.g., a grid of thermistors) to monitor the heat signature/map of the DAE ensemble, and resulting data can be used to manage heat load of and/or in the ensemble. Redundant heat generating sensors may be included in the same DAE or in other DAEs to manage heat load, e.g., sensor 1 can be taken offline while sensor 2 can assume the function in place of sensor 1.

In some embodiments, the front fascia (e.g., outward-facing side of the lid or a covering thereon) is textured at the fenestrated region (e.g., to mask the existence of the fenestration(s) from untrained eye) and is optionally smoother at an opposite (non-fenestrated) end. The front fascia may be a lid made of a material comprising elemental metal, metal alloy, ceramic, an allotrope of elemental carbon, glass fibers, a polymer, or a resin. For example, the lid may comprise Acrylonitrile Butadiene Styrene (ABS) plastic (e.g., machined and/or molded). The material may comprise composite material or non-composite material. The material may comprise organic or inorganic material. The material may include at least a portion that is transparent and/or a portion that is non-transparent (e.g., opaque). The material may comprise at least a portion that has a look similar to the fixture in which it is destined to be affixed to. The luster and/or specularity of at least the external portion of the DAE capsule may resemble the fixture (e.g., structural element of the enclosure) adjacent to which it is affixed (e.g., metallic if it is positioned in a metallic frame, dull if it is positioned on a dull fixture such as a wall or ceiling). For example, a smooth (e.g., mirror-like) surface exhibits specular reflection (e.g., angle of reflection equals angle of incidence) which appears glossy while a rough surface exhibits diffuse reflection (e.g., scattering) which gives a matte appearance. For example, a metallic luster having high specularity (e.g., high specular reflectivity) may be provided on the lid for a DAE destined to be affixed in a metallic (or metallic looking) fixture. Specularity may be characterized according to a ratio of the specular reflectance to the total reflectance. Since diffuse reflectance may be easiest to measure, specularity of any particular material may be determined as follows: (total reflectance minus diffuse reflectance) divided by total reflectance. Metal surfaces may have a specularity of from about 0.8 to about 0.99. Plastic surfaces may have a specularity of from about 0 to about 0.1. Specularity of painted surfaces may fall over a wide range. Low gloss paint may have a specularity from about 0.1 to about 0.2. Semi-gloss paint may have a specularity from about 0.2 to about 0.7. High gloss paint may have a specularity from about 0.7 to about 0.9. Plaster or wallboard may have a high gloss appearance. By altering the roughness of any surface (e.g., by scratching a surface to increase roughness or applying a coating to decrease roughness), the specularity can be raised or lowered. In some embodiments, a visible surface of the lid is formed of a particular matching material and/or is treated in a manner that provides a specularity similar to adjacent materials of its final installation.

The ensemble housing (e.g., capsule) can be of any three dimensional shape. The ensemble housing can have a portion facing an occupant. The portion facing the occupant can be a lid of the ensemble housing. The lid can be of any shape, e.g., a geometric shape. The lid can be elongated or wide. The lid can be circular. The lid can be a polygon (e.g., triangular, rectangular, pentagonal, hexagonal, heptagonal, or octagonal. The lid can have an aspect ratio that is 1:1. The lid can have an aspect ratio that differs from 1:1. The lid can have an aspect ratio of 1:x, where X is at least about 1, 2, 3, 4, 5, 6, or 8.

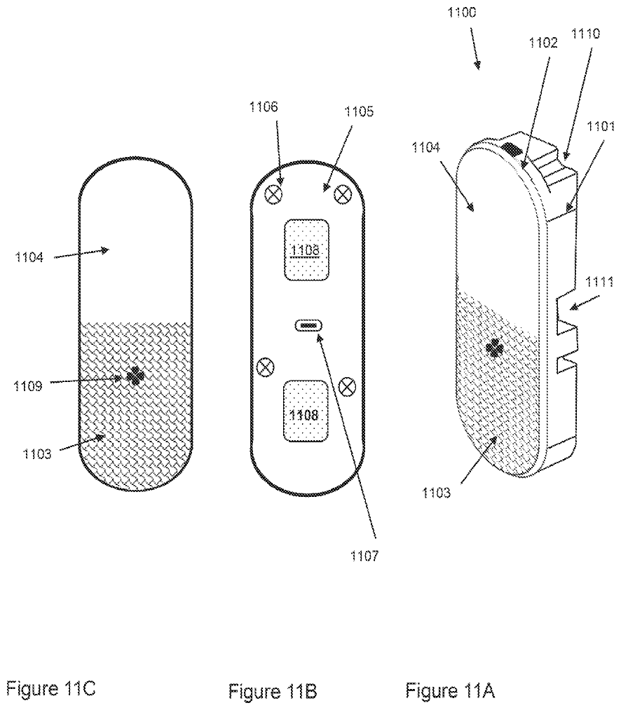

FIGS. 11A-C show various perspective views examples of an ensemble housing (e.g., a capsule) 1100 having a housing shell with a main housing body 1101 and a lid 1102. Main body 1101 defines an inner chamber (not shown) for containing circuitry and devices including, for example, a printed circuit board, sensors, emitters, processor(s), heat sinks, and or heat shields. Lid 1102 covers an opening to the inner chamber of the capsule. In the illustrated example, Lid 1102 and main body 1101 define an elongated capsule. The lid may have a fenestrated region 1109 in area 1103, which festered region containing openings. The fenestrated region can be at any region of the lid. In the example shown in FIG. 11A and FIG. 11C, the fenestrated region is in area 1103 that is textured (e.g., to camouflage the fenestrations). The festered region may be camouflaged by a textured lid portion. The lid may or may not include a textured portion. In the example shown in FIG. 11C and FIG. 11A, the textured region is at a first end (e.g., a lower end) of capsule 1101, a fenestrated region 1109 is formed of fenestrations (e.g., physical openings and/or optical windows) at locations corresponding to circuitry in the inner chamber which interact with an exterior of capsule 1100 through the fenestrations. The fenestrations may have various sizes and/or shapes, e.g., according to the need for exchanging atmospheric gases, sound waves, and/or electromagnetic radiation in and/or out of capsule 1100 and/or according to an arrangement or pattern that provides a pleasing appearance, for example. In some examples, at least two of the fenestrations have the same shape and/or size. In some examples, at least two of the fenestrations have different shapes and/or sizes. At a second end (e.g., an upper end) of capsule 1100, an untextured region 1104 is formed. The untextured region can be un-fenestrated or fenestrated. In the examples shown in FIG. 11A and FIG. 11C, the untextured region is un-fenestrated. The infenestrated region may provide a continuous barrier over circuitry located in a corresponding portion of the inner chamber. FIG. 11B shows an example of a back side 1105 of the capsule 1100 in which a socket 1107 is located, e.g., to allow connectivity to the communication network and/or power. The back portion may have one or more screws (e.g., 1106) that may attach the lid and/or circuit board to the back side of the capsule. In some embodiments, the screws do not attach the lid to the back portion of the capsule. The back portion of the capsule may have one or more depressions (e.g., 1108). The back portion of the capsule may have depressions (e.g., 1110 and 1111) and/or protrusions that facilitate correct orientation of the capsule in its intended working location.

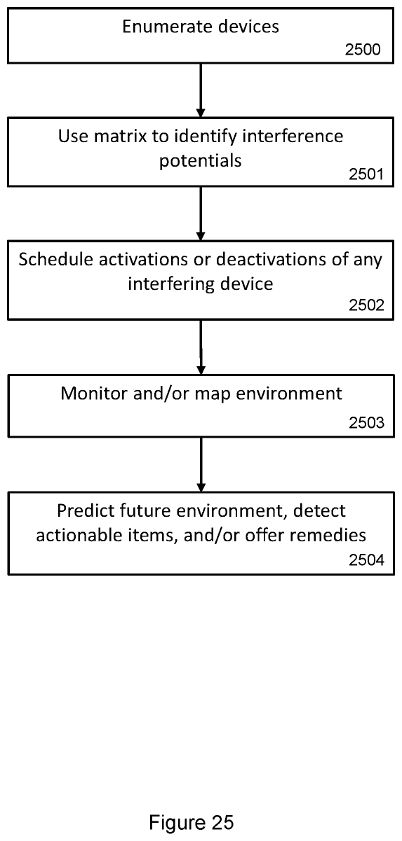

FIGS. 12A and 12B show various perspective views of capsule 1200 in which main body 1201 has an inner chamber covered by a lid 1202. An outer liner 1203 is applied along at least a portion of an outer surface of lid 1202. Liner 1203 may be comprised of a laminate, fabric and/or mesh having a porous structure which may be capable of hiding fenestrations in lid 1202 while continuing to provide optical, sound, and/or gas exchange between an interior of the capsule and an ambient environment. FIG. 12A shows a side view example showing a socket 1205 that facilitates connectivity of the devices in the capsule to communication and/or power network, and screws 1206 that fasten the circuity board and/or lid to the back of the capsule, and FIG. 25B is a top view example a socket 1207 that facilitates connectivity of the devices in the capsule to communication and/or power network, and screws 1208 that fasten the circuity board and/or lid to the back of the capsule.

In some embodiments, a designed cover includes at least the fenestrated region, which is permeable to gas and/or electromagnetic radiation. An irregular design or a patterned design may be provided over a fenestrated portion. A designed cover may include a fabric, screen, and/or mesh over the fenestrated region and/or over the un-fenestrated region. In some embodiments, at least a portion of the outer surface of the lid is visible (e.g., not covered by a mesh), and the visible lid surface may be smooth and/or provided with a design, e.g., an irregular design or a patterned design (e.g., by inscribing, embossing, or texturing).

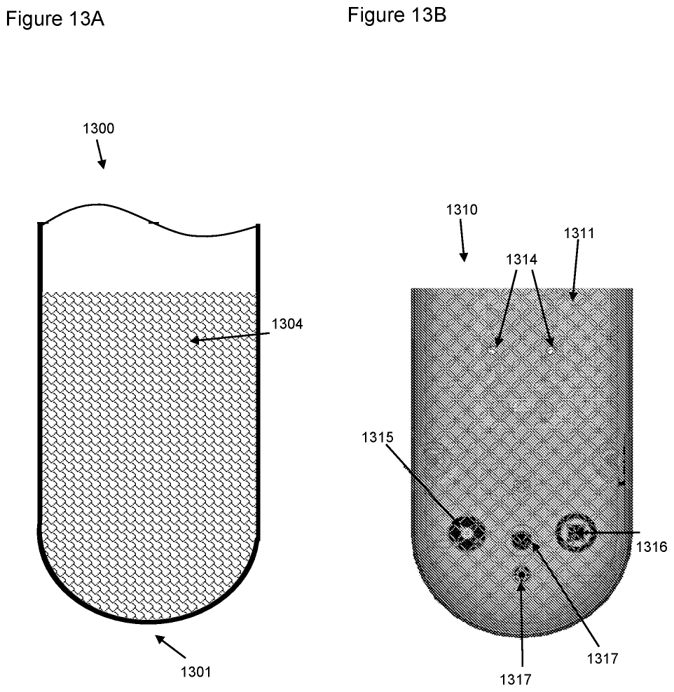

FIG. 13A shows an example of a portion of the capsule lid that includes a design (e.g., pattern). A capsule has a first longitudinal end 1301 at which the lid portion 1300 has a region 1304 that includes a design. The designed region 1304 may include one or more holes passing through a sheet-like or plate-like body of lid portion 1300 (e.g., formed of a metal sheet or molded plastic). FIG. 13B shows an example of a portion of the capsule lid 1310 that includes a design (e.g., pattern) 1311. The design can be formed by a (e.g., woven) mesh. In the example shown in FIG. 13B, the lid portion 1310 has a plurality of fenestrations (e.g., holes) 1314, 1315, 1316, and 1317. At least two of the fenestrations (e.g., 1314) are of the same size and circular shape. At least two of the fenestrations (e.g., 1317 and 1316) are of different size and different shape. At least two of the fenestrations (e.g., 1317 and 1314) are of different size and of the same circular shape. The fenestrations can be aligned or misaligned with the devices which they server. For example, a pair of fenestrations 1314 (e.g., open holes) may provide gas exchange ports for a CO₂ sensor mounted on a printed circuit board in capsule 1310 aligned with fenestrations 1314. For example, a fenestration 1315 (e.g., an open hole) may be aligned with a microphone on the printed circuit board. For example, a fenestration 1316 (e.g., an open hole) may be aligned with a VOC sensor for measuring volatile organic compounds. For example, a fenestration 1317 (e.g., a translucent window) may be aligned with an ambient light sensor (ALS) on the printed circuit board to admit ambient light for measurement. the design 1311 may hide the appearance of the fenestrations which are comprised of open holes.

In some embodiments, a fenestration for passing electromagnetic radiation (e.g., admitting light to an ambient light sensor (ALS) or emitting light from an LED) includes a light pipe passing through a corresponding opening in the lid of the capsule. For example, the lid may be formed of an opaque material (e.g., molded plastic) with an aperture at a location corresponding to a light receiving or emitter device. A transparent or translucent body may be inserted into the aperture to at least partly seal the aperture, while efficiently transmitting light. The light pipe element may be heat-staked to a back surface of the lid over an LED on the circuit board, for example.

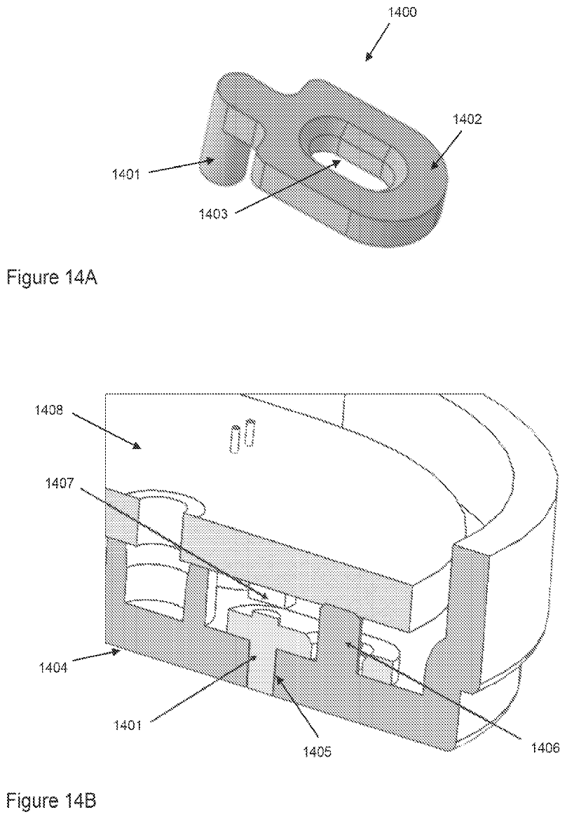

FIG. 14A shows an example of a light pipe element 1400 having a transparent pipe body 1401 and a mounting flange 1402 with an opening 1403. Light pipe element 1400 may be formed a unitary body (e.g., by injection molding or 3D printing). FIG. 14B shows an example of a light pipe element 1400 mounted with its pipe body 1401 inserted into a fenestration aperture 1405 in a lid 1404. An inner side of lid 1404 has a mounting post 1406 which is received by opening 1403 of mounting flange 1402. Lid 1404 may be formed of plastic, and post 1403 may be partially melted in order to heat stake light pipe element 1400 in place. Lid 1404 may be formed of any material disclosed herein (e.g., metal). Pipe body 1401 is aligned with an ambient light sensor 1407 which is mounted on a printed circuit board 1408.

In some embodiments, a DAE capsule is integrated into a window mullion. For example, a mullion may easily provide sufficient space for a capsule and for cable routing (e.g., including connectors). In some embodiments, a mullion placement is configured for sensing internal and/or external environments to the enclosure of the facility (e.g., in which the ensemble is mounted). Mullion mounting may be unobtrusive and may provide easy access for repair/replacement (snap joint removable without tools). In some embodiments, a spline and a mullion cap are configured to retain the capsule for a DAE. The spline may comprise the same material as the DAE material (e.g., aluminum strip, elemental metal, metal alloy, ceramic, an allotrope of elemental carbon, glass fibers, a polymer, or a resin) and may be fixedly mounted to a building structural element (e.g., a window fixture). The mullion cap may be a U-shaped channel (e.g., comprising the same ensemble material such as aluminum) with a joint which is configured to form a mated assembly with the spline, e.g., snapping together with the spline. An open slot in face of a frame (e.g., mullion) cap may be configured to expose the capsule fascia. In some embodiments, an intermediate coupler (e.g., an insert) is provided for securing the capsule to the spline and to the cap.

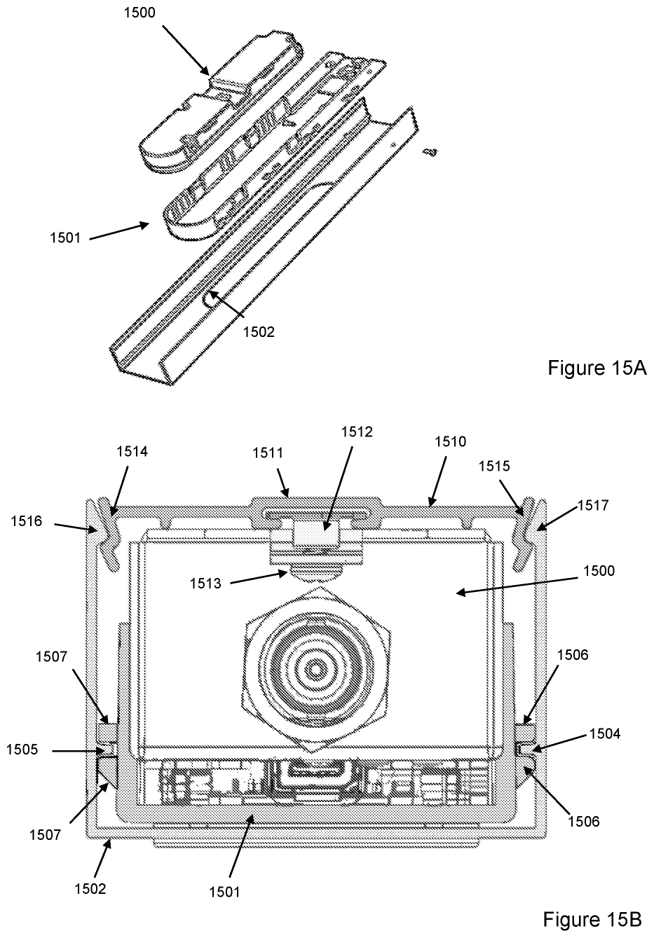

FIGS. 15A and15B show different view examples of a capsule 1500 which is received in an insert coupler 1501 to form the capsule (e.g., ensemble housing), and a U-shaped mullion cap 1502 into which the capsule is inserted. For example, coupler 1501 may be comprised of plastic or metal and may have features allowing it to be snapped over capsule 1500, with the lid side of capsule 1500 being exposed by an elongated opening of coupler 1501. The capsule and any of its components may be formed from any material disclosed herein. A spline 1510 (FIG. 15B showing an example of a vertical cross section view) may be comprised of an elongated strip which is fixedly mounted on a window frame structure or a permanent fixture of a building. A central portion of spline 1510 may, for example, include a fastener socket 1511 holding a threaded nut 1512. A mounting screw 1513 may pass through a mounting hole of capsule 1500 to be tightened into nut 1512 for holding capsule 1500 to spline 1510. U-shaped mullion cap 1502 may include a pair of inner rails 1504 and 1505 which are retained in guide tabs 1506 and 1507, respectively, projecting at opposite sides of coupler 1501. Spline 1510 may further include side rails 1514 and 1516 with a stepped profile for receiving projections 1516 and 1517, respectively, along opposite edges of U-shaped mullion cap 1502 to provide a snap-fit. Accordingly, mullion cap 1502 may be removable from spline 1510 without tools. FIG. 15A shows a perspective view.

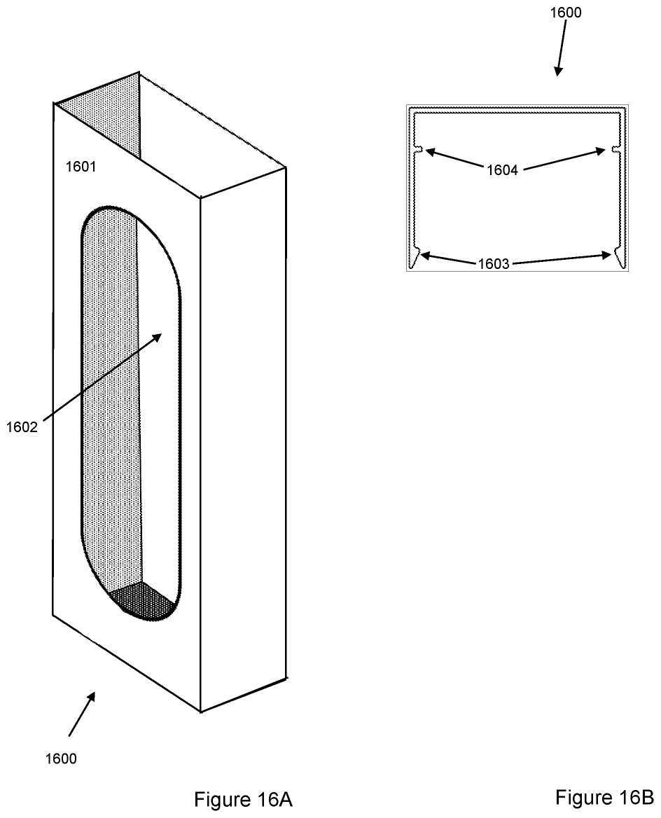

FIGS. 16A and 16B show various views of a mullion cap 1600. A front-facing surface 1601 includes an elongated slot 1602 for exposing at least a front lid portion of the capsule for a DAE. An inner surface of cap 1600 provides projections 1603 for forming a snap fit to a window spline and rails 1604 of mating with matching tabs on an intermediate coupler installed over a DAE capsule. FIG. 16A shows an example of the mullion cap as a perspective view. FIG. 16B shows an example of the mullion cap as a cross sectional view.

In some embodiment, a DAE capsule is integrated into wall directly or using a (e.g., decorative) wall holster. For example, a capsule design having features adapted for assembly into a window mullion can be mounted to a wall or other flat surface (e.g., flat interior surface in an enclosure such as a partition, ceiling, transom, or door) using appropriate hardware (e.g., holster, adapter, fastener). For example, a DAE capsule may be integrated into ceiling directly, or with a ceiling holster. Some surfaces for supporting an ensemble capsule (such as a ceiling) may too far away from building occupants or other entities to be sensed within the enclosure. In some embodiments, the capsule is moved away from the supporting surface using a mast extending from the surface and carrying cabling to a capsule mounted at a distal end of the mast. In some embodiments, the DAE capsule may be at least partially located behind a wall, floor, or ceiling surface so that a front fascia of the lid is flush with the wall, floor, or ceiling surface. In some embodiments, the DAE capsule may be at least partially outside the wall or ceiling surface, wherein a cover of the DAE capsule includes lateral sides of various configurations for providing a finished appearance. For example, capsule cover shapes may include a dome, crown, bevel, extruded, or a flange. The cover shape can contact the back of the capsule, the side of the capsule, and/or the front (e.g., lid) of the capsule). The front of the capsule faces an occupant of the enclosure and/or is the face of the capsule that is furthers away from the fixture to which the capsule is affixed to. The back of the capsule faces away from an occupant of the enclosure and/or is the face of the capsule that is the closest to the fixture to which the capsule is affixed to (e.g., closest to the wall).

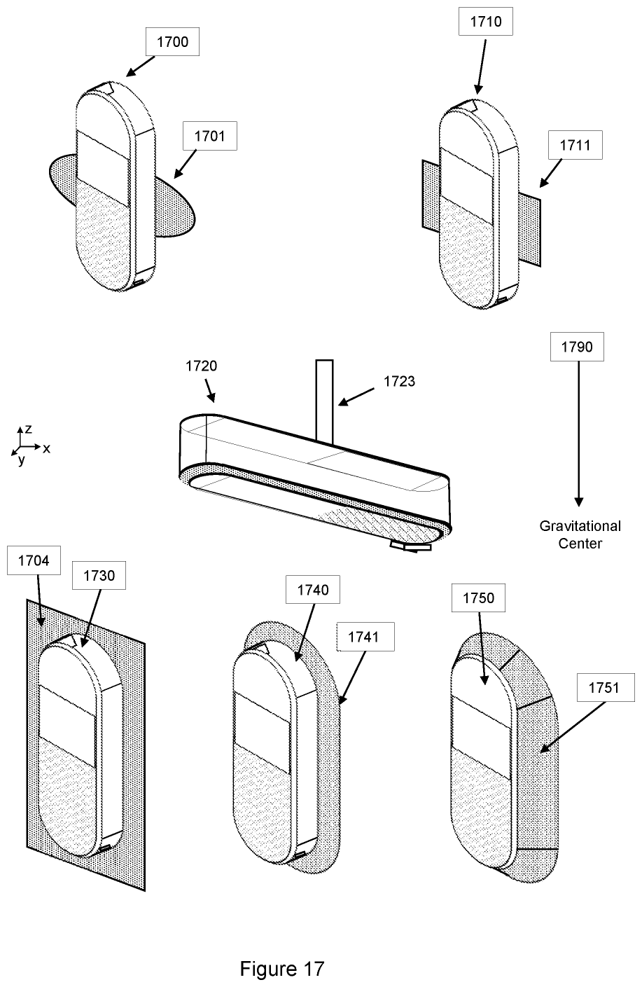

FIG. 17 shows an example of a DAE capsule 1700 in which an outer surface of the capsule 1700 provides a finished cover which is connectable to a wall-mount plate 1701. The wall mount plate can have any shape such as a geometric shape or an abstract shape. FIG. 17 shows an example of a wall mount plate having an elliptical shape 1701 and a wall mount shape having a rectangular shape 1711 affixing capsule 1710 to a fixture (e.g., a wall). The geometric shape can be any geometric shape, e.g., disclosed herein. In order to extend capsule 1700 from a mounting surface, for example, capsule 1720 may be adapted to connect to a mast 1723. The mast may be connected to the capsule via an intermediately mounting block (not shown) affixed to an end of a mast 1703. An outside cover surface of a capsule may be framed (e.g., framed and attached to a fixture such as a wall). The frame may have any (e.g., geometric or abstract) shape. For example, capsule 1730 is framed by a rectangular frame. For example, capsule 1730 is framed by a frame 1741 that has curved edges. The frame may connect to the back of the capsule or to the front face of the capsule. FIG. 17 shown an example of frame 1741 that is connected to the back of capsule 1740, and domed frame 1751 that is connected to the front of capsule 1750 and extends to engulf the back of capsule. 1790 designates a gravitational center pointing vector. Capsules 1700, 1710, 1720, 1730, 1740, and 1750 are aligned with respect to vector 1790.

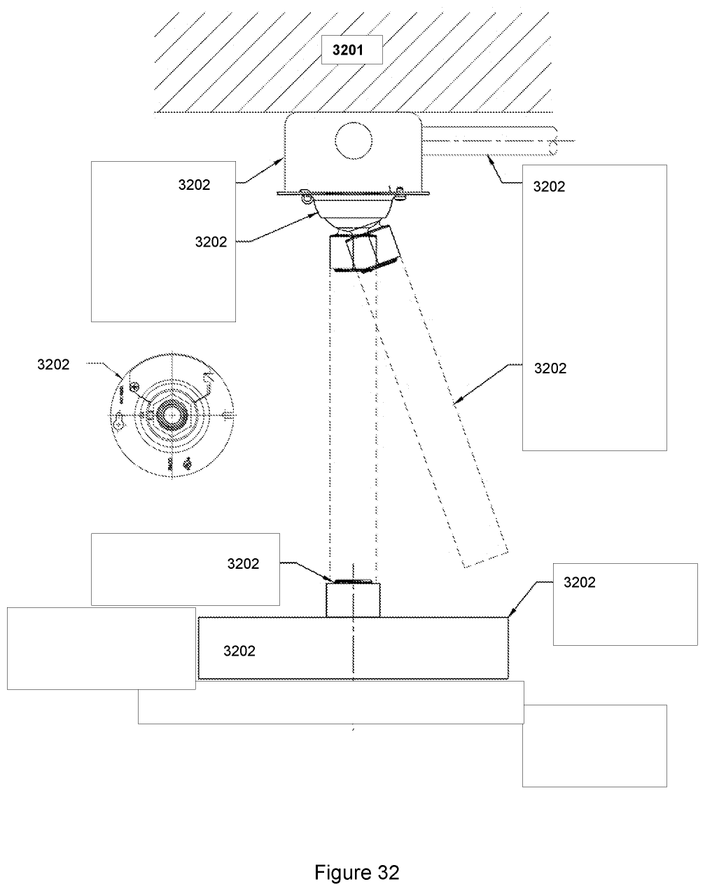

In some embodiments, the capsule (e.g., DAE housing) is attached to a mast. The mast may or may not be configured to swivel. The mast may swivel continuously and/or intermittently (e.g., comprise swiveling stations). For example, the mast may swivel continuously when subjected to a first force, and swivel intermittently when subjected to a second force that is less than the first force. The mast may be connected to a curved member (e.g., a dome or a ball) joint. The joint may be disposed in a socket. The joint may be configured to facilitate continuous or discontinuous swiveling. The joint may be smooth, comprise recessions and/or protrusions. The recessions/protrusions may facilitate intermittent swiveling. The swiveling of the mast may facilitate pointing the DAE housing into a requested direction. FIG. 32 shows an example of a swiveling mast disposed in a first position 3201a and in a second position 3201b. The swiveling can be continuous or discrete. The swiveling mast is connected to a joint having a joint cover 3202. The joint cover may comprise a screw (e.g., an octagonal screw as can be seen in a horizontal cross section of the swivel and its cover 3207) The mast is connected to the DAE housing 3203. The mast is coupled to the wall (e.g., ceiling) 3208 via a wall connector 3205. The mast facilitates coupling of the DAE to the network by cabling. Wall connector 3205, joint (in housing 3202), mast 3201 (a and b), mast connector 3206, and DAE housing 3203 allow the cabling 3204 to run therethrough and connect to the circuitry disposed in the DAE housing (not shown). The cabling may facilitate transmission of power and/or communication. The cabling may comprise ethernet cabling (e.g., CAT5e ethernet cable). The cabling may include twisted wires, optical wires, and/or coaxial cable. The wall connector may be of any (e.g., geometrical) shape. The wall connector may be a box, pyramid, prism, or cone. The prism may be a triangular, pentagonal or octagonal prism. The mast (e.g., 3001a) may be of any length. The mast may be of a fixed or variable length. The mast may be fixed. The mast may be (e.g., reversibly) shrinkable or extendable. The wall connector may comprise one or more holes to facilitate mounting it to the wall (e.g., via screw(s)). The wall may be a ceiling. The wall may be a vertical wall.

In some embodiments, the DAE capsule (e.g., housing) may be disposed recessed with respect to an external surface of a fixture (e.g., mullion, transom, floor, ceiling, and/or vertical wall). In some embodiments, the DAE capsule (e.g., housing) may be disposed flush with an external surface of a fixture (e.g., mullion, transom, floor, ceiling, and/or vertical wall). The external surface is the surface facing an occupant of the enclosure in which the capsule is disposed.

In some embodiments, a DAE capsule is adapted for (e.g., specialized) data collection. For example, a control system may provide an alert regarding at least one environmental characteristic of an enclosure (e.g., atmosphere of the enclosure), e.g., when the at least one environmental characteristic deviates from a threshold (e.g., a maximum threshold, a minimum threshold, or an acceptable window range comprising a maximum threshold and a minimum threshold). The threshold can be a threshold value, a threshold function, or a threshold range (e.g., threshold window). The alert may be in a way of an optical, written, and/or audio message (e.g., a lit or flashing light, a sound, and/or a written message). The ensemble capsule may include at least one sensor configured to sense electromagnetic radiation in the form of an image (e.g., variations of intensity of radiation received from different locations in a room). For example, the at least one sensor may comprise an array of sensors, such as an IR sensor array (e.g., thermal imager). In some embodiments, the DAE ensemble capsule (or a group of capsules) may be utilized to detect characteristics of enclosure occupant(s). For example, the ensemble may be utilized to detect abnormal bodily characteristic of enclosure occupant(s), such as is disclosed in U.S. Provisional Patent Application Ser. No. 63/993,617, filed Mar. 23, 2020, titled “SENSING ABNORMAL BODY CHARACTERISTICS OF ENCLOSURE OCCUPANTS,” that is incorporated herein by reference in its entirety. The abnormal bodily characteristic may comprise bodily temperature, coughing, sneezing, perspiration (e.g., humidity and/or VOCs expulsion), or CO₂ level.

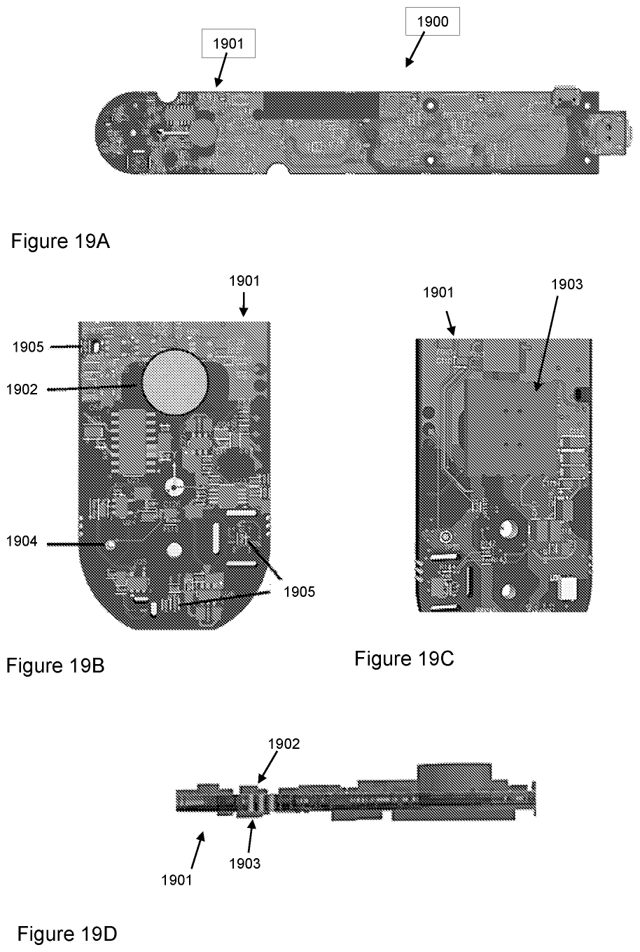

FIGS. 19A, 19B, 19C, and 19D show various views of a printed circuit board 1900 and portions thereof, which circuit board is configured for integration into a capsule ensemble for a DAE having functionality for data collection and/or processing, e.g., related to thermal imaging. FIG. 19A shows a top view of circuit board 1900, FIG. 19B shows an enlarged top view of a portion of circuity board 1900, FIG. 19C shows an enlarged bottom view of a portion of circuity board 1900, and FIG. 19D shows a side view of a portion of circuity board 1900. A first end 1901 of circuit board 1900 retains a thermal imaging array 1902 (e.g., a Melexis MLX90640 IR Imaging Array or any other suitable device) in a position corresponding to a fenestrated region of a lid of the capsule (not shown). Thermal imaging array 1902 is electrically and mechanically connected to a breakout board 1903 located on an opposite side of circuit board 1900. Breakout board 1903 may have castellated holes along its edges for electrical interconnection and for mounting. Circuit board 1900 may have cutout holes for passing through the lead wires of thermal imaging array 1902 to breakout board 1903. A microphone 1904 is mounted at first end 1901 of circuit board 1900 for collecting sounds to be analyzed along with data from thermal imaging array 1902. Circuit board 1900 further include a plurality of onboard thermistors 1905, e.g., for characterizing the temperature and heat flow at circuit board 1900 (which may impact performance).

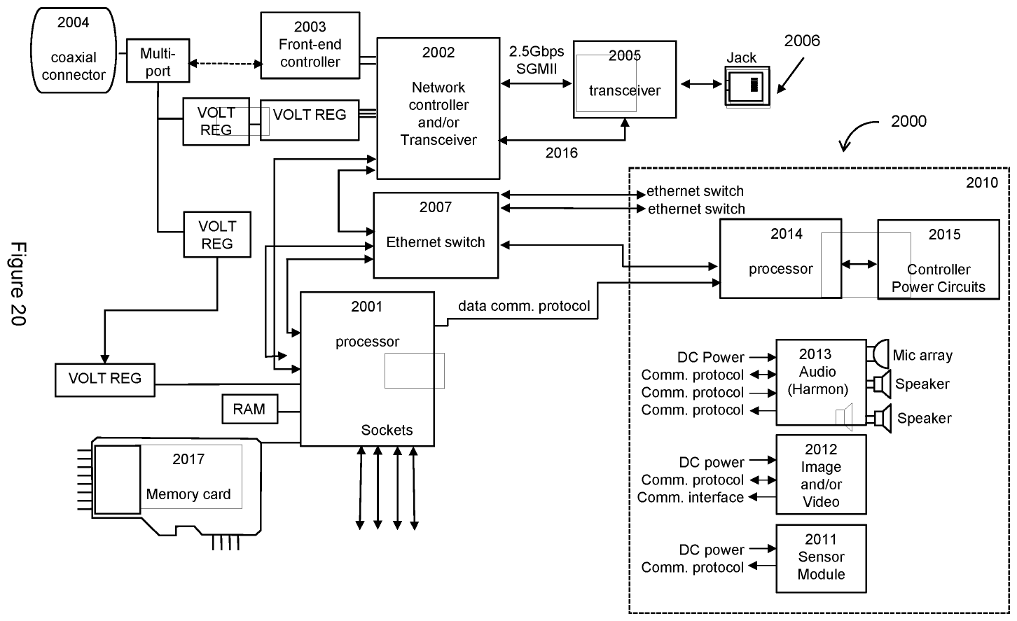

In some embodiments, an ensemble including sensors, emitters, actuators, receivers, and/or transmitters in a consolidated assembly can comprise one node in a larger network providing data and communications services for occupants of an enclosure. Sophisticated environmental control, security, and advanced person-to-person collaboration is provided by an example assembly architecture shown schematically in FIG. 20. In some embodiments, a smart control unit can comprise hardware, firmware, and/or software components designed to provide desired data processing, communication, and control actions according to performance of predefined functions (e.g., tintable window and other environmental controls) in coordination with other similar units, other local devices, and/or other remote devices. In the example of FIG. 20, a control unit assembly 2000 includes a main applications processor 2001 connected to a network controller and/or (e.g., RF) transceiver 2002 (e.g., coaxial network controller and RF Transceiver). In this example, a Multimedia over Coax Alliance (abbreviated herein as “MoCA”) front-end controller 2003 (e.g., MoCA front-end integrated circuits) connects network controller 2002 to a coaxial connector 2004. The coaxial connector can provide a communication and/or power link to other consolidated assemblies (e.g., in the same enclosure or located remotely). The coaxial connector can be configured to facilitate radio frequency communication (e.g., F type coaxial connection). The front end may comprise an integrated circuit that includes a monolithic microwave integrated circuit (IC), such as an IC comprising GaAs. An Ethernet transceiver 2005 (e.g., multi-Gigabit ethernet transceiver) and a jack (e.g., ethernet connector) 2006 provide Ethernet communication to processor 2001(e.g., audio, voice, and video processor) via network controller 2002 and an ethernet switch 2007. The controller may comprise one or more ethernet switches. The controller may comprise one or more sockets for cabling that transmit ethernet (e.g., twisted pair and/or coaxial cables). The network controller 2002 may communicate with the transceiver via a serial bus 2016 (e.g., a bus defined for the Media Independent Interface (MII)). In this example, an ensemble 2010 comprises a sensor module 2011, a video module 2012, and an audio module 2013. The video module in FIG. 20 is connected to a communication interface. The communication interface (Comm. Interface) may be configured to transmit image and/or video. Ensemble 2010 further comprises a processor 2014 and controller power circuits 2015 (e.g., for local controller(s) such as window controllers(s)). In this example, an assembly mounted for controlling a tintable window can be deployed in a way that provides additional enhanced smart features to user/occupants of a space (e.g., video and/or audio conferencing, and/or network access). The controller may comprise one or more voltage regulators (abbreviated in FIG. 20 as “VOLT REG”). The power in the network and/or control circuitry may be at least about 12V, 24V, 48V, or 96Volts (V) DC. The controller may comprise a socket configured to facilitate coupling with a memory device (e.g., a memory card 2017). Direction of the arrows in FIG. 20 designates the communication direction, with bidirectional arrows designating bidirectional communication, and monodirectional arrows designating monodirectional communication. The controller may comprise one or more sockets, the sockets can be USB, or HDMI sockets. The socket may be configured to communicate audio, images, video, data, and/or power. The socket may be configured to communicate to at least one external memory and/or processor. The socket may be a communication port. The communication port may be a serial port or a parallel port. The communication port may be a Universal Serial Bus port (i.e., USB). The USB can be micro or mini USB. The USB port may relate to device classes comprising 00h, 01h, 02h, 03h, 05h, 06h, 07h, 08h, 09h, 0Ah, 0Bh, 0Dh, 0Eh, 0Fh, 10h, 11h, DCh, E0h, EFh, FEh, or FFh. The controller may comprise a Bluetooth technology. The controller may comprise a plug and/or a socket (e.g., electrical, AC power, DC power). The controller may comprise an adapter (e.g., AC and/or DC power adapter). The controller may comprise a power connector, and/or be configured to connect to a power connector. The power connector can be an electrical power connector. The power connector may comprise a magnetically attached power connector. The power connector can be a dock connector. The connector can be configured to include, and/or connect to, a data and/or power connector. The connector may comprise pins. The connector may comprise at least 10, 15, 18, 20, 22, 24, 26, 28, 30, 40, 42, 45, 50, 55, 80, or 100 pins. The socket may be configured to connect to at least a portion of the connector pins. The memory may be a mass storage device (e.g., as hard disk drive, optical drive, and/or solid-state drive). The port may comprise a serial or a parallel attachment. The socket may facilitate connection to a high- speed serial computer expansion bus (e.g., a Peripheral Component Interconnect Express). The socket can be a jack (e.g., 2006) such as a registered jack. The socket may configured to connected to one or more cables. The cables can be twisted pair or coaxial cables. The twisted pair and/or coaxial cables may facilitate transmission of power and/or communication (e.g., ethernet). The communication speed on the cable may be at least about 0.1 Gigabit per second (Gbit/s), 1.0 Gbit/s, 2.5 Gbit/s, 4 Gbit/s, or 5 Gbit/s. The controller may comprise a multi-port. The multi-port may be a three-port network (e.g., bias tee). The multi-port may be utilized for setting the DC bias point of some electronic components, e.g., with minimally disturbing other components to which it is communicatively coupled. The bias tee may be a diplexer. The multi-port may be a low-frequency port, e.g., that is used to set a bias. The multi-port may comprise a high-frequency port that facilitate transmission of radio-frequency signals (e.g., and reduced transmission (e.g., blocks) the biasing levels). The multi-port may connect to at least one device. The device may be exposed to both the bias and the RF signal. The controller may be configured (e.g., comprise hardware configured) for asynchronous serial communication, e.g., in which the data format and transmission speeds are configurable. For example, the controller may comprise a universal asynchronous receiver-transmitter. The controller may be communicatively coupled to (and/or include) random access memory (RAM).

In some embodiments, the controller may comprise a processor. The processor may be configured to process voice, audio, image, and/or video. The image may be an ultra-high definition (e.g., at least 4K) image. The image may be displayed on a screen (e.g., light emitting diode (LED) screen such as a transparent organic LED (TOLED) screen). The screen may have at its fundamental length scale 2000, 3000, 4000, 5000, 6000, 7000, or 8000 pixels. The screen may have at its fundamental length scale any number of pixels between the aforementioned number of pixels (e.g., from about 2000 pixels to about 4000 pixels, from about 4000 pixels to about 8000 pixels, or from about 2000 pixels to about 8000 pixels). A fundamental length scale may comprise a diameter of a bounding circle, a length, a width, or a height. The fundamental length scale may be abbreviated herein as “FLS.” The screen construct may comprise a high resolution screen. For example, the screen may have a resolution of at least about 550, 576, 680, 720, 768, 1024, 1080, 1920, 1280, 2160, 3840, 4096, 4320, or 7680 pixels, by at least about 550, 576, 680, 720, 768, 1024, 1080, 1280, 1920, 2160, 3840, 4096, 4320, or 7680 pixels (at 30 Hz or at 60 Hz). The first number of pixels may designate the height of the screen and the second pixels may designate the length of the screen. For example, the screen may be a high resolution screen having a resolution of 1920×1080, 3840×2160, 4096×2160, or 7680×4320. The screen may be a standard definition screen, enhanced definition screen, high definition screen, or an ultra-high definition screen. The screen may be rectangular. The image projected by the screen may be refreshed at a frequency (e.g., at a refresh rate) of at least about 20 Hz, 30 Hz, 60 Hz, 70 Hz, 75 Hz, 80 Hz, 100 Hz, or 120 Hertz (Hz). The FLS of the screen may be at least 20″, 25″, 30″, 35″, 40″, 45″, 50″, 55″, 60″, 65″, 80″, or 90 inches (″). The FLS of the screen can be of any value between the aforementioned values (e.g., from about 20″ to about 55″, from about 55″ to about 100″, or from about 20″ to about 100″). The processor may process a plurality of audio channels, e.g., the processor may support at least 5, 10, 15, 20, 25, or 30 audio channels (e.g., at about 384 KHz). The processor may comprise a plurality of cores (e.g., at least 1, 3, or 6 cores). The processor may be utilized for embedded system processing applications and/or real time applications. The processor may have a clock speed of at least about 1 GHz, 1.3 GHz, 1.6 GHz, 1.9 GHz, or 2 Giga Hertz (GHz). The processor may have at least about 16, 32 or 64 bit CPU capability. The processor may facilitate operation of a real time operating system kernel (RTOS), e.g., for embedded device(s). The processor may comprise one or more chips optimized for low-cost and/or energy-efficient (e.g., micro-) controller.

In some embodiments, the controller may connect to a sensor module. The sensor module may connect to a communication protocol (abbreviated in FIG. 20 as “comm. Protocol”). The communication protocol may comprise a half-duplex communication protocol (12C) or a full duplex commination protocol (SPI). The communication protocol may comprise clock stretching (e.g., when the slave node is not able to send fast data as fast enough then the protocol suppresses the clock to stop the communication). The communication protocol can be embedded in a programmable logic device (e.g., FPGA).

In some embodiments, the controller comprises a front end controller. The front end controller can be an analog front-end controller (abbreviated herein as AFEC). The front end controller can comprise analog signal conditioning circuitry, e.g., that uses one or more (e.g., sensitive) analog amplifiers, filters, and/or application-specific integrated circuits (e.g., for sensors, radio receivers). The front end controller may provide a configurable and/or flexible electronics functional block. The front end controller may facilitate interfacing one or more sensors to at least one antenna (e.g., using analog to digital converter), and/or to a microcontroller. The front-end controller can be a radio frequency (RF) front-end. The front-end controller can be embedded in at least one chip.

In some embodiments, the controller may comprise an Ethernet switch. The Ethernet switch may have a plurality (e.g., at least 3, 5, or 7) ports. At least one of the ports (e.g., each port) can be (e.g., individually) configured to operate in one of several modes. The modes may comprise various media-independent interface modes (e.g., media independent interface (MII), reduced media-independent interface (RMII), gigabit media-independent interface (GMII), reduced gigabit media-independent interface (RGMII), serial gigabit media-independent interface (SGMII), high serial gigabit media-independent interface (HSGMII), quad serial gigabit media-independent interface (QSGMII), or 10-gigabit media-independent interface (XGMII)). The ethernet switch may facilitate connection with various communication switched, microprocessors, and/or Fast Ethernet and Gigabit Ethernet PHY. The ethernet switch facilitates scalability. The Ethernet switch can be used in automotive applications (e.g., gateway applications), and/or in domain controllers. The ethernet switch support audio, visual, and/or video application.

In some embodiments, the controller circuitry comprises a serial bus, e.g., a bus defined for the Media Independent Interface (MII). The serial bus may comprise a Management Data Input and/or Output (MDIO), Serial Management Interface (SMI), and/or Media Independent Interface Management (MIIM). The MII may connect to Media Access Control (MAC) devices with Ethernet physical layer (PHY) circuits. The MAC device may control the MDIO.

The controller may be communicatively coupled to, and/or include random access memory (RAM). The RAM may be low power double data rate RAM. The RAM may store short term data, e.g., used by application(s).

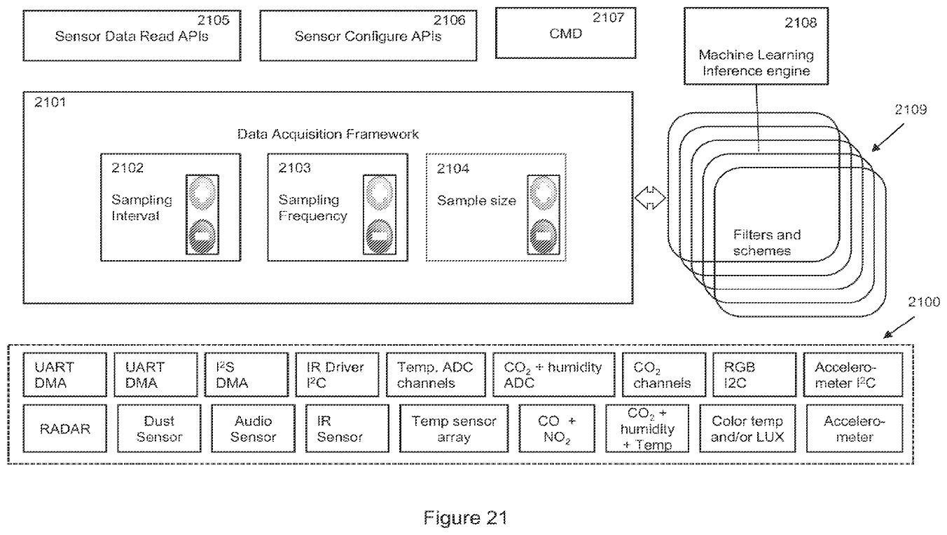

Requested capabilities of a control architecture for a controller unit may comprise platform independent drivers, a common driver framework, bus sharing and synchronization at the transport layer, a bus lockout and recovery mechanism, driver test module, clock gating and PM functions integrated to the driver, CLI driver test routines, a Data Acquisition framework (e.g., with a data path between a sensor driver and application layer, including variable sampling intervals, sample size and FIFO sizes), OS Abstraction Layers, SSL/TLS, IP stack Integration, BLE Integration, FTL and wear leveling for serial NAND Flash, a port reference implementation for wear leveling and Flash Translation Layer, an event logging system and diagnostic interfaces, a command shell, ML Inference Engine, processing engines (e.g., for RADAR and/or sensor fusion), system health check and recovery, a location engine, and power management, for example. The control architecture is configured to handle the expanded functionalities and modalities which are consolidated into an assembly. FIG. 21 shows an example wherein an ensemble 2100 is accessed by a data acquisition framework 2101 which defines a sampling interval 2102, a sampling frequency 2103, and a sample size 2104 according to respective elements of ensemble 2100. Sets of Application Program Interfaces (APIs) comprising Sensor Data Read APIs 2105 and Sensor Configure APIs 2106 are configured to enumerate, configure, calibrate, and access the elements of ensemble 2100 (e.g., sensors). A command (CMD) block 2107 supervises command and control. A machine learning interface engine 2108 and a collection of filters and schemes 2109 can register threads in live data for processing schemes according to particular sensors. Device ensemble 2100 includes the following devices and related connectors: universal asynchronous receiver-transmitter with direct memory access (DMA), Inter-integrated circuit sound (I²S) with DMA, Infrared (IR) driver I²C, temperature (Temp.) ADC channels, Carbon dioxide (CO₂) and humidity ADC, CO₂ channels, color (RGB) I²C, Accelerometer I²C. Device ensemble 2100 includes the following devices (e.g., sensors): radar, dust sensor, audio sensor, IR sensor, temperature (Temp.) sensor array, carbon monoxide (CO) and Nitrogen Dioxide (NO₂) sensor(s), color temperature and/or light (LUX) sensor, and accelerometer. Any of the devices may comprise, or be operatively coupled to, an analogue to digital converter (ADS). For example, a device may have an ADS associated and/or dedicated to it (e.g., Temp. ADC channels). The ensemble may comprise a connector (e.g., a bus) for integrated circuits (ICs) such as a multi-master bus (e.g., I²C). The connector (e.g., bus) may connect one or more devices and/or chips. The connector can act as a master by initiating a data transfer. The connector can comprise an inter-integrated circuit (I²C). The connector may comprise a serial bus (path) design for digital audio devices and/or digital sound processors, e.g., Inter-IC Sound (I²S). The bus may be configured to handle audio data separately from clock signals. The ensemble may comprise a circuitry configured for asynchronous serial communication, e.g., in which the data format and transmission speeds are configurable. For example, the ensemble may comprise a universal asynchronous receiver-transmitter (UART). The ensemble may comprise one or more Direct Memory Access (DMA) components configure to transfer data from data source locations (e.g., sensors) to data destination locations (e.g., memory storage), e.g., without intervention of the CPU or other on-chip devices. The ensemble may comprise a computer program (e.g., driver) configured to controls a device that is attached to a processor. The driver may depend on the hardware (e.g., device) dependent and/or operating-system-specific. The driver may provide an interrupt handling, e.g., required for an asynchronous time-dependent hardware interface.

In some embodiments, a coexistence matrix provides a tool or resource for evaluating, ranking, and/or memorializing potential interactions (e.g., interference) between modules and/or other electronic elements of any particular assembly. The interactions could result in intra assembly interference and/or inter assembly interference. The coexistence matrix may evaluate different devices as an Aggressor with respect to at least one other device as a Victim. At each intersecting cell in the coexistence matrix, a designation, characterization, and/or quantization of the interference impact during simultaneous operations of the corresponding Aggressor upon the corresponding Victim is provided using known performance specifications and/or empirical evaluations. Designations can represent relative susceptibility to interference (e.g., High potentials to relatively Lower potentials). In some embodiments, designations can represent absolute measures of interference. The coexistence matrix can be informative as to potentially interfering elements. The coexistence matrix can facilitate development of actionable insights. The actionable insights can be used to (i) reduce interference and/or (ii) map interfering properties, in order to gain additional environmental data.

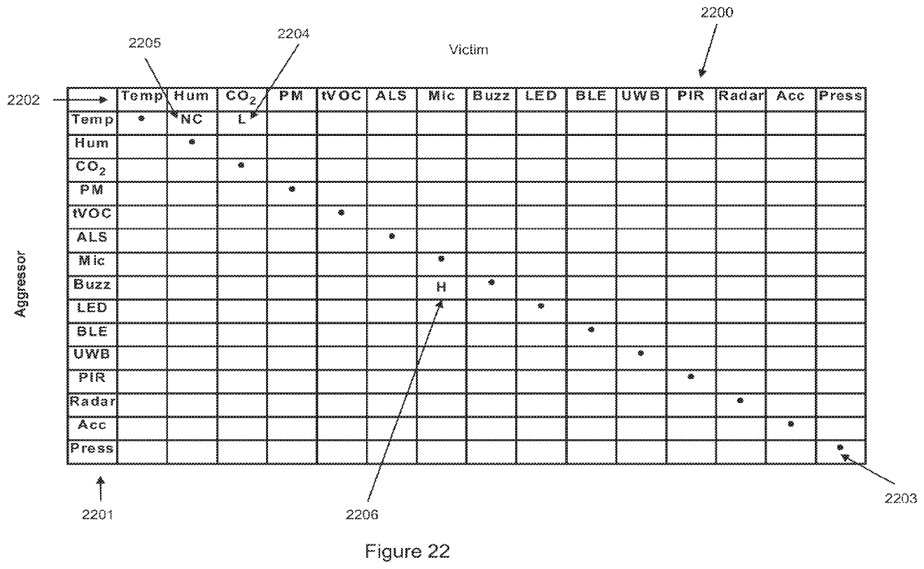

FIG. 22 shows an example representation of a coexistence matrix 2200 in which Aggressor devices (e.g., temperature sensor (abbreviated as “Temp”), humidity sensor (abbreviated as “Hum”), carbon dioxide sensor (abbreviated as “CO2”), particulates sensor (abbreviated as “PM”), total volatile organics sensor (abbreviated as “tVOC”), ambient light sensor (abbreviated as “ALS”), microphone (abbreviated as “Mic”), speaker/buzzer (abbreviated as “Buzz”), LED indicators (abbreviated as “LED”), Bluetooth transceiver (abbreviated as “BLE”), ultra-wideband transceiver (abbreviated as “UWB”), passive infrared motion sensor (abbreviated as “PIR”), radar sensor, accelerometer (abbreviated as “acc”), and pressure sensor (abbreviated as “Press”)) are listed as row headers 2201, and the same corresponding elements are listed as Victim devices in column headers 2202. A diagonal line of dotted cells such as 2203 corresponds to a comparison of each element to itself, which can be ignored. Other cells can store a quantifier and/or a qualifier representing the interference (or interference potential) between the corresponding Aggressor device and Victim device, such as a designation of a low potential (“L”) in a cell 2204, a nonexistent potential (“NC” or Not Care) that can be designated for a pairing that is already optimized as depicted in a cell 2205, and a high potential (“H”) in a cell 2206. The designation can include a value. The value can be a relative value or an absolute value.

In some embodiments, the coexistence matrix is informative as to interfering modules (e.g., devices) and/or facilitates development of actionable insights that can be used to reduce interference (e.g., by scheduled operation and placement of a module in an environment) and to map an interfering property in an environment by using the interfering property. In some embodiments, pairings of modules that may have an actionable level of potential interference include: (i) pressure sensor and humidity sensors, (ii) a microphone and a buzzer, (iii) a temperature sensor and an IR-based CO₂ sensor, (iv) an LED module (e.g., indicator) and a photosensor, and/or (v) an accelerometer and a buzzer. For example, some sensors may generate heat and have a heat signature during operation. The heat signature of another sensor can affect a reading accuracy of a proximate temperature sensor. For example, some sensors may draw a certain amount of current in order to function. If two sensors are connected to the same power source, current draw of one sensor can affect proper functioning of the other sensor, e.g., by restricting how much current the other sensor can be drawn. In another example, a microphone can be used to record sound levels, while a buzzer can be used to emit a tone for alerts. In some circumstances it is not optimal to operate the microphone and the buzzer simultaneously (e.g., and in close proximity), as the buzzer's noise will skew accurate noise determination by the microphone. The device ensemble may comprise a messaging light (e.g., LED such as a tricolor LED). The messaging light may have a visible color range and/or pulsation frequency designated for a message. For example: (a) a blue color may designate normal operation, (b) a green color may designate that good data is being sent, (c) red may designate that the data is bad, the data transmission is bad, and/or that the device is otherwise defective. Good data may comprise calibrated, within normal range, and/or non-corrupt data. Bad data may comprise non-calibrated, out of normal data range, and/or corrupted data. Bad data transmission may comprise interrupted transmission, infected data, data suspected with malicious manipulation, or interrupted transmission. The device may comprise a sensor or a device ensemble (e.g., comprising, sensors, a sensor and an emitter, or a transceiver).

In some embodiments, a processing system includes a plurality of elements embodying sensors and/or emitters for which a coexistence matrix has been constructed. At least two of the plurality of elements can be disposed in an ensemble. There can be one or more ensembles operatively (e.g., communicatively) coupled to, or a part of, the control system and/or processing system. In some embodiments, the control system and/or processing system can mitigate (e.g., substantially eliminate, measurably eliminate, or eliminate) interference. Mitigation of interference may comprise scheduling operation of various elements such that an Aggressor having a predetermined potential for interference on a particular Victim does not overlap in operation time (e.g., operate simultaneously) with that Victim. A controller (e.g., coexistence controller) can include, and/or may be coupled to, a scheduler for operating the devices (e.g., sensors and/or emitters). The devices may include elements in one or more assemblies interconnected within a processing system and/or control system. The scheduling can be manually and/or automatically determined, e.g., according to (a) a system layout in a memory block and/or (b) a coexistence matrix block in a memory. The system layout can provide information regarding (i) the elements in particular assemblies, and/or (ii) the relative and/or absolute positioning (e.g., separation distance) of the elements. The position may be relative to, and/or in, an enclosure (e.g., facility, building, or room). In some embodiments (e.g., using predetermined rules) the scheduler can establish coordinated time windows for operation of various devices (e.g., sensors and/or emitters) according to the relationships characterized in the coexistence matrix. The operation may include intermittent, scheduled (e.g., pre-scheduled), occasional, repetitive, sporadic, and/or random operation. The operation may comprise non-simultaneous, simultaneous, or consecutive operation. The rules may comprise usage of learning analysis (e.g., artificial intelligence) performed in at least one learning block. At least one sharing control block may coordinate data processing tasks among various (e.g., different) computing devices and/or controllers (e.g., in the same or in different assemblies). The coordination may be in one or more ways that minimize (e.g., avoid) interfering operation (e.g., which may result from power drain or electromagnetic interference (EMI) in an assembly). For example, a sharing control block may coordinate sharing of sensor data from one ensemble to another, e.g., so that a receiving assembly need not operate its corresponding sensor at all. For example, data from a CO₂ sensor in one assembly could be shared with other assemblies in a same room since there would be little (if any) variation in the measured values, (e.g., without wishing to be bound to theory, due to gas diffusion). This would facilitate reducing (e.g., avoiding) potential interference conditions in a receiving assembly.

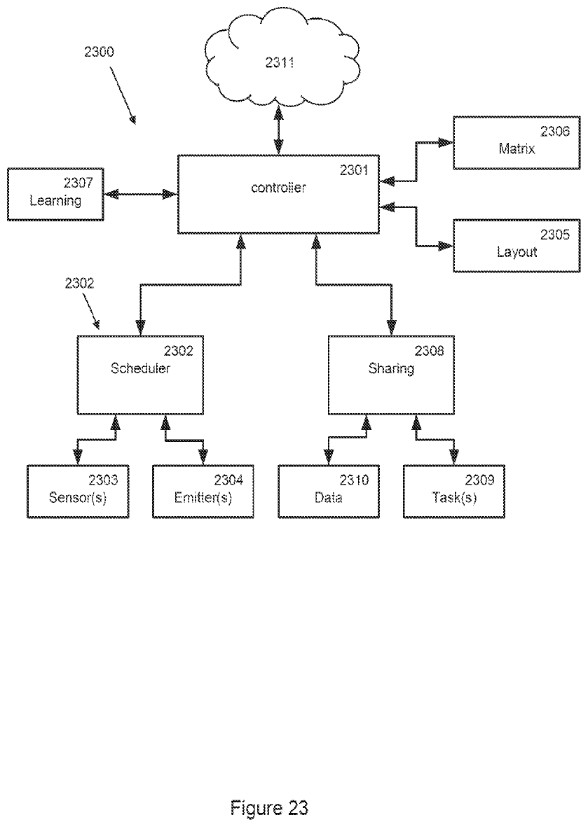

FIG. 23 shows an example of a processing system 2300 (comprising a controller 2301) including various processors, elements, and memory blocks. FIG. 23 shows an example of a learning module 2307, a controller 2301 communicatively coupled to the cloud 2311, a coexistence matrix 2306 in a memory block, a system layout 2305 in a memory block, a scheduler 2302 control block. The control block may be utilized for operating the devices (e.g., emitter(s) and/or sensor(s)), a sharing 2308 control block, sensor(s) 2303, emitter(s) 2304, element (e.g., sensor) data 2310 memory block, and/or task(s) 2309 memory block. Double arrows shown in FIG. 23 designate bidirectional communication between the different blocks in system 2300.

In some embodiments, the coexistence controller function is implemented as a shared process (e.g., in a master node and/or an intermediate (floor or network) controller). The shared process can direct scheduling and/or data sharing among a plurality of assemblies deployed within an enclosure and/or among a plurality of enclosures. Each assembly may provide a respective node within an interlinked processing and/or control system.

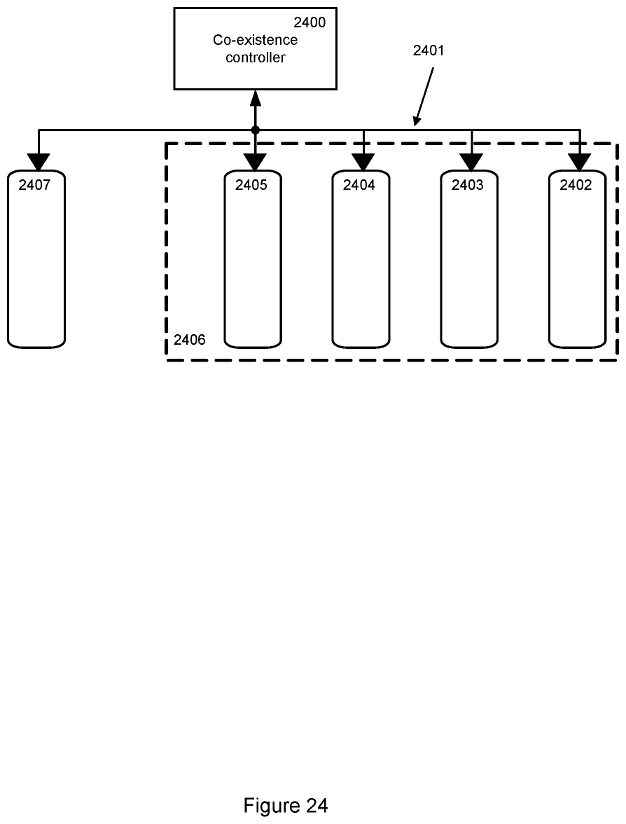

FIG. 24 shows an example of a coexistence controller 2400 connected by a network link 2401 to a plurality of assemblies 2402, 2403, 2404, 2405, and 2407. Assemblies 2402-2405 are deployed within a space 2406 of an enclosure (e.g., a conference room in an office building) such that they may have a close proximity which raises the chance for interference potentials as characterized in a respective coexistence matrix derived for each (e.g., inter and/or intra assembly). An assembly 2407 is located outside space 2406 and may be subject to potential interference internally and/or externally with assemblies 2402-2405.

In some embodiments, a controller manages the coexistence of devices. For example, a control process for managing coexistence of potentially interfering modules (e.g., devices) may begin with the coexistence controller enumerating (e.g., identifying) the devices (e.g., sensors, emitters, and/or other modules) that are present at the nodes in an interconnected system. At least one coexistence matrix is identified, which characterizes potential interference relationships within an assembly and/or between assemblies (e.g., that sense each other such as assemblies in proximity). For example, a buzzer in a first assembly disposed in a first enclosure can emit sound that propagates though fixture(s) to a second enclosure in which a second assembly is located, which second assembly has a sound sensor that can sense the sound emitted by the buzzer. In some embodiments, the coexistence matrix is produced in advance according to a particular design of an assembly. In some embodiments, the coexistence matrix is produced automatically in a (e.g., coexistence) controller in response to enumerating the modules (e.g., sensors and emitters) in the assemblies using predetermined data characterizing interference potentials between various modules. Based at least in part on the interference potentials for the enumerated modules (e.g., devices), activations and/or deactivations can be scheduled, e.g., by establishing coordinated time windows for operation of various devices (e.g., according to the relationships characterized in the coexistence matrix). The operation may include intermittent, scheduled (e.g., pre-scheduled), occasional, repetitive, sporadic, and/or random operation. The operation may comprise non-simultaneous, simultaneous, or consecutive operation.

In some embodiments, decisions are made regarding operations of devices. For example, decisions regarding operation of modules to measure, emit, and/or alter an environmental property (e.g., characteristic) can be made in the cloud and/or at the module level (e.g., by a coexistence controller using the processor and/or controller of the module). For example, at least about 90%, 70%, 50%, 30% or 10% of the decisions can be made on the module (e.g., on the device, rather than in a processor and/or controller remote from the ensemble such as in cloud). In some embodiments, parameter scaling is used in order to identify available computing power (e.g., of idle modules) that is free to allocate. Once a first module is measuring, and a second module is not (e.g., is in an idle or non-functioning mode), the second module can process the information obtained by the first module. Likewise, additional processor(s) can be grouped for computing tasks when the modules containing them are not active for other purposes. For example, when an enclosure (e.g., room) is empty, then all processors located assembly units (e.g., nodes) in the enclosure can be allocated for other computing tasks. When an occupant enters the room, the occupant (e.g., and/or any activity of the occupant) can be tracked by a device of the assembly (e.g., by a radar) and those modules needed to record data on the occupant are used, while the remainder of the capacity of the processor(s) and/or controller(s) can be used for other tasks. In some embodiments, this arrangement is dynamic as the occupant moves in the enclosure.

In some embodiments, actionable insights for a building management system (BMS) can use data from one or more module types (e.g., various sensors). Scheduling by the coexistence controller and/or processor may control operation of interfering sensors, e.g., by separating the sensors from the emitter of the sensed property and listening to each other. For example, a first kind of sensor may be activated while an interfering first kind of emitter is deactivated in one ensemble disposed in a first assembly unit, while the first kind (e.g., type) of sensor is deactivated and the related (e.g., corresponding) first kind of emitter is activated in a second ensemble disposed in a second assembly unit.

In some embodiments, performance of the sensor and/or emitter modules are monitored for malfunction. The malfunction may arise at least in part due to interference and/or to detect changes in the sensed environment. A future environment can be predicted. Based at least in part on predictions, actionable items associated with one or more future conditions can be identified, and remedies can be implemented and/or offered to a user. For example, a revised scheduling of temperature sensing modules may be used in order to better monitor a temperature at a location where people are gathering. For example, a sensor module in one assembly may be deactivated, e.g., if the sensor module is predicted to fail while activating a corresponding sensor module in a different, nearby assembly. For example, measured properties can be used to create a 3D map of the space. The properties may be acoustic, light, environmental (e.g., temperature, venting), and states of building assets (e.g., doors and/or windows). Performance of each sensor can be mapped as a function of time. The mapped data can be used for conformation, and/or for prediction (e.g., taking preventive and/or proactive actions).

FIG. 25 shows an example method wherein devices (e.g., sensors, emitters, and other modules) are enumerated at operation 2500. A coexistence matrix is used to identify any interference potential at operation 2501. Activations and/or deactivations of any identified interfering and/or potentially interfering elements are scheduled at 2502. Monitoring and/or mapping of the environment occurs at 2503 for property (e.g., environmental characteristic) associated with the interfering or potentially interfering device(s). At 2504, a future environment is predicted for the property in an enclosure, actionable items are detected, and/or remedies are taken and/or offered.

In some embodiments, the coexistence processor and/or controller distinguishes measured properties that require monitoring and others that do not. The monitoring may be constant, intermittent, scheduled, sporadic, or random. Parameter(s) for constant, intermittent, or scheduled module operation can include CO₂, VOCs, occupancy, and lighting. Other parameters change more slowly as compared to these modes of operations that include CO₂, VOCs, occupancy, and lighting. More slowly can be on the order of tens of minutes to hours. Real time data collection (e.g., by the sensors) may not be required continuously. The coexistence controller and/or processor may, for example, control operation of the modules requiring intermittent operation using a scheduler, e.g., to minimize (e.g., avoid) their simultaneous operation.

In some embodiments, the coexistence controller and/or processor coordinates operation between separate assembly units (nodes). Information from a first assembly related to at least one first sensor can be shared with at least one second sensor of the second assembly (and/or with the local controller and/or processor of the second assembly). In this manner the first assembly can collaborate with the second assembly. For example, information from the first assembly related to the CO₂ sensor can be shared with the CO₂ sensor of the second assembly (and/or with the local controller of the second assembly). In this manner the two CO₂ sensors can collaborate. When coverage range of a sensor in one assembly (e.g., CO₂ sensor) encompasses another assembly, a matching sensor type in second assembly can be deactivated to prevent interference. If requested, sensor measurement from the first assembly can be shared with the second assembly.

In some embodiments, the role of the coexistence controller and/or processor can be assigned to a node from among a plurality of nodes in a processing system. For example, containerized applications including tasks associated with the coexistence controller can be managed within a clustered environment using an orchestration system. Hosted services (e.g., applications) can be distributed and run to provide load balancing and can be redistributed in the event that resources (e.g., nodes) malfunction or are lost. In some embodiments, nodes are preconfigured to perform a process in which one assembly unit (e.g., node) is selected to assume the role of master coexistence controller and other assembly units assume the role of slaves. While the node selected as the master coexistence controller manages coexistence functions, the preconfigured process may continue to monitor for scheduling or other operations of the coexistence tasks. If the coexistence tasks (e.g., scheduling) cease to be detected, then the assignment of the role of master coexistence controller can be reassigned to a different assembly unit. Any particular node can be turned into master and/or slave using UWB signals, for example.

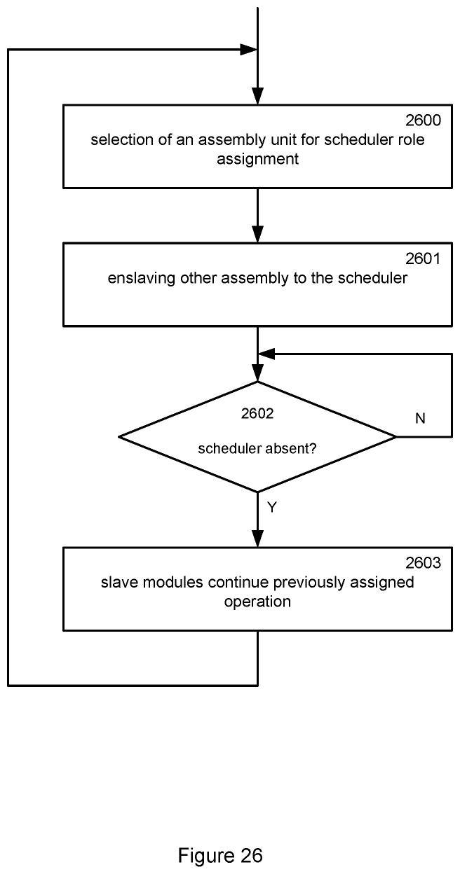

FIG. 26 shows an example of a process in which an assembly unit is selected to fulfill the role of coexistence scheduler in block 2600. Other assembly units in a processing system are assigned the role of slaves of the assigned coexistence scheduler in block 1601. Monitoring for activities of coexistence scheduler is performed in block 2602. As long as the coexistence scheduler is detected not to be absent, then monitoring continues. If the scheduler is found to be absent in this example, the slave assembly units (e.g., nodes) continue according to their previously assigned operation (e.g., schedules) in block 2603 and then a return is made to block 2600 in order to select another assembly unit for the role of coexistence scheduler.

In some embodiments, the consolidated assembly unit includes a controller. The controller may monitor and/or direct (e.g., physical) alteration of the operating conditions of the apparatuses, software, and/or methods described herein. Control may comprise regulate, manipulate, restrict, direct, monitor, adjust, modulate, vary, alter, restrain, check, guide, or manage. Controlled (e.g., by a controller) may include attenuated, modulated, varied, managed, curbed, disciplined, regulated, restrained, supervised, manipulated, and/or guided. The control may comprise controlling a control variable (e.g., temperature, power, voltage, and/or profile). The control can comprise real time or off-line control. A calculation utilized by the controller can be done in real time, and/or offline. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from at least one sensor). The controller may deliver an output. The controller may comprise multiple (e.g., sub-) controllers. The controller may be a part of a control system. The control system may comprise a master controller, floor controller, local controller (e.g., enclosure controller, or window controller). The controller may receive one or more inputs. The controller may generate one or more outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may comprise a user interface. The user interface may comprise (or operatively coupled to) a keyboard, keypad, mouse, touch screen, microphone, speech recognition package, camera, imaging system, or any combination thereof. The outputs may include a display (e.g., screen), speaker, or printer.

The methods, systems, and/or the apparatus described herein may comprise a control system. The control system can be in communication with any of the apparatuses (e.g., sensors) described herein. The sensors may be of the same type or of different types, e.g., as described herein. For example, the control system may be in communication with the first sensor and/or with the second sensor. The control system may control the one or more sensors. The control system may control one or more components of a building management system (e.g., lightening, security, and/or air conditioning system). The controller may regulate at least one (e.g., environmental) characteristic of the enclosure. The control system may regulate the enclosure environment using any component of the building management system. For example, the control system may regulate the energy supplied by a heating element and/or by a cooling element. For example, the control system may regulate velocity of an air flowing through a vent to and/or from the enclosure. The control system may comprise a processor. The processor may be a processing unit. The controller may comprise a processing unit. The processing unit may be central. The processing unit may comprise a central processing unit (abbreviated herein as “CPU”). The processing unit may be a graphic processing unit (abbreviated herein as “GPU”). The controller(s) or control mechanisms (e.g., comprising a computer system) may be programmed to implement one or more methods of the disclosure. The processor may be programmed to implement methods of the disclosure. The controller may control at least one component of the forming systems and/or apparatuses disclosed herein.

The computer system that is programmed or otherwise configured to one or more operations of any of the methods provided herein can control (e.g., direct, monitor, and/or regulate) various features of the methods, apparatuses and systems of the present disclosure, such as, for example, control heating, cooling, lightening, and/or venting of an enclosure, or any combination thereof. The computer system can be part of, or be in communication with, any sensor or sensor ensemble disclosed herein. The computer may be coupled to one or more mechanisms disclosed herein, and/or any parts thereof. For example, the computer may be coupled to one or more sensors, valves, switches, lights, windows (e.g., IGUs), motors, pumps, optical components, or any combination thereof.

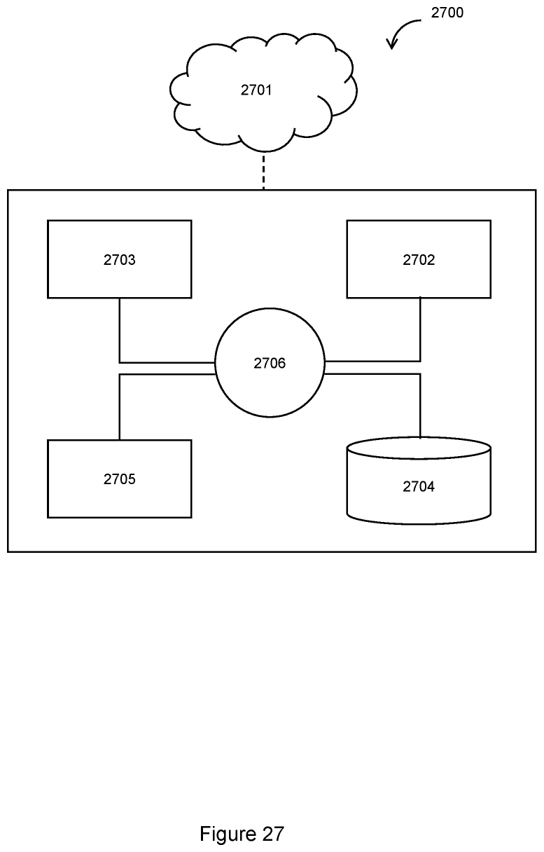

FIG. 27 shows a schematic example of a computer system 2700 that is programmed or otherwise configured to one or more operations of any of the methods provided herein. The computer system can include a processing unit (e.g., 2706) (also “processor,” “computer” and “computer processor” used herein). The computer system may include memory or memory location (e.g., 2702) (e.g., random-access memory, read-only memory, flash memory), electronic storage unit (e.g., 2704) (e.g., hard disk), communication interface (e.g., 2703) (e.g., network adapter) for communicating with one or more other systems, and peripheral devices (e.g., 2705), such as cache, other memory, data storage and/or electronic display adapters. In the example shown in FIG. 27, the memory 2702, storage unit 2704, interface 2703, and peripheral devices 2705 are in communication with the processing unit 2706 through a communication bus (solid lines), such as a motherboard. The storage unit can be a data storage unit (or data repository) for storing data. The computer system can be operatively coupled to a computer network (“network”) (e.g., 2701) with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The processing unit can execute a sequence of machine-readable instructions, which can be embodied in a program or software. The instructions may be stored in a memory location, such as the memory 2702. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 2700 can be included in the circuit.

The storage unit can store files, such as drivers, libraries and saved programs. The storage unit can store user data (e.g., user preferences and user programs). In some cases, the computer system can include one or more additional data storage units that are external to the computer system, such as located on a remote server that is in communication with the computer system through an intranet or the Internet.

The computer system can communicate with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. A user (e.g., client) can access the computer system via the network.

Methods as described herein can be implemented by way of machine (e.g., computer processor) executable code stored on an electronic storage location of the computer system, such as, for example, on the memory 2702 or electronic storage unit 2704. The machine executable or machine-readable code can be provided in the form of software. During use, the processor 2706 can execute the code. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine have a processer adapted to execute the code or can be compiled during runtime. The code can be supplied in a programming language that can be selected to enable the code to execute in a pre-compiled or as-compiled fashion.

In some embodiments, the processor comprises a code. The code can be program instructions. The program instructions may cause the at least one processor (e.g., computer) to direct a feed forward and/or feedback control loop. In some embodiments, the program instructions cause the at least one processor to direct a closed loop and/or open loop control scheme. The control may be based at least in part on one or more sensor readings (e.g., sensor data). One controller may direct a plurality of operations. At least two operations may be directed by different controllers. In some embodiments, a different controller may direct at least two of operations (a), (b) and (c). In some embodiments, different controllers may direct at least two of operations (a), (b) and (c). In some embodiments, a non-transitory computer-readable medium cause each a different computer to direct at least two of operations (a), (b) and (c). In some embodiments, different non-transitory computer-readable mediums cause each a different computer to direct at least two of operations (a), (b) and (c). The controller and/or computer readable media may direct any of the apparatuses or components thereof disclosed herein. The controller and/or computer readable media may direct any operations of the methods disclosed herein.

In some embodiments, a tintable window exhibits a (e.g., controllable and/or reversible) change in at least one optical property of the window, e.g., when a stimulus is applied. The stimulus can include an optical, electrical and/or magnetic stimulus. For example, the stimulus can include an applied voltage. One or more tintable windows can be used to control lighting and/or glare conditions, e.g., by regulating the transmission of solar energy propagating through them. One or more tintable windows can be used to control a temperature within a building, e.g., by regulating the transmission of solar energy propagating through them. Control of the solar energy may control heat load imposed on the interior of the facility (e.g., building). The control may be manual and/or automatic. The control may be used for maintaining one or more requested (e.g., environmental) conditions, e.g., occupant comfort. The control may include reducing energy consumption of a heating, ventilation, air conditioning and/or lighting systems. At least two of heating, ventilation, and air conditioning may be induced by separate systems. At least two of heating, ventilation, and air conditioning may be induced by one system. The heating, ventilation, and air conditioning may be induced by a single system (abbreviated herein as “HVAC). In some cases, tintable windows may be responsive to (e.g., and communicatively coupled to) one or more environmental sensors and/or user control. Tintable windows may comprise (e.g., may be) electrochromic windows. The windows may be located in the range from the interior to the exterior of a structure (e.g., facility, e.g., building). However, this need not be the case. Tintable windows may operate using liquid crystal devices, suspended particle devices, microelectromechanical systems (MEMS) devices (such as microshutters), or any technology known now, or later developed, that is configured to control light transmission through a window. Windows (e.g., with MEMS devices for tinting) are described in U.S. patent application Ser. No. 14/443,353, filed May 15, 2015, titled “MULTI-PANE WINDOWS INCLUDING ELECTROCHROMIC DEVICES AND ELECTROMECHANICAL SYSTEMS DEVICES,” that is incorporated herein by reference in its entirety. In some cases, one or more tintable windows can be located within the interior of a building, e.g., between a conference room and a hallway. In some cases, one or more tintable windows can be used in automobiles, trains, aircraft, and other vehicles, e.g., in lieu of a passive and/or non-tinting window.

In some embodiments, the tintable window comprises an electrochromic device (referred to herein as an “EC device” (abbreviated herein as ECD), or “EC”). An EC device may comprise at least one coating that includes at least one layer. The at least one layer can comprise an electrochromic material. In some embodiments, the electrochromic material exhibits a change from one optical state to another, e.g., when an electric potential is applied across the EC device. The transition of the electrochromic layer from one optical state to another optical state can be caused, e.g., by reversible, semi-reversible, or irreversible ion insertion into the electrochromic material (e.g., by way of intercalation) and a corresponding injection of charge-balancing electrons. For example, the transition of the electrochromic layer from one optical state to another optical state can be caused, e.g., by a reversible ion insertion into the electrochromic material (e.g., by way of intercalation) and a corresponding injection of charge-balancing electrons. Reversible may be for the expected lifetime of the ECD. Semi-reversible refers to a measurable (e.g., noticeable) degradation in the reversibility of the tint of the window over one or more tinting cycles. In some instances, a fraction of the ions responsible for the optical transition is irreversibly bound up in the electrochromic material (e.g., and thus the induced (altered) tint state of the window is not reversible to its original tinting state). In various EC devices, at least some (e.g., all) of the irreversibly bound ions can be used to compensate for “blind charge” in the material (e.g., ECD).

In some implementations, suitable ions include cations. The cations may include lithium ions (Li+) and/or hydrogen ions (H+) (e.g., protons). In some implementations, other ions can be suitable. Intercalation of the cations may be into an (e.g., metal) oxide. A change in the intercalation state of the ions (e.g., cations) into the oxide may induce a visible change in a tint (e.g., color) of the oxide. For example, the oxide may transition from a colorless to a colored state. For example, intercalation of lithium ions into tungsten oxide (WO3-y (0<≤˜0.3)) may cause the tungsten oxide to change from a transparent state to a colored (e.g., blue) state. EC device coatings as described herein are located within the viewable portion of the tintable window such that the tinting of the EC device coating can be used to control the optical state of the tintable window.

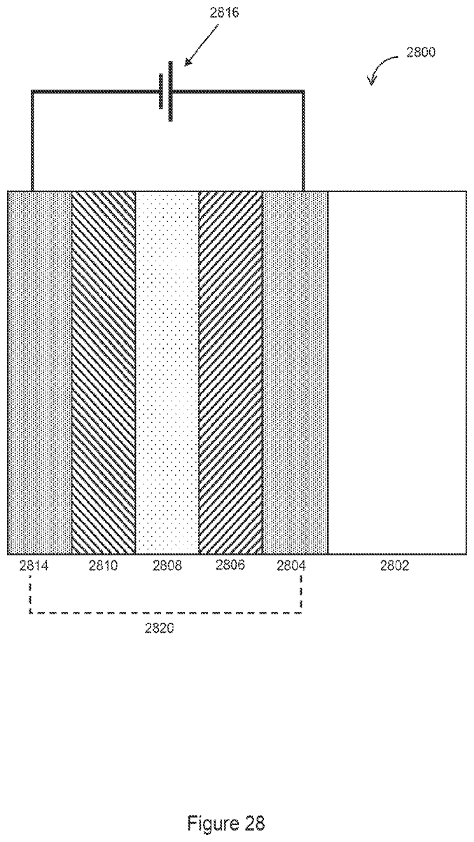

FIG. 28 shows an example of a schematic cross-section of an electrochromic device 2800 in accordance with some embodiments. The EC device coating is attached to a substrate 2802, a transparent conductive layer (TCL) 2804, an electrochromic layer (EC) 2806 (sometimes also referred to as a cathodically coloring layer or a cathodically tinting layer), an ion conducting layer or region (IC) 2808, a counter electrode layer (CE) 2810 (sometimes also referred to as an anodically coloring layer or anodically tinting layer), and a second TCL 2814.

Elements 2804, 2806, 2808, 2810, and 2814 are collectively referred to as an electrochromic stack 2820. A voltage source 2816 operable to apply an electric potential across the electrochromic stack 2820 effects the transition of the electrochromic coating from, e.g., a clear state to a tinted state. In other embodiments, the order of layers is reversed with respect to the substrate. That is, the layers are in the following order: substrate, TCL, counter electrode layer, ion conducting layer, electrochromic material layer, TCL.

In various embodiments, the ion conductor region (e.g., 2808) may form from a portion of the EC layer (e.g., 2806) and/or from a portion of the CE layer (e.g., 2810). In such embodiments, the electrochromic stack (e.g., 2820) may be deposited to include cathodically coloring electrochromic material (the EC layer) in direct physical contact with an anodically coloring counter electrode material (the CE layer). The ion conductor region (sometimes referred to as an interfacial region, or as an ion conducting substantially electronically insulating layer or region) may form where the EC layer and the CE layer meet, for example through heating and/or other processing steps. Examples of electrochromic devices (e.g., including those fabricated without depositing a distinct ion conductor material) can be found in U.S. patent application Ser. No. 13/462,725, filed May 2, 2012, titled “ELECTROCHROMIC DEVICES,” that is incorporated herein by reference in its entirety. In some embodiments, an EC device coating may include one or more additional layers such as one or more passive layers. Passive layers can be used to improve certain optical properties, to provide moisture, and/or to provide scratch resistance. These and/or other passive layers can serve to hermetically seal the EC stack 2820. Various layers, including transparent conducting layers (such as 2804 and 2814), can be treated with anti-reflective and/or protective layers (e.g., oxide and/or nitride layers).

In certain embodiments, the electrochromic device is configured to (e.g., substantially) reversibly cycle between a clear state and a tinted state. Reversible may be within an expected lifetime of the ECD. The expected lifetime can be at least about 5, 10, 15, 25, 50, 75, or 100 years. The expected lifetime can be any value between the aforementioned values (e.g., from about 5 years to about 100 years, from about 5 years to about 50 years, or from about 50 years to about 100 years). A potential can be applied to the electrochromic stack (e.g., 2820) such that available ions in the stack that can cause the electrochromic material (e.g., 2806) to be in the tinted state reside primarily in the counter electrode (e.g., 2810) when the window is in a first tint state (e.g., clear). When the potential applied to the electrochromic stack is reversed, the ions can be transported across the ion conducting layer (e.g., 2808) to the electrochromic material and cause the material to enter the second tint state (e.g., tinted state).

It should be understood that the reference to a transition between a clear state and tinted state is non-limiting and suggests only one example, among many, of an electrochromic transition that may be implemented. Unless otherwise specified herein, whenever reference is made to a clear-tinted transition, the corresponding device or process encompasses other optical state transitions such as non-reflective-reflective, and/or transparent-opaque. In some embodiments, the terms “clear” and “bleached” refer to an optically neutral state, e.g., un-tinted, transparent and/or translucent. In some embodiments, the “color” or “tint” of an electrochromic transition is not limited to any wavelength or range of wavelengths. The choice of appropriate electrochromic material and counter electrode materials may govern the relevant optical transition (e.g., from tinted to un-tinted state).

In certain embodiments, at least a portion (e.g., all of) the materials making up electrochromic stack are inorganic, solid (e.g., in the solid state), or both inorganic and solid. Because various organic materials tend to degrade over time, particularly when exposed to heat and UV light as tinted building windows are, inorganic materials offer an advantage of a reliable electrochromic stack that can function for extended periods of time. In some embodiments, materials in the solid state can offer the advantage of being minimally contaminated and minimizing leakage issues, as materials in the liquid state sometimes do. One or more of the layers in the stack may contain some amount of organic material (e.g., that is measurable). The ECD or any portion thereof (e.g., one or more of the layers) may contain little or no measurable organic matter. The ECD or any portion thereof (e.g., one or more of the layers) may contain one or more liquids that may be present in little amounts. Little may be of at most about 100 ppm, 10 ppm, or 1 ppm of the ECD. Solid state material may be deposited (or otherwise formed) using one or more processes employing liquid components, such as certain processes employing sol-gels, physical vapor deposition, and/or chemical vapor deposition.

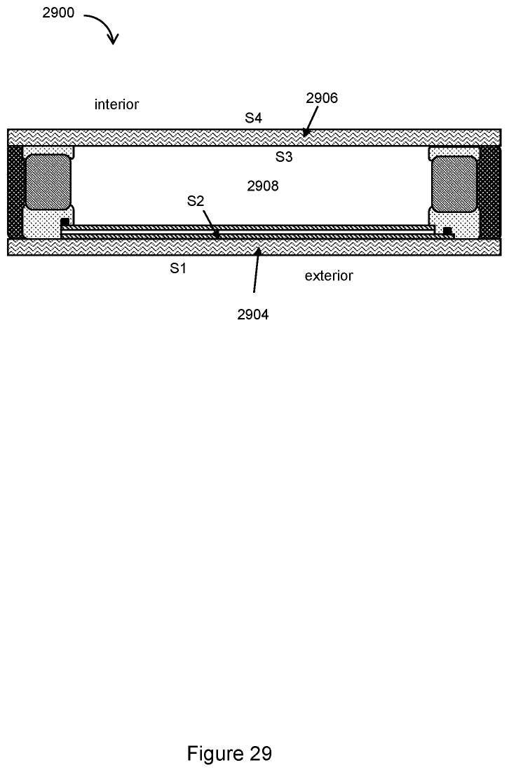

FIG. 29 shows an example of a cross-sectional view of a tintable window embodied in an insulated glass unit (“IGU”) 2900, in accordance with some implementations. The terms “IGU,” “tintable window,” and “optically switchable window” can be used interchangeably herein. It can be desirable to have IGUs serve as the fundamental constructs for holding electrochromic panes (also referred to herein as “lites”) when provided for installation in a building. An IGU lite may be a single substrate or a multi-substrate construct. The lite may comprise a laminate, e.g., of two substrates. IGUs (e.g., having double- or triple-pane configurations) can provide a number of advantages over single pane configurations. For example, multi-pane configurations can provide enhanced thermal insulation, noise insulation, environmental protection and/or durability, when compared with single-pane configurations. A multi-pane configuration can provide increased protection for an ECD. For example, the electrochromic films (e.g., as well as associated layers and conductive interconnects) can be formed on an interior surface of the multi-pane IGU and be protected by an inert gas fill in the interior volume (e.g., 2908) of the IGU. The inert gas fill may provide at least some (heat) insulating function for an IGU. Electrochromic IGUs may have heat blocking capability, e.g., by virtue of a tintable coating that absorbs (and/or reflects) heat and light.

In some embodiments, an “IGU” includes two (or more) substantially transparent substrates. For example, the IGU may include two panes of glass. At least one substrate of the IGU can include an electrochromic device disposed thereon. The one or more panes of the IGU may have a separator disposed between them. An IGU can be a hermetically sealed construct, e.g., having an interior region that is isolated from the ambient environment. A “window assembly” may include an IGU. A “window assembly” may include a (e.g., stand-alone) laminate. A “window assembly” may include one or more electrical leads, e.g., for connecting the IGUs and/or laminates. The electrical leads may operatively couple (e.g., connect) one or more electrochromic devices to a voltage source, switches and the like, and may include a frame that supports the IGU or laminate. A window assembly may include a window controller, and/or components of a window controller (e.g., a dock).

FIG. 29 shows an example implementation of an IGU 2900 that includes a first pane 2904 having a first surface S1 and a second surface S2. In some implementations, the first surface S1 of the first pane 2904 faces an exterior environment, such as an outdoors or outside environment. The IGU 2900 also includes a second pane 2906 having a first surface S3 and a second surface S4. In some implementations, the second surface (e.g., S4) of the second pane (e.g., 2906) faces an interior environment, such as an inside environment of a home, building, vehicle, or compartment thereof (e.g., an enclosure therein such as a room).

In some implementations, the first and the second panes (e.g., 2904 and 2906) are transparent or translucent, e.g., at least to light in the visible spectrum. For example, each of the panes (e.g., 2904 and 2906) can be formed of a glass material. The glass material may include architectural glass, and/or shatter-resistant glass. The glass may comprise a silicon oxide (SO_{X}). The glass may comprise a soda-lime glass or float glass. The glass may comprise at least about 75% silica (SiO₂). The glass may comprise oxides such as Na₂O, or CaO. The glass may comprise alkali or alkali-earth oxides. The glass may comprise one or more additives. The first and/or the second panes can include any material having suitable optical, electrical, thermal, and/or mechanical properties. Other materials (e.g., substrates) that can be included in the first and/or the second panes are plastic, semi-plastic and/or thermoplastic materials, for example, poly(methyl methacrylate), polystyrene, polycarbonate, allyl diglycol carbonate, SAN (styrene acrylonitrile copolymer), poly(4-methyl-1-pentene), polyester, and/or polyamide. The first and/or second pane may include mirror material (e.g., silver). In some implementations, the first and/or the second panes can be strengthened. The strengthening may include tempering, heating, and/or chemically strengthening.

In some embodiments, a device ensemble comprises a plurality of devices operatively coupled to one or more circuit boards, enclosed in a housing, e.g., as disclosed herein (e.g., see FIGS. 9, 10A and 10B). There may be various types of housings, circuit board, and device set configurations. The housings may be dedicated to one or more sensed property. The device ensemble may comprise a processor, accelerometer, network adapter, socket, plug, memory, geo-location technology, or a circuity board, e.g., regardless of the designated property(ies) the device ensemble is designated to sense. For example, a device ensemble dedicated for sensing pulverous material may comprise processor (e.g., GPU), accelerometer, network adapter, socket, plug, memory, geo-location technology, and a circuity board. For example, a device ensemble dedicated for sensing IR and/or visual image (e.g., using a camera) may comprise processor (e.g., GPU), accelerometer, network adapter, socket, plug, memory, geo-location technology, and circuity board(s). For example, a device ensemble dedicated for sensing IR humidity, carbon dioxide, pressure, and temperature, may comprise processors (e.g., GPU and/or CPU), accelerometer, network adapter, socket, plug, memory, geo-location technology, and circuity board(s).

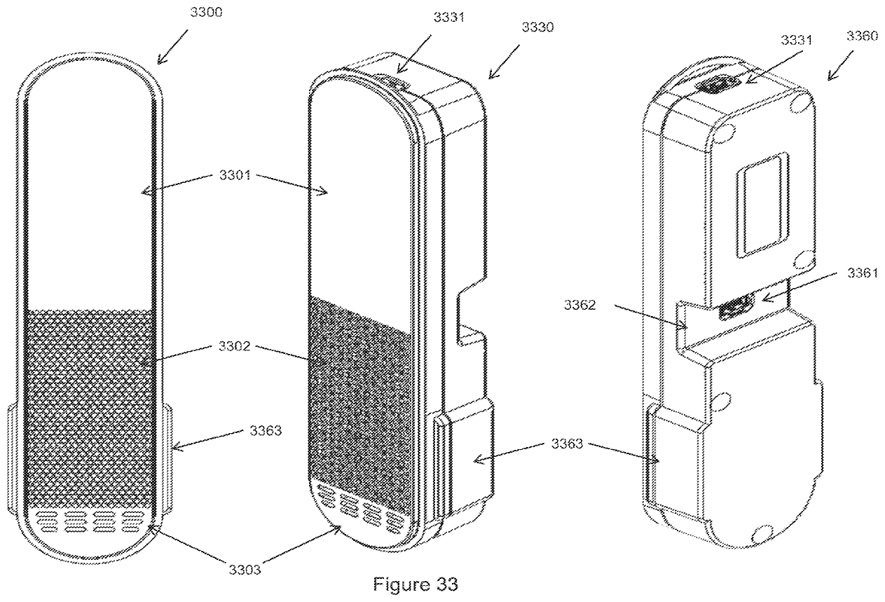

FIG. 33 shows an example of an assembly housing shown as front view 3300, front perspective view 3330, and back perspective view 3360. The device housing is configured to facilitate connection to a sockets 3331 and 3361. The housing comprises a non-patterned frontal section 3301 (e.g., a smooth, flat, lower Ra value section), and a frontal section 3302 having a pattered (e.g., a rough, patterned, higher Ra value section). The housing may comprise a depression configured to mount on a fixture. The housing may have an expansion 3363 configured to facilitate incorporation of a module (e.g., geo-location module) in the device ensemble. The housing comprises a plurality of holes 3303. The plurality of holes may facilitate suction of the external atmosphere (e.g., air) into the device ensemble housing, e.g., to facilitate sensing the atmospheric components (e.g., particulate matter). The plurality of holes may facilitate exchange of atmosphere between the interior of the sensor ensemble and the external atmosphere. The atmospheric exchange can be passive or active. For example, one or more holes can serve as suction holes and one or more holes can server as exhaust holes. In the example shown in FIG. 33, the holes are arranged in four columns of three holes. One or more (e.g., two) of the hole columns can serve as suction holes configured to suck atmosphere from the enclosure into the device housing (e.g., to facilitate sensing by the sensor), and one or more (e.g., two) of the hole columns can serve as exhaust holes configured to expel atmosphere from the device housing back into the enclosure atmosphere. At least two of the plurality of columns dedicated to an active function (e.g., suction or expulsion) may be disposed immediately adjacent to each other (e.g., without an intervening hole column in between). At least two of the plurality of columns dedicated to an active function (e.g., suction) may be disposed adjacent to each other and separated by one or more hole columns dedicated to an opposition active function (e.g., expulsion). The holes dedicated to each function (e.g., suction or expulsion) are grouped (e.g., huddled) together. The groups of holes dedicated for one active function (e.g., suction) may be separated by a gap from the group dedicated for the opposing active function (e.g., expulsion). The length of the gap may minimize mixing of air expelled with air sucked into the device ensemble. In some embodiments, suction of the atmosphere is performed at a first time, and expulsion of the atmosphere from the device ensemble is performed at a second time different from the first time. The first time may be separated from the second time by a time gap. The time gap may minimize mixing of air expelled with air sucked into the device ensemble. Active expulsion and suction of the atmosphere may be facilitated by an actuator (e.g., motor).

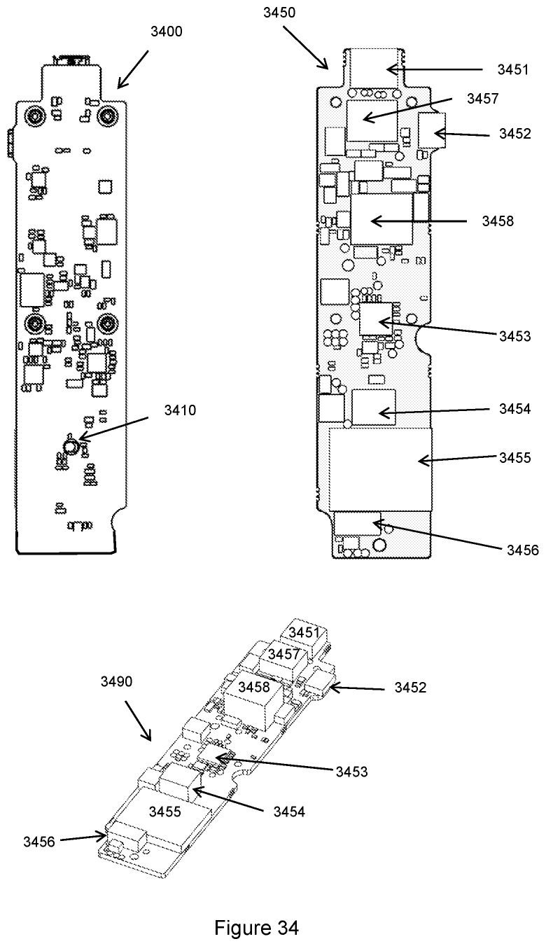

FIG. 34 shows example layouts of modules on a circuit board. A frontal side of a circuit board housed in housing shown in FIG. 33, is shown in 3400, which is configured to face a user once the device ensemble housing in affixed to a fixture in the room in which the user is disposed. The circuit board can include a processor, sensor, transceiver, and/or emitters. For example, 3410 is an emitter that is a Light Emitting Diode (LED), which may server as an optional light guide and/or messaging light (e.g., as disclosed herein). The rear side of the circuit board housed the housing shown in FIG. 33, is shown in 3450, and its perspective view 3490. Some portions connected to the circuit board includes 3451 cabling connector (e.g., socket such as RJ 45 PoE connector) facilitating coupling to the network such as IX Ethernet connector (for mounting to a framing portion such as a mullion or transom), 3452 communication (e.g., data) and/or power connector (e.g., socket) such as a Universal Serial Bus (USB) connector (e.g., Micro USB), 3457 is an audio signal transformer, 3458 is a power transformer, 3453 is a controller such as a microcontroller (e.g., ARM Cortex-M such as MCU M7), 3454 cabling connector (e.g., socket) facilitating coupling to the network such as IX Ethernet connector (for mounting to a surface such as a wall, ceiling, or floor), 3455 geo-location module, and 3456 connector to particulate matter sensor (e.g., SPS30). The controller may include a core optimized for low-cost and energy-efficient integrated circuits. The controller can comprise a high-performance core. For example, it may comprise a 6-stage superscalar pipeline with branch prediction and an optional floating-point unit capable of single-precision and optionally double-precision operations. The instruction and data buses may comprise a 64-bit wide bus. The geo-location module may comprise a real-time location system (RTLS). The geo-location module may facilitate wired and/or wireless communication. The geo location module may comprise a transceiver (e.g., radio). The geo-location module (e.g., DWM1001C DecaWave) may comprise geo-location technology (e.g., facilitating UWB and BLE (e.g., BLE 5.0) technology. The geo-location module and/or device ensemble may include an accelerometer and/or a battery. The particulate matter sensor may be configured to measure particle Concentration/Counts as stand-alone meters, or simultaneously measure atmospheric quality with other related sensors (e.g., gas sensor such as toxic gas sensor, gas (e.g., air) velocity sensor, and/or air pressure sensor. The particular matter sensor may be configured to measure Mass Concentrations, e.g., as PM-X (micrograms per meter cube μG/m³) and/or Number Concentration as NC-X (N/cm³). The particulate matter sensor may be configured to report data as accumulated over time. The particulate matter sensor may be configure to detect particles having at least about PM1.0 (corresponding to mass concentration of particles having a diameter of from about 0.5 micrometers (μm) to about 1.0 μm), PM2.5 (corresponding to mass concentration of particles having a diameter of from about 0.5 μm to about 2.5 μm), PM4.0 (corresponding to mass concentration of particles having a diameter of from about 0.5 μm to about 4.0 μm), or PM10 (corresponding to mass concentration of particles having a diameter of from about 0.5 μm to about 10 μm). The particulate matter sensor may provide “Typical Particle Size,” which is a weighted average calculation based on all the PM and NC values. The particulate matter sensor may be configured to sense particles having a diameter of at least about 0.2 μm, 0.3 μm, 0.5 μm, 1.0 μm, 2.5 μm, 4.0 μm, 5.0 μm, 8.0 μm, or 10.0 μm. The particulate matter sensor may be configured to sense particulate matter having a diameter between any of the aforementioned values (e.g., from about 0.2 μm to about 10.0 μm). The device ensemble may comprise additional sensors such as % RH, Temperature, CO2, Total VOC (TVOC), or any other sensor, e.g., as disclosed herein.

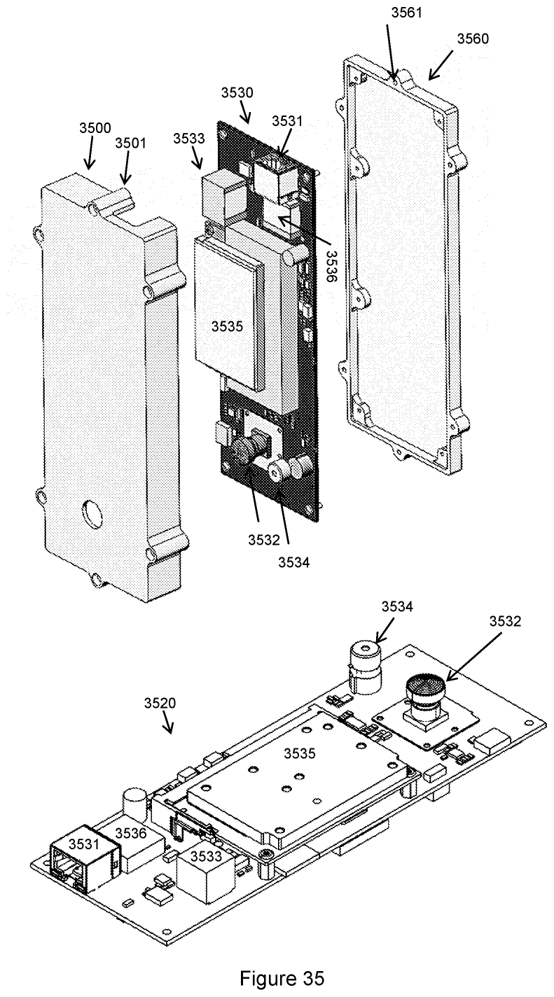

FIG. 35 shows an example of an exploded device assembly shown perspective view. The device ensemble has a housing having a front cover 3500 and a back cover 3560, which housing houses a circuit board 3530 to which various sensors and other modules are connected, e.g., a visible sensor (e.g., camera) 3532, an infrared sensor (e.g., IR camera), 3534, a power supply 3533, a processor 3535 (e.g., Nvidia Jetson) and a connector 3531 (e.g., IX Ethernet Connector such as Registered Jack (RJ) 45 PoE connector) that facilitates connection of the device ensemble circuitry to the network, and 3536. The circuit board is also shown as a perspective view 3520. The front and back sides of the housing couple with each other and are held together via screws (not shown) that engage in hole pairs such as 3561 and 3501.

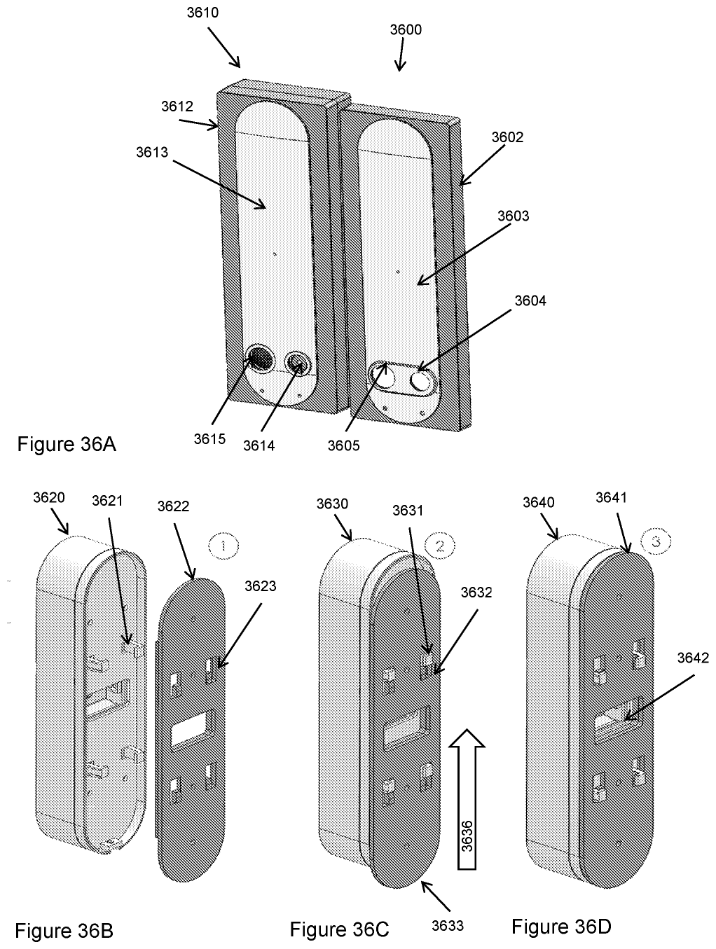

FIGS. 36A-D show examples of various views of device ensembles in various configurations. Fig.36A shows a frontal cover 3600 of a device ensemble housing 3603 engaged in a framing portion 3602 that surrounds the frontal cover of the device ensemble housing. The frontal cover 3603 includes two holes 3605 and 3604 configured for sensor measurements. For example, hole 3605 may facilitate a visual sensor (e.g., camera) to sense the external environment to the device ensemble. For example, hole 3604 may facilitate an infrared sensor (e.g., camera) to sense the external environment to the device ensemble. The device ensemble housing may comprise a circuit board, e.g., similar to 3530 of FIG. 35. The device ensemble may have a frontal cover and a back cover that are configured to engage, e.g., using screws, snap fit, glue, pins, or any other engagement mechanism, e.g., as disclosed herein. The engagement may be reversible (e.g., engage and disengage). The engagement mechanisms may be configured to facilitate reversible engagement (e.g., for installation, repair, and relocation). FIGS. 36B -36D show example stages in engagement between a frontal and a back cover of a device ensemble. For example, FIG. 36 shows a frontal portion 3620 of a device ensemble, and a back portion 3622 of the device ensemble in a disengaged arrangement. The front cover includes for snap pins such as 3621, and the back portion has four holes such as 3623 that facilitate movement and engagement (snapping) of the pins, once the front and back covers are in sufficiently close proximity. FIG. 36C shows an example where the front cover 3630 of the device ensemble is sufficiently close to the back cover 3632, to facilitate entry of the pins such as 3631 of the front portion into the holes such as 3632 of the back portion 3631. The holes are configured (e.g., shaped) to facilitate entry of the pins into the holes in a misaligned (e.g., recessed) portion of the back portion 3631 with respect to the front portion 3630, as shown in FIG. 36. Alignment of the front and back portions is facilitated by moving the back portion relative to the front portion in a direction along arrow 3636. FIG. 36D shows and example of an aligned engagement of the front cover 3640 of the device ensemble with the back cover 3640 in which all pins are engaged and an opening 3642 is visible. The opening 3642 may facilitate coupling of the device ensemble to the network (e.g., via a connector (e.g., socket) such as 3454 of FIG. 34).

In some embodiments, the device ensemble is disposed in a framing portion (e.g., mullion or transom). The framing may comprise a framing cap. The framing cap may be the mullion or transom. The framing cap may cover a mullion or a transom. In some embodiments, the framing cap comprises a polymer (e.g., an organic polymer), resin, or an allotrope of elemental carbon. In some embodiments, the framing cap comprises metal including elemental metal and/or metal alloy. In some embodiments, the framing cap comprises a composite material. In some embodiments, the framing cap comprises non-composite material. In some embodiments, a surface of the framing cap is treated. The framing cap may be configured to be resistance to electricity (e.g., be non-conductive). The at least one surface of the framing cap may be treated. For example, the framing cap may comprise aluminum that has been surface treated to generate anodized aluminum. The surface may be configured for self-lubrication. The surface may comprise impregnated polytetrafluoroethylene (PTFE) Teflon (e.g., for increased lubricity and/or low friction). As compared to the non-treated surface, at least on surface of the framing cap may be configured to increased lubricity, higher corrosion resistance, and/or higher electrical resistance. The such surface treatment may facilitate a tool-less installation and removal process (e.g., via snapping), e.g., of the framing cap portions to each other. The tool-less installation may save time during commissioning.

In some embodiments, the framing cap and/or the framing (or a portion thereof) is configured for temperature conditioning. The framing cap and/or the framing (or a portion thereof) can comprise one or more ventilation holes. The one or more ventilation holes can be configured to facilitate gas flow within the framing cap and/or the framing (or a portion thereof), e.g., from one end of the framing cap and/or the framing (ora portion thereof) to its opposing end. The one or more ventilation holes can be configured to facilitate temperature conditioning of an interior of the framing cap and/or the framing (or a portion thereof). The framing cap and/or the framing (or a portion thereof) is part of a framing system, e.g., of a door, a wall, a supporting structure, a window such as a tintable window, or any combination thereof. The one or more ventilation holes may be configured to facilitate temperature conditioning of an interior of the framing cap and/or the framing (or a portion thereof), e.g., during temperature variation in a framing system. The one or more ventilation holes are configured to facilitate gas flow in the vicinity of at least one device integrated with (e.g., disposed in and/or on) the framing cap and/or the framing (or a portion thereof). The device can be disposed partially inside and partially outside of the framing cap and/or the framing (or a portion thereof). The device can be disposed partially inside and partially at the external surface of the framing cap and/or the framing (or a portion thereof). The device may comprise a sensor ensemble, or a media display. The one or more ventilation holes may be configured to facilitate temperature conditioning in the vicinity of at least one device disposed in the framing cap portion, e.g., to facilitate temperature conditioning of the device (e.g., thermally equilibrating, heating, or cooling the device). The device can be disposed partially inside and partially outside of the framing cap and/or the framing (ora portion thereof). The framing cap and/or the framing (or a portion thereof) can comprise an insulating coating configured to reduce temperature variation in the interior of the framing cap and/or the framing (or a portion thereof), e.g., respectively. The framing cap and/or the framing (or a portion thereof) can comprise an insulating coating configured to reduce temperature equilibration between an external environment and an interior of the framing cap and/or the framing (or a portion thereof). The framing cap and/or the framing (or a portion thereof) can comprise an insulating coating configured to reduce temperature equilibration between a framing (as part of the framing system) and the framing cap (e.g., an interior of the framing cap). The insulating coating can be disposed in an interior and/or at an exterior of the framing cap and/or the framing (or a portion thereof). The framing system (e.g., the kit and/or the frame) may comprise an intermediate body (e.g., a thermal insulator or a heat conductor) disposed between the framing cap and the framing (that is a part of the framing system). The intermediate body may be an insert, an intermediary body, or an interposing body. The intermediate body may be configured to reduce heat transfer (e.g., temperature equilibration) between the framing system and the framing cap portion (e.g., which is part of the kit). The intermediate body can comprise a solid, semi-solid (e.g., gel), liquid, or gaseous material (e.g., low heat conductive material). The intermediate body (e.g., insulator) material can include a polymer, a cloth, and/or a foam. The intermediate body may be a low pressure gas (e.g., lower than the ambient pressure in an environment in which the framing cap and/or the framing (or a portion thereof) is disposed), e.g., lower than about one (1) atmosphere. The intermediate body can be passive. The passive intermediate body may comprise a heat conductive plate, or a heat conductive pipe. The intermediate body may be active. The active intermediate material comprises a thermostat, a circulating coolant, a heat conductive plate, a heat conductive pipe, a heater, or a cooler. The intermediate body may be disposed in a manner that facilitates temperature shielding, limit heat exchange, or any combination thereof. The device, device housing, intermediate body, the framing cap and/or the framing (or a portion thereof), may comprise a, insulator, a heat exchanger and/or a cooling element. The heat exchanger and/or cooling element may comprise a heat pipe, or a metallic slab. Metallic may comprise elemental metal or metal alloy. The metal may be configured for (e.g., efficient and/or rapid) heat conduction. The metal may comprise copper, aluminum, brass, steel, or bronze. The thermal exchanger (e.g., cooling element) may comprise a fluid, gaseous, or semisolid (e.g., gel) material. The thermal exchanger may be active and/or passive. The thermal exchanger may comprise a circuiting substance. The thermal exchanger may be operatively coupled to an active cooling device (e.g., thermostat, cooler, and/or refrigerator). The active cooling device may be disposed externally to the device, device housing, intermediate body, the framing cap and/or the framing (or a portion thereof), or to any combination thereof. The thermal exchanger may be disposed in a fixture (e.g., the floor, ceiling, or wall) of the enclosure (e.g., building or room) in which the device, device housing, intermediate body, the framing cap and/or the framing (or a portion thereof), or to any combination thereof, is located. The heat exchange may comprise radiation, conduction, or convection. The intermediate body may comprise a polymer. For example, polyurethane, styrene, vinyl, Teflon, Kapton, Nylon, or polyimide. The intermediate body may comprise a foam, a tape, or an extruded shape (e.g., sheet). The coating may be anodized (e.g., anodized aluminum). The coating may be a polymer. e.g., any of the polymers disclosed herein. The intermediate body may comprise at least one thermal break.

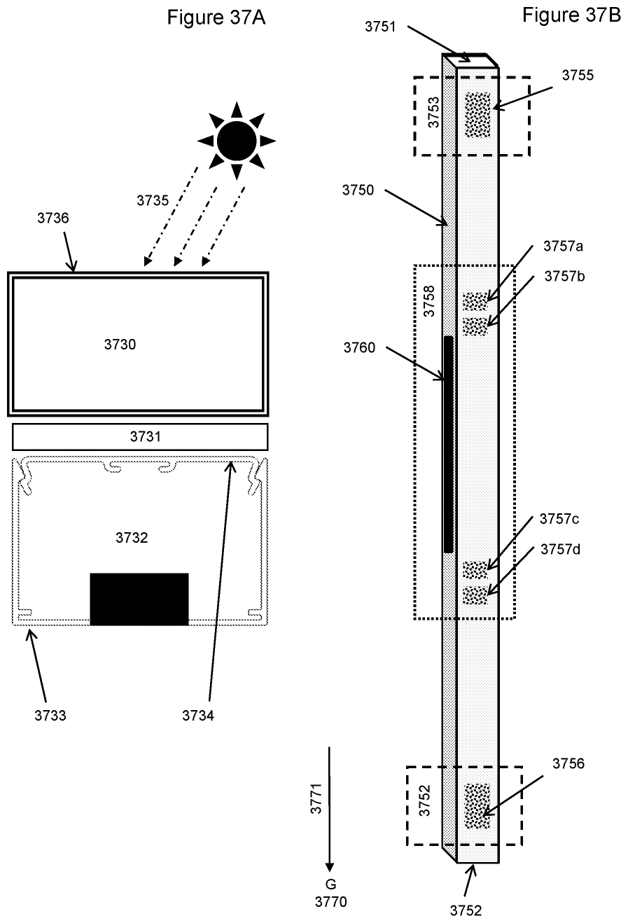

FIG. 37A shows example of various framing system portions shown as vertical cross sections and an example for head conditioning. First cap portion 3734 comprising two splines that point towards each other, and dent configured to engage with a snap fit. First cap portion 3734 is configured to be attached to an existing framing portion such as 3736. Second cap portion 3733 comprises sides having snap fits configured to couple to the dents in the first cap portion 3734. The second cap portion 3733 includes a railing. The railing may extend along the entire second cap portion, or extend only to a portion of the second cap portion. The second cap portion 3733 is configured to engage with the first portion 3734 as shown in FIG. 37A. The interior 3732 of the framing cap is configured to hold cables and/or devices (e.g., sensors, emitters, controllers, circuitry (e.g., circuit boards), and/or other electrical components), e.g., such as housing 3735, which may be a housing of one or mor devices. The railing side may have any length that is smaller than the width of the framing cap. The width of the framing cap can be the same or larger than the width of the existing framing such as 3736. The width of the railing may be configured to accommodate the wiring. The length of the railing may be configured to hold the wiring in place. The length of the opening to the railing cavity may be configured for the wiring to go through. The housing 3735 is disposed partially in the interior of the framing cap 3732 and partially flush with an external surface of the framing cap portion 3733. The framing cap is disposed adjacent to a framing portion 3736 (e.g., mullion or transom) as part of the framing system. An intermediate body 3731 is disposed between the framing portion 3736 and the framing cap (including 3733 and 3734). The intermediate body may be configured to reduce heat exchange between the framing portion 3736 and (i) the framing cap (including 3733 and 3734), (iii) an interior of the framing cap 3732, (iii) the housing 3735, (iv) any device in the housing 3735, or (v) any combination thereof (e.g., any combination of (i), (ii), (iii), and (iv)). For example, sun radiation 3735 may shine on framing 3736 that is exposed to an ambient external environment of a facility, which sun radiation may cause the framing 3736 (e.g., and optionally also an interior of the framing 3730) to heat up. The intermediate body 3731 may be configured to reduce heat transfer from framing portion 3736 towards (i) the framing cap (including 3733 and 3734), (iii) an interior of the framing cap 3732, (iii) the housing 3735, (iv) any device in the housing 3735, or (v) any combination thereof. The intermediate body may reduce the heat transfer passively or actively. The intermediate body may reduce the heat transfer by cooling and/or by insulating.

FIG. 37B shows an example of a frame or framing cap portion shown in perspective view and an example for head conditioning. Portion 3750 is a framing cap or a framing portion (e.g., mullion or transom) as part of a framing system. Frame or framing cap portion 3750 is configured to accommodate a housing 3760 that includes one or more devices (e.g., a device ensemble). Frame or framing cap portion 3750 includes one end portion 3751 a second end portion 3752 opposing end portion 3751 along the length of frame or framing cap portion 3750. The frame or framing cap portion 3750 includes a first area 3753 close to the first end 3751, and a second area 3752 close to the second end 3752. The first area 3753 shows perforations (holes) 3755 located on the frame or framing cap portion 3750. The second area 3754 shows perforations (holes) 3756 located on the frame or framing cap portion 3750. The frame or framing cap portion 3750 includes a third area 3758 surrounding the housing 3760, and preformation 3757a, 3757b, 3757c, and 3757d in the third area. The perforations (e.g., holes) can be an array. The perforations may be grouped in groups such as 3755, 3757a/b/c/d, or 3756. The perforation in a group can be organized or disorganized (e.g., randomly located). The perforations can be arranged as a repeating lattice (e.g., as a matrix). The perforations can be disposed at any side of the frame or framing cap portion 3750. In the example shown in FIG. 37B, the perforation groups are disposed on a side of the frame or framing cap portion 3750. There may be one or more groups of perforations located anywhere along the Frame or framing cap portion. FIG. 37B shows an example of perforation groups located close to the ends of frame or framing cap portion 3750 and close to the housing 3760, which housing is disposed in the frame or framing cap portion 3750, and is flush with an external surface of the frame or framing cap portion 3750. The housing can be partially or entirely in the frame or framing cap portion. The housing can be partially or entirely out of the frame or framing cap portion. When the housing is disposed entirely out of the frame or framing cap portion, it may be attached to the frame or framing cap portion. The frame or framing cap portion can be disposed horizontally or vertically with respect to the gravitational center such as 3770. FIG. 37B show an example where the frame or framing cap portion 3750 is disposed along gravitational vector 3757 that points towards the gravitational center 3770. When the frame or framing cap portion 3750 experiences heat in its interior, which is higher than the ambient temperature, heat exchange may initiate. For example, gas (e.g., air) may travel upwards in the direction from the second end 3752 towards the first end 3752, opposing gravitational vector 3771. The gas (e.g., air) may exit any of the perforations it encounters along its travel path in the frame or framing cap portion 3750. Gas (e.g., air) may be sucked into the interior of the frame or framing cap portion 3750, e.g., during cooling and/or heat exchange. For example, the gas may enter through the perforations (e.g., 3756). The gas may preferentially enter one group of perforations (e.g., 3756) and exit another group of perforations (e.g., 3755), e.g., creating a convective heat exchange. Heat may be generated from one or more devices in the housing, e.g., during operation of the devices. The heat may exit through perforations, e.g., adjacent to the housing. Examples of temperature conditioning, control system, network, sensors, and device ensembles can be found in U.S. Provisional Patent Application Ser. No. 63/170,245, filed Apr. 2, 2021, titled “DISPLAY CONSTRUCT FOR MEDIA PROJECTION AND WIRELESS CHARGING,” which is incorporated herein by reference in its entirety.

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein might be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1. A method for managing coexistence of devices, the method comprising:
generating a coexistence matrix indicative of any interference between each of a first plurality of devices disposed in an enclosure and each of a second plurality of devices disposed in the enclosure;
using the coexistence matrix to control operation of (a) at least one first device of the first plurality of devices and/or (b) at least one second device of the second plurality of devices; and
altering an environment of the enclosure using the at least one first device and/or the at least one second device.

2-4. (canceled)

5. The method of claim 1, wherein the first plurality of devices is disposed in a first sub enclosure and wherein the second plurality of devices is disposed in a second sub enclosure.

6. (canceled)

7. The method of claim 5, wherein the first sub enclosure is a first room in a facility and/or the second sub enclosure is a second room in the facility.

8. The method of claim 1, wherein the coexistence matrix is utilized in controlling the first plurality of devices and/or the second plurality of devices indicated in the coexistence matrix as having an interference potential above a threshold.

9-13. (canceled)

14. An apparatus for managing coexistence of devices, the apparatus comprising one or more controllers comprising circuitry, which one or more controllers are configured to:
generate, or direct generation of, a coexistence matrix indicative of any interference between each of a first plurality of devices disposed in an enclosure and each of a second plurality of devices disposed in the enclosure;
use, or direct usage of, the coexistence matrix to control operation of (a) at least one first device of the first plurality of devices and/or (b) at least one second device of the second plurality of devices; and
alter, or direct alteration of, an environment of the enclosure using the at least one first device and/or the at least one second device.

15. The apparatus of claim 14, wherein the one or more controllers are coupled to the first plurality of devices and to the second plurality of devices, and wherein the one or more controllers are configured to isolate operation of the at least one first device from operation of the at least one second device based at least in part on any respective interference included in the coexistence matrix.

16. The apparatus of claim 15, wherein operation of the at least one first device and the operation of the at least one second device are isolated when an interference potential included in the coexistence matrix is above a threshold.

17. The apparatus of claim 15, wherein isolation of the at least one first device from operation of the at least one second device is comprised of (i) a first time of operation of the at least one first device and (ii) a second time of operation of the at least one second device, wherein the first time is separated from the second time to prevent simultaneous operation of the at least one first device and the at least one second device.

18. The apparatus of claim 15, wherein the at least one first device and the at least one second device are of the same type, wherein the first plurality of devices are in a first assembly, wherein the second plurality of devices are in a second assembly, and wherein isolation of the at least one first device from operation of the at least one second device is comprised of a physical distance separation resulting from the one or more controllers activating the at least one first device while deactivating the at least one second device when the first assembly is above a distance threshold from the second assembly.

19-20. (canceled)

21. The apparatus of claim 14, wherein the one or more controllers are configured to control operation of the first plurality of devices and/or the second plurality of devices at least in part by controlling operation mode of (i) at least one first device of the first plurality of devices and/or (ii) at least one second device of the second plurality of devices.

22. (canceled)

23. An apparatus for altering an environment of an enclosure, the apparatus comprising:
a plurality of devices comprising a sensor configured to sense an environmental property of the enclosure;
a first circuit board to which the plurality of devices is coupled, wherein the first circuit board is configured to operatively couple to at least one controller configured to alter the environment using at least one of the plurality of devices; and
a casing having an open body and a lid configured to cover an opening of the open body, wherein:
the casing is configured to enclose the plurality of devices and at least a portion of the first circuit board,
the lid has a textured portion at an exterior of the lid,
the textured portion surrounds at least one hole in the lid, and
the at least one hole is configured to facilitate sensing of the environmental property by the sensor when the casing is covered by the lid during operation.

24. The apparatus of claim 23, wherein at least one device of the plurality of devices is configured to reversibly couple to the first circuit board.

25. The apparatus of claim 23, wherein the casing interior comprises a heat sink.

26. The apparatus of claim 23, wherein the casing is configured to be assembled onto, or into, at least a portion of a fixture of the enclosure, and the fixture comprises a wall, a ceiling, a frame, a window frame a door frame, or a mast.

27-29. (canceled)

30. The apparatus of claim 23, wherein the first circuit board comprises a through-hole configured to facilitate sensing of the environmental property by the sensor when the casing is covered by the lid during operation.

31. The apparatus of claim 30, wherein:
first circuit board further comprises a
second through-hold configured to facilitate sensing of the environmental property by the sensor, the sensor is positioned on a rear side of the first circuit board over the through-hole and the second through-hole, and
the rear side faces away from the lid.

32. The apparatus of claim 30, wherein:
the lid further includes at least a second hole, and
the at least one hole and the second hole are positioned over the through-hole of the first circuit board.

33. The apparatus of claim 23, wherein the sensor is an ambient light sensor, and
the apparatus further includes a light pipe configured to allow light to pass through the at least one hole to the ambient light sensor.

34. The apparatus of claim 33, wherein the light pipe includes:
a mounting flange, and
a transparent pipe body that extends at least partially through the at least one hole.

35. The apparatus of claim 23, further comprising:
at least one controller having a processor and a memory, and
a second circuit board offset from the first circuit board, wherein:
the processor and/or the memory are disposed in the second circuit board.

36. The apparatus of claim 23, wherein:
the lid further includes a plurality of holes, and
the sensor is configured to suction external atmosphere through the plurality of holes and into the open body of the casing.

37-48. (canceled)
